(19) United States
(12) Patent Application Publication
(10) Pub. No.: US 2024/0338777 A1
(43) Pub. Date: Oct. 10, 2024

(54) Ecosystem for Initiating an Action Following Occurrence of an Event

(71) Applicant: STATE FARM MUTUAL AUTOMOBILE INSURANCE COMPANY, Bloomington, IL (US)

(72) Inventors: John Hurliman, Bloomington, IL (US); Kami Lavallier, Knoxville, TN (US); Emily Bryant, Mesa, AZ (US); Sondra Mulford, Bloomington, IL (US); Amy L. Starr, Roswell, GA (US); Christopher Sawula, Decatur, GA (US)

(21) Appl. No.: 18/631,251

(22) Filed: Apr. 10, 2024

Related U.S. Application Data
(60) Provisional application No. 63/535,363, filed on Aug. 30, 2023.
(60) Provisional application No. 63/534,630, filed on Aug. 25, 2023.
(60) Provisional application No. 63/534,415, filed on Aug. 24, 2023.
(60) Provisional application No. 63/533,184, filed on Aug. 17, 2023.
(60) Provisional application No. 63/530,605, filed on Aug. 3, 2023.
(60) Provisional application No. 63/524,336, filed on Jun. 30, 2023.
(60) Provisional application No. 63/524,342, filed on Jun. 30, 2023.
(60) Provisional application No. 63/524,343, filed on Jun. 30, 2023.
(60) Provisional application No. 63/471,868, filed on Jun. 8, 2023.
(60) Provisional application No. 63/465,004, filed on May 9, 2023.
(60) Provisional application No. 63/458,289, filed on Apr. 10, 2023.

(51) Int. Cl. G06Q 40/08

(52) U.S. Cl. CPC G06Q 40/08

(57) ABSTRACT

The following relates generally to a home ecosystem and home ecosystem app. In some embodiments, one or more processors: (1) receive data from a plurality of data sources, the plurality of data sources including: smart home devices, a weather database, an insurance company, a real estate & property data company, artificial intelligence (AI) company, an electrical data company, a security company, and/or a property risk data company; (2) determine, based upon the received data from the plurality of data sources, that an event has occurred that will damage or has damaged an insured asset; and/or (3) initiate an action based upon the determination that the event has occurred.

### CROSS REFERENCE TO RELATED APPLICATIONS

This application claims the benefit of: (1) U.S. Provisional Application No. 63/458,289, entitled “Home Score Marketplace” (filed Apr. 10, 2023); (2) U.S. Provisional Application No. 63/465,004, entitled “Home Score Marketplace” (filed May 9, 2023); (3) U.S. Provisional Application No. 63/471,868, entitled “Home Score Marketplace” (filed Jun. 8, 2023); (4) U.S. Provisional Application No. 63/524,336, entitled “Augmented Reality System to Provide Recommendation to Purchase a Device That Will Improve Home Score” (filed Jun. 30, 2023); (5) U.S. Provisional Application No. 63/524,342, entitled “Augmented Reality System to Provide Recommendation to Repair or Replace an Existing Device to Improve Home Score” (filed Jun. 30, 2023); (6) U.S. Provisional Application No. 63/524,343, entitled “Virtual Reality Digital Twin of A Home” (filed Jun. 30, 2023); (7) U.S. Provisional Application No. 63/530,605, entitled “Recommendation System to Purchase a New Device to Improve a Home Score” (filed Aug. 3, 2023); (8) U.S. Provisional Application No. 63/533,184, entitled “Recommendation System to Replace or Repair an Existing Device to Improve a Home Score” (filed Aug. 17, 2023); (9) U.S. Provisional Application No. 63/534,415, entitled “Recommendation System for Upgrades or Services for a Home to Improve a Home Score” (filed Aug. 24, 2023); (10) U.S. Provisional Application No. 63/534,630, entitled “Information System for Products to Improve a Home Score” (filed Aug. 25, 2023); and (11) U.S. Provisional Application No. 63/535,363, entitled “Machine Vision and/or Computer Vision System to Purchase a New Device to Improve a Home Score” (filed Aug. 30, 2023), the entirety of each of which is incorporated by reference herein.

### FIELD

The present disclosure generally relates to a home ecosystem and home ecosystem app.

### BACKGROUND

Determining and presenting a home score (e.g., a score rating safety of a home, etc.) may be important to an insurance company. However, present systems for determining and/or displaying home scores and/or subscores may have certain drawbacks.

The systems and methods disclosed herein may provide solutions to these problems, and may provide solutions to the ineffectiveness, insecurities, difficulties, inefficiencies, encumbrances, and/or other drawbacks of conventional techniques.

### SUMMARY

In one aspect, a computer-implemented method for an ecosystem that initiates an action following an occurrence of an event may be provided. The method may be implemented via one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For instance, in one example, the method may include: (1) receiving, via one or more processors, data from a plurality of data sources, the plurality of data sources including: smart home devices, a weather database, an insurance company, a real estate & property data company, artificial intelligence (AI) company, an electrical data company, a security company, and/or a property risk data company; (2) determining, via the one or more processors, based upon the received data from the plurality of data sources, that an event has occurred that will damage or has damaged an insured asset; and/or (3) initiating, via the one or more processors, an action based upon the determination that the event has occurred. The method may include additional, fewer, or alternate actions, including those discussed elsewhere herein.

In another aspect, computer system for an ecosystem that initiates an action following an occurrence of an event may be provided. The computer system may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For example, in one instance, the computer system may include one or more processors configured to: (1) receive data from a plurality of data sources, the plurality of data sources including: smart home devices, a weather database, an insurance company, a real estate & property data company, artificial intelligence (AI) company, an electrical data company, a security company, and/or a property risk data company; (2) determine, based upon the received data from the plurality of data sources, that an event has occurred that will damage or has damaged an insured asset; and/or (3) initiate an action based upon the determination that the event has occurred. The computer system may include additional, less, or alternate functionality, including that discussed elsewhere herein.

In yet another aspect, a computer device for an ecosystem that initiates an action following an occurrence of an event may be provided. The computer device may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For instance, in one example, the computer device may include: one or more processors; and/or one or more non-transitory memories. The one or more non-transitory memories having stored thereon computer-executable instructions that, when executed by the one or more processors, cause the computer device to: (1) receive data from a plurality of data sources, the plurality of data sources including: smart home devices, a weather database, an insurance company, a real estate & property data company, artificial intelligence (AI) company, an electrical data company, a security company, and/or a property risk data company; (2) determine, based upon the received data from the plurality of data sources, that an event has occurred that will damage or has damaged an insured asset; and/or (3) initiate an action based upon the determination that the event has occurred. The computer device may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates an exemplary home score and marketplace system, according to one embodiment.

FIG. 2 illustrates an exemplary screen including an exemplary holistic risk profile.

FIG. 3 illustrates an exemplary screen including an exemplary holistic risk profile, including an exemplary selection of an exemplary residential icon.

FIG. 4 illustrates exemplary data sources that may provide data to be used, inter alia, to calculate the overall home score.

FIG. 5 illustrates an exemplary ecosystem.

FIG. 6A illustrates an exemplary login screen.

FIG. 6B illustrates an exemplary screen showing an overall home score and home subscores.

FIG. 6C illustrates an exemplary screen including exemplary recommendations.

FIG. 6D illustrates an exemplary homeowners community screen.

FIG. 7 illustrates exemplary interactions between entities.

FIG. 8 illustrates exemplary potential business-to-customer (B2C) capabilities and/or features of an example system.

FIG. 9 illustrates exemplary system components.

FIG. 10 illustrates an exemplary home health score report.

FIG. 11 shows an exemplary computer-implemented method or implementation for determining and/or displaying home scores and/or subscores.

FIG. 12 illustrates a block diagram of an exemplary machine learning modeling method for training and evaluating exemplary machine learning model(s).

FIG. 13 illustrates exemplary layers of an exemplary ecosystem.

FIG. 14 illustrates exemplary product and services screens of an exemplary home ecosystem app.

FIG. 15 illustrates an exemplary screen allowing a user to select types of data to be displayed.

FIG. 16 illustrates exemplary screens showing exemplary electrical and exemplary water data.

FIGS. 17 and 18 illustrate additional exemplary screens of an exemplary app, in accordance with embodiments described herein.

FIG. 19 illustrates additional exemplary screens of an exemplary app, including a screen which allows access to various smart home devices.

FIG. 20 illustrates an exemplary screen facilitating scheduling of water restoration.

FIG. 21 shows an exemplary computer-implemented method or implementation for an ecosystem to predict and/or prevent loss.

FIG. 22 shows an exemplary computer-implemented method or implementation for an ecosystem that initiates an action following an occurrence of an event.

FIG. 23 illustrates a block diagram of an exemplary machine learning modeling method for training and evaluating exemplary machine learning model(s).

FIG. 24 depicts an exemplary computer-implemented method or implementation for recommending a device to purchase to improve a home score.

FIG. 25 depicts an exemplary device catalog.

FIG. 26 depicts a combined block and logic diagram in which exemplary computer-implemented methods and systems for using ML to generate device recommendations, identify devices, and calculate home score improvements are implemented, according to one embodiment.

FIG. 27 depicts a combined block and logic diagram in which exemplary computer-implemented methods and systems for training an ML chatbot model are implemented, according to one embodiment.

FIG. 28 depicts an exemplary display, including exemplary text explaining why a device improves a home score.

FIG. 29 depicts another exemplary display, including exemplary text explaining why a device improves a home score.

FIG. 30 depicts an exemplary display identifying a device, and recommending a placement location of the device.

FIG. 31 depicts an exemplary computer-implemented method or implementation for determining an improvement to a home score for replacing or repairing an existing device.

FIG. 32 shows an exemplary table indicating information of a home safety attribute.

FIG. 33 depicts an exemplary table indicating information of a fire protection attribute.

FIG. 34 depicts exemplary matrix of smart smoke detectors indicating points that the smart smoke detectors increase the home automation subscore by.

FIG. 35 depicts an exemplary screen allowing a user to enter and/or confirm structural information.

FIG. 36 depicts an exemplary screen depicting an overall home score, a home safety subscore, and a fire protection subscore.

FIG. 37 depicts an exemplary screen depicting home score improvements for replacing an existing device.

FIG. 38 depicts an exemplary screen depicting home score improvements for repairing an existing device.

FIG. 39 depicts an exemplary screen including exemplary text explaining a recommendation to replace a water monitor.

FIG. 40 depicts an exemplary screen depicting text explaining how the home score(s) are calculated.

FIG. 41 depicts an exemplary screen including a difference between a home score improvement for replacing an existing device, and a home score improvement for repairing the existing device.

FIG. 42 depicts an exemplary screen displaying a list of purchase options.

FIG. 43 depicts an exemplary screen displaying a list of repair options.

FIG. 44 depicts a combined block and logic diagram in which exemplary computer-implemented methods and systems for using ML to generate device recommendations, identify devices, and calculate home score improvements for replacing or repairing existing devices are implemented, according to one embodiment.

FIG. 45 depicts a combined block and logic diagram in which exemplary computer-implemented methods and systems for training an ML chatbot model are implemented, according to one embodiment.

### DETAILED DESCRIPTION

The present embodiments relate to, inter alia, determining and/or displaying home scores and/or subscores. For example, a customer (or prospective customer) of an insurance company may be presented (e.g., on a display of a smartphone) with an overall home score, a relative home score, and/or a plurality of home subscores. The plurality of subscores may include a home safety subscore, a fire protection subscore, a sustainability subscore, a home automation subscore, etc. The system may offer recommendations to improve the overall home score, the relative home score, and/or any of the subscores. More broadly, the system may provide, to the customer, a holistic risk profile score comprising the overall home score, a self-risk score, and/or an auto risk score.

### Exemplary Home Marketplace System

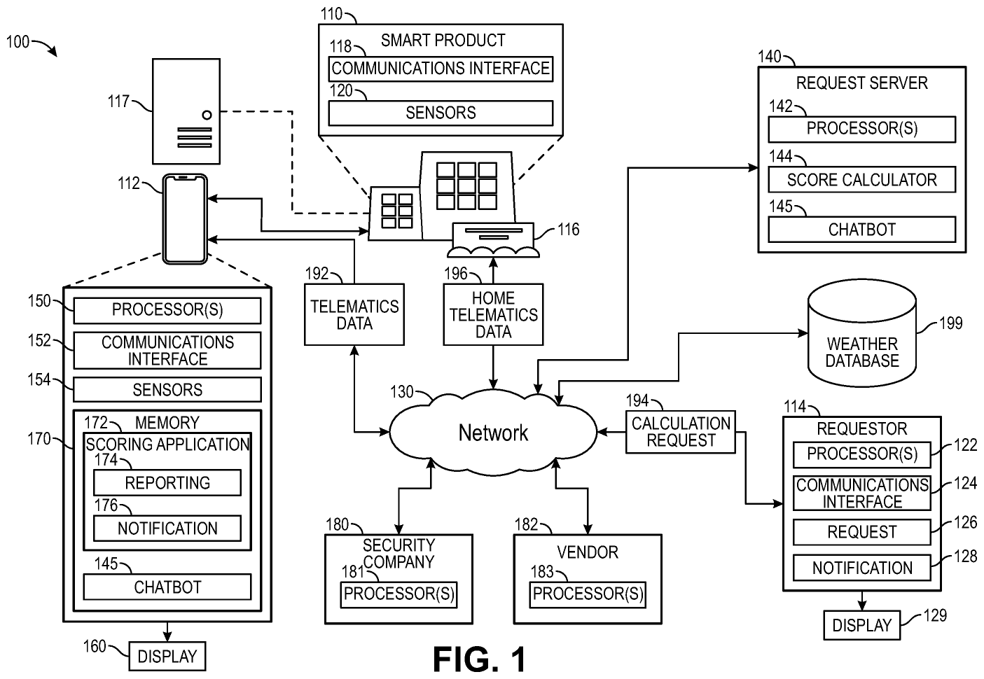

FIG. 1 depicts an exemplary home score and marketplace system 100. Depending on the embodiment, the exemplary system 100 may determine and/or display an overall home score, a relative home score, a plurality of home subscores, or any other similar home score for a user. It should be appreciated that an entity (e.g., requestor 114), such as an insurance company, may wish to determine and/or view any such overall home score, relative home score, plurality of home subscores.

Additionally, the property (e.g., a home or residence, such as property 116) and, more specifically, a computing device 117 associated with the property 116, a smart device 110 within the property 116, and/or one or more mobile devices may detect, gather, or store home data (e.g., home telematics data) associated with the functioning, operation, and/or evaluation of the property 116. The computing device 117 associated with the property 116 may transmit home telematics data in a communication 196 via the network 130 to a request server 140.

In some embodiments, the request server 140 may already store home data (e.g., home telematics data) and/or user data (e.g., user telematics data) in addition to any received home telematics data or user telematics data. Further, the request server 140 may use the home telematics data and/or user telematics data to evaluate and calculate/determine a home score for the property 116, or to train any machine learning algorithm as discussed herein. Additionally or alternatively, one or more mobile devices (e.g., mobile device 112) communicatively coupled to the computing device associated with the property 116 may transmit home telematics data and/or user telematics data in communication 192 to the request server 140 via the network 130.

The smart device 110 may include a processor, a set of one or several sensors 120, and/or a communications interface 118. In some embodiments, the smart device 110 may include single devices, such as a smart television, smart refrigerator, smart doorbell, or any other similar smart device. In further embodiments, the smart device 110 may include a network of devices, such as a security system, a lighting system, or any other similar series of devices communicating with one another. The set of sensors 120 may include, for example, a camera or series of cameras, a motion detector, a temperature sensor, an airflow sensor, a smoke detector, a carbon monoxide detector, or any similar sensor.

Although FIG. 1 depicts the set of sensors 120 inside the smart device 110, it is noted that the sensors 120 need not be internal components of the smart device 110. Rather, a property 116 may include any number of sensors in various locations, and the smart device 110 may receive data from these sensors during operation. In further embodiments, the computing device 117 associated with the property 116 may receive data from the sensors during operation. In still further embodiments, the computing device 117 associated with the property 116 may be the smart device 110.

The communications interface 118 may allow the smart device 110 to communicate with the mobile device 112, the sensors 120, and/or a computing device 117 associated with the property 116. The communications interface 118 may support wired or wireless communications, such as USB, Bluetooth, Wi-Fi Direct, Near Field Communication (NFC), etc. The communications interface 118 may allow the smart device 110 to communicate with various content providers, servers, etc., via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc. The processor may operate to format messages transmitted between the smart device 110 and the mobile device 112, sensors 120, and/or computing device 117 associated with the property 116; process data from the sensors 120; transmit communications to the request server 140; etc.

In some embodiments, the smart device 110 may collect the home telematics data using the sensors 120. Depending on the embodiment, the smart device may collect home telematics data regarding the usage and/or occupancy of the property. In some embodiments, the home telematics data may include data such as security camera data, electrical system data, plumbing data, appliance data, energy data, maintenance data, guest data, homeshare data, rental data, home use data, home occupancy data, home occupant data, renter data, home layout data (e.g., home structure, number of bedrooms, number of bathrooms, square footage, etc.), home characteristic data, and any other suitable data representative of property 116 occupancy and/or usage.

For instance, the home telematics data may include data gathered from motion sensors and/or images of the home from which it may be determined how many people occupy the property and the amount of time they each spend within the home. Additionally or alternatively, the home telematics data may include electricity usage data, water usage data, HVAC usage data (e.g., how often the furnace or air conditioner unit is on), and smart appliance data (e.g., how often the stove, oven, dish washer, or clothes washer is operated). The home telematics data may also include home occupant mobile device data or home guest mobile device data, such as GPS or other location data.

The user data (e.g., user telematics data) may include data from the user's mobile device, or other computing devices, such as smart glasses, wearables, smart watches, laptops, etc.

The user data or user telematics data may include data associated with the movement of the user, such as GPS or other location data, and/or other sensor data, including camera data or images acquired via the mobile or other computing device. In some embodiments, the user data and/or user telematics data may include historical data related to the user, such as historical home data, historical claim data, historical accident data, etc. In further embodiments, the user data and/or user telematics data may include present and/or future data, such as expected home data when moving, projected claim data, projected accident data, etc. Depending on the embodiment, the historical user data and the present and/or future data may be related.

The user data or user telematics data may also include vehicle telematics data collected or otherwise generated by a vehicle telematics app installed and/or running on the user's mobile device or other computing device. For instance, the vehicle telematics data may include acceleration, braking, cornering, speed, and location data, and/or other data indicative of the user's driving behavior.

The user data or user telematics data may also include home telematics data collected or otherwise generated by a home telematics app installed and/or running on the user's mobile device or other computing device. For instance, a home telematics app may be in communication with a smart home controller and/or smart appliances or other smart devices situated about a home, and may collect data from the interconnected smart devices and/or smart home sensors. Depending on the embodiment, the user telematics data and/or the home telematics data may include information input by the user at a computing device or at another device associated with the user. In further embodiments, the user telematics data and/or the home telematics data may only be collected or otherwise generated after receiving a confirmation from the user, although the user may not directly input the data.

In some embodiments, the user data or user telematics data may include user-reported data obtained via an application (e.g., on the mobile device 112), website, email, phone call, etc. Depending on the embodiment, the user-reported data may include one or more answers to questions regarding a property 116 associated with the user. For example, the user-reported data may include answers regarding: a year the home was built, whether any components and/or systems (e.g., electrical, plumbing, foundation, etc.) have been replaced, when any components and/or systems have been replaced, how many stories the property has, whether the property has a basement, whether the basement is finished, a size range of the overall size of the property, a square footage of a building (e.g., as being, associated with, or part of the property), a subjective overall condition rating of the property, whether other people live on the property, how many people live on the property full time, how many people live on the property part-time, how many hours per day someone is typically on the property, any homeownership worries the user has (e.g., ability to afford repairs, ability to make repairs, ability to find someone to make repairs, general worry regarding unforeseen issues, etc.), frequency with which the user forgets to lock doors (e.g., days per week, days per month, etc.), frequency with which the user forgets to close windows (e.g., days per week, days per month, etc.), whether the user utilizes security mitigation devices (e.g., cameras, sensors, central monitored security system, connected smoke detectors, water sensors, electrical system monitors, etc.), whether the user has various disaster prevention items (e.g., a fire extinguisher, first aid kid, etc.), how the user handles home care and maintenance (e.g., do-it-yourself (DIY) style maintenance, hire a professional, differing depending on circumstance, etc.), a description of a maintenance schedule, any plans for structural changes (e.g., replacing roof, replacing windows, adding/changing floorplan, etc.), any plans for cosmetic changes (e.g., paint, replacing appliances, adding/changing carpeting, etc.), a level of satisfaction for care and maintenance of the property, whether any obstacles prevent the user from being satisfied with home care and maintenance (e.g., time, money, knowledge, resources, etc.), whether the user has had an insurance review recently (e.g., in the last month, in the last 6 months, in the last 12 months, etc.), and/or any other such datapoints.

Mobile device 112 may be associated with (e.g., in the possession of, configured to provide secure access to, etc.) a particular user, who may be an owner of a property, such as property 116. In further embodiments, the mobile device 112 may be associated with a potential homeowner, shopper, developer, or other such particular user. Mobile device 112 may be a personal computing device of that user, such as a smartphone, a tablet, smart glasses, smart headset (e.g., augmented realty, virtual reality, or extended reality headset or glasses), wearable, or any other suitable device or combination of devices (e.g., a smart watch plus a smartphone) with wireless communication capability. In the embodiment of FIG. 1, mobile device 112 may include a processor 150, a communications interface 152, sensors 154, a memory 170, and a display 160.

Processor 150 may include any suitable number of processors and/or processor types. Processor 150 may include one or more CPUs and one or more graphics processing units (GPUs), for example. Generally, processor 150 may be configured to execute software instructions stored in memory 170. Memory 170 may include one or more persistent memories (e.g., a hard drive and/or solid state memory) and may store one or more applications, including scoring application 172.

The mobile device 112 may be communicatively coupled to the smart device 110, the sensors 120, and/or a computing device 117 associated with the property 116. For example, the mobile device 112 and the smart device 110, sensors 120, and/or computing device 117 associated with the property 116 may communicate via USB, Bluetooth, Wi-Fi Direct, Near Field Communication (NFC), etc. For example, the smart device 110 may send home telematics data, user telematics data, or other sensor data in the property 116 via communications interface 118 and the mobile device 112 may receive the home telematics data or other sensor data via communications interface 152. In other embodiments, mobile device 112 may obtain the home telematics data from the property 116 from sensors 154 within the mobile device 112.

Further still, mobile device 112 may obtain the home telematics data and/or user telematics data via a user interaction with a display 160 of the mobile device 112. For example, a user may take a photograph indicative of a property and/or input, at the display 160, information regarding characteristics indicative of potential hazards or other such information relevant to determining any of the scores. Scoring unit 174 may be configured to prompt a user to take a photograph or input information at the display 160. The mobile device 112 may then generate a communication that may include the home telematics data and/or user telematics data and may transmit the communication 192 to the request server 140 via communications interface 152.

In some embodiments, the scoring application 172 may include or may be communicatively coupled to a home score application or website. In such embodiments, the request server 140 may obtain the home telematics data and/or user telematics data via stored data in the home score application or via a notification 176 in the scoring application 172 granting the scoring application 172 access to the home score application data.

Depending on the embodiment, a computing device 117 associated with the property 116 may obtain home telematics data for the property 116 indicative of environmental conditions, housing and/or construction conditions, location conditions, first responder conditions, or other similar metrics of home telematics data. The computing device 117 associated with the property 116 may obtain the home telematics data from one or more sensors 120 within the property 116. In other embodiments, the computing device 117 associated with the property 116 may obtain home telematics data through interfacing with a mobile device 112.

Depending on the embodiment, home telematics data may be indicative of both visible and invisible hazards to the property. For example, the home telematics data may include image data of the property 116 as well as internal diagnostic data on functionality of particular devices or components of the property 116. In another example, home telematics data may be used to determine that the property 116 and/or components of the property 116 are likely to require repair and/or replacement, and may lead to a potential risk or claim associated with the property 116.

In some embodiments, the home telematics data may include interpretations of raw sensor data, such as detecting an intruder event when a sensor detects motion during a particular time period. The computing device 117 associated with the property 116, mobile device 112, and/or smart device 110 may collect and transmit home telematics data to the request server 140 via the network 130 in real-time or at least near real-time at each time interval in which the system 100 collects home telematics data. In other embodiments, a component of the system 100 may collect a set of home telematics data at several time intervals over a time period (e.g., a day), and the smart device 110, computing device 117 associated with the property 116, and/or mobile device 112 may generate and transmit a communication which may include the set of home telematics data collected over the time period.

In addition, in some embodiments, the smart device 110, computing device 117 associated with the property 116, and/or mobile device 112 may generate and transmit communications periodically (e.g., every minute, every hour, every day), where each communication may include a different set of home telematics data and/or user telematics data collected over the most recent time period. In other embodiments, the smart device 110, computing device 117 associated with the property 116, and/or mobile device 112 may generate and transmit communications as the smart device 110, mobile device 112, and/or computing device 117 associated with the property 116 receive new home telematics data and/or user telematics data.

In further embodiments, a trusted party may collect and transmit the home telematics data and/or user telematics data, such as an evidence oracle. The evidence oracles may be devices connected to the internet that record and/or receive information about the physical environment around them, such as a smart device 110, a mobile device 112, sensors 120, a request server 140, etc. In further examples, the evidence oracles may be devices connected to sensors such as connected video cameras, motion sensors, environmental conditions sensors (e.g., measuring atmospheric pressure, humidity, etc.) as well as other Internet of Things (IoT) devices.

The data may be packaged into a communication, such as communication 192 or 196. The data from the evidence oracle may include a communication ID, an originator (identified by a cryptographic proof-of-identity, and/or a unique oracle ID), an evidence type, such as video and audio evidence, and a cryptographic hash of the evidence. In another embodiment, the evidence is not stored as a cryptographic hash, but may be directly accessible by an observer or other network participant.

Next, the smart device 110 and/or computing device 117 associated with the property 116 may generate a communication 196 including a representation of the home telematics data wherein the communication 196 is stored at the request server 140 and/or an external database (not shown).

In some embodiments, generating the communication 196 may include obtaining identity data for the smart device 110, computing device 117, and/or the property 116; obtaining identity data for the mobile device 112 in the property 116; and/or augmenting the communication 196 with the identity data for the smart device 110, the property 116, the computing device 117, and/or the mobile device 112. The communication 196 may include the home telematics data or a cryptographic hash value corresponding to the home telematics data.

In some embodiments, the mobile device 112 or the smart device 110 may transmit the home telematics data and/or user telematics data to a request server 140. The request server 140 may include a processor 142 and a memory that stores various applications for execution by the processor 142. For example, a score calculator 144 may obtain home telematics data for a property 116 and/or user telematics data for a user to analyze, calculate, and/or determine score(s) for a property 116 (e.g., the overall home score, the relative home score, any of the home subscores, the auto score, the self-risk score, etc.). The score calculator 144 may also use any of the scores to determine recommendations to improve any of the score(s), determine recommendations for vendors to sell items and/or provide services, etc.

In further embodiments, a requestor 114 may transmit a communication 194 including a score calculation request to the request server 140 via the network 130. Depending on the embodiment, the requestor may include one or more processors 122, a communications interface 124, a request module 126, a notification module 128, and a display 129. In some embodiments, each of the one or more processors 122, communications interface 124, request module 126, notification module 128, and display 129 may be similar to the components described above with regard to the mobile device 112.

Depending on the embodiment, the requestor 114 may be associated with a particular user, such as an insurance company, a shopper, a home shopping website and/or application, a home rental website and/or application, a construction company, a real estate company, an underwriting company, etc. In some embodiments, the requestor 114 may be associated with the same user as the request server 140. In other embodiments, the requestor 114 is associated with a different user than the request server 140. In some such embodiments, the request module 126 and/or notification module 128 may include or be part of a request application, such as an underwriting application, a shopping application, an insurance application, etc.

In some embodiments, the requestor 114 may transmit a communication 194 including a score request to the requestor 140 via the communications interface 124. In some such embodiments, the requestor 114 may request the score to use as an input to a rating model, an underwriting model, a claims generation model, or any other similarly suitable model. For example, the requestor 114 or a user (e.g., via the mobile device 112) may request the overall home score, the relative home score, the home subscores (e.g., a home safety subscore, a fire protection subscore, a sustainability subscore, a home automation subscore, etc.), a self-risk score, an auto score, etc.

As will be discussed elsewhere herein, any of the scores may be determined by any suitable technique. For example, any of the scores may be determined via a machine learning model(s), which may be trained via any suitable technique. For instance, a machine learning model that determines the home safety subscore may be trained using historical data from the security company 180, which includes one or more processors 181.

As also will be discussed elsewhere herein, the recommendations for vendors (such as vendor 182, which may include one or more processors 183) may be determined by any suitable technique. For instance, the recommendations may be determined via a lookup table, or via a machine learning model. The recommendations may allow a user to select from a plurality of vendors, thus creating an exemplary marketplace.

Furthermore, although the exemplary system 100 illustrates only one of each of the components, any number of the example components are contemplated (e.g., any number of mobile devices, vendors, requestors, smart products, request servers security companies, computing devices, etc.).

### Exemplary Displays

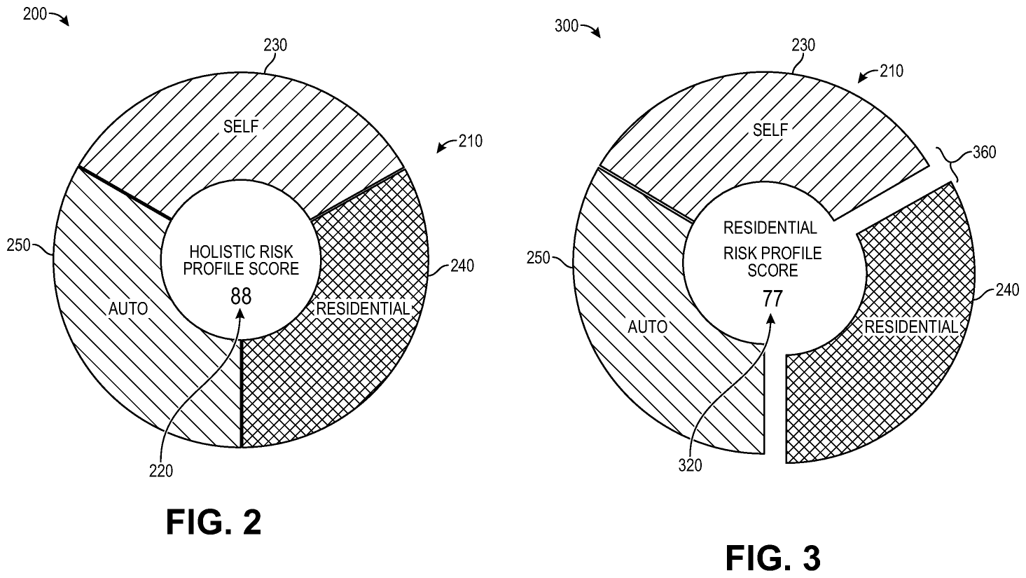

FIG. 2 illustrates an exemplary screen 200 including an exemplary holistic risk profile 210 encompassing a self-risk component, a residential component, and an auto component. More particularly, the exemplary holistic risk profile 210 may be a risk profile of the insurance customer (or potential insurance customer) (e.g., an owner of the mobile device 112), and may display holistic risk score 220. In the illustrated example, the insurance customer has achieved 88 as her holistic risk profile score.

As will be described elsewhere herein, the holistic risk profile score may include a self-risk component, a residential component, and an auto component. To this end, the displayed exemplary holistic risk profile may include a self icon 230, a residential icon 240, and/or an auto icon 250.

In some embodiments, when the system selects any of the icons, more information corresponding to the selected icon is displayed. For instance, in the example of FIG. 3, the user has selected the residential icon 240; and, in response to the selection, the residential risk profile score 320 (e.g., overall home score) is displayed. Furthermore, in some embodiments, upon selection of an icon 230, 240, 250, the selected icon is moved away from the other two icons. In this regard, in the example screen 300, the user has selected the residential icon 240, and thus distance 360 has been created between the self icon 230 and the residential icon 240.

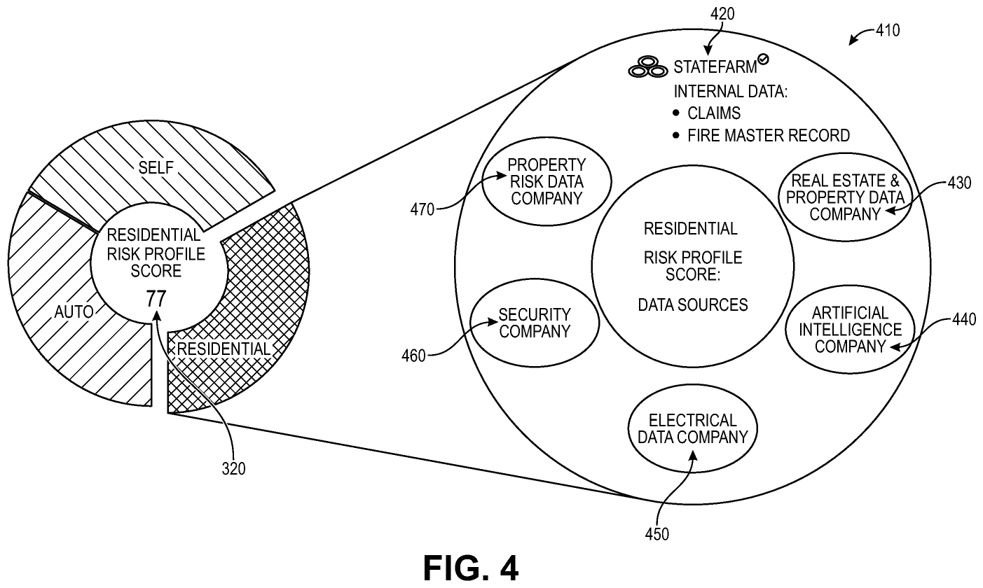

As discussed elsewhere herein, the overall home score 320 may be determined based upon data from any suitable source. In this regard, FIG. 4 illustrates exemplary data sources 410 that may provide data to calculate the overall home score, and/or any of the home subscores. More particularly, the example of FIG. 4 illustrates insurance company 420 (e.g., State Farm, etc.), real estate & property data company 430, artificial intelligence (AI) company 440, electrical data company 450, security company 460, property risk data company 470. Additional examples of data sources not illustrated in FIG. 4 include tech companies, and/or home automation companies; for instance, a home automation company may send data to be analyzed from sensors, cameras, doorbells, etc. It should be appreciated that any of the companies 420, 430, 440, 440, 450, 460, 470 may send data to be used: (i) to calculate the overall home score, the relative home score, and/or any of the home subscores, (ii) make recommendations improve the overall home score or any of the home subscores, (iii) suggest vendors (e.g., to provide parts or services in connection with the recommendations), and/or (iv) train any of the machine learning models discussed herein. In addition, although not shown in FIG. 1, it should be appreciated that any of the companies 420, 430, 440, 440, 450, 460, 470 may be connected (e.g., via network 130) to any component in FIG. 1.

Moreover, the techniques discussed herein have certain advantages. For example, the techniques discussed herein help to predict and prevent loss. For instance, bringing a fire protection subscore to the attention of a user may encourage the user to upgrade her home to reduce the risk of fire, thereby preventing or reducing the risk of loss. In another example, the techniques described herein help users to understand how to improve how they live. For instance, a recommendation (possibly along with an explanation) in connection with a sustainability subscore for adding insulation to a particular room of a house may help a user understand how to improve how she lives. In yet another example, the techniques described herein allow users to easily obtain products and services to improve their home (e.g., by recommending particular vendors, etc.).

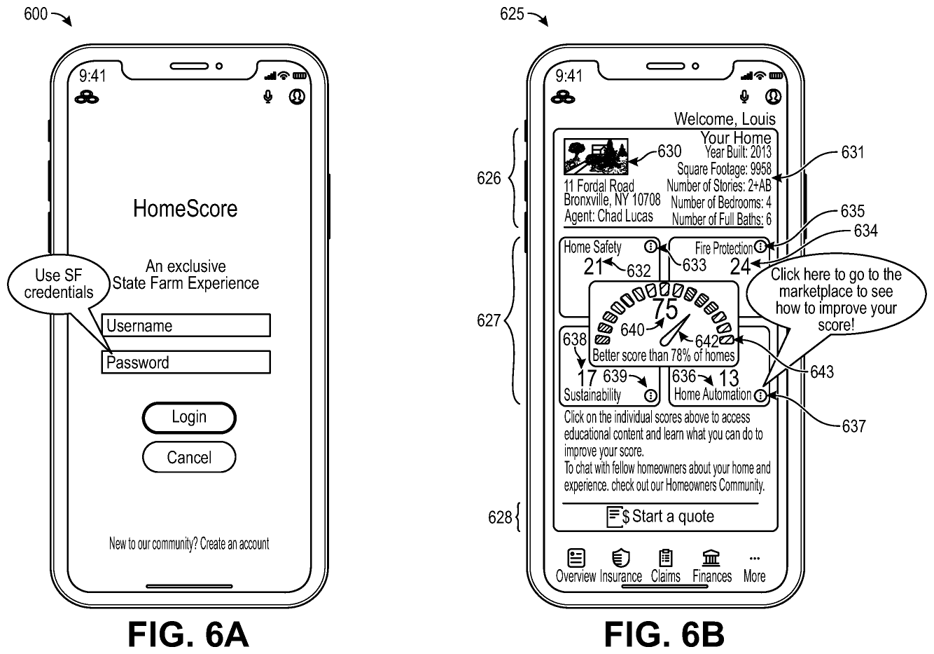

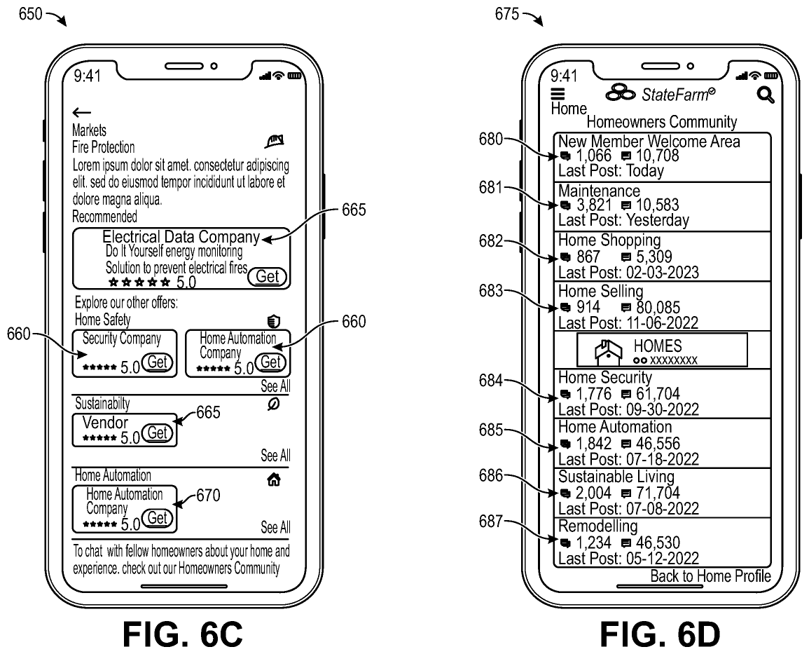

In some embodiments, to begin, a user may enter, for authentication, his login credentials (e.g., username and password) into the exemplary screen 600 of the example of FIG. 6A. Upon authentication of the login credentials, the exemplary home score screen 625 of FIG. 6B may be displayed. However, it should be appreciated that, in some embodiments, the exemplary screen 625 may additionally or alternatively be reached by the user selecting the residential icon 240 of FIG. 2. The exemplary screen 625 may include a first portion 626, which may include identifying information of a home 630 (e.g., address information, etc.), and/or home parameters 631 (e.g., a year built of the home, square footage of the home, a number of stories of the home, a number of bedrooms of the home, a number of bathrooms of the home, etc.). The first portion may further include the name of a real estate agent and/or a name of an insurance agent.

The exemplary screen 625 may further include a second portion 627, which may include overall home score 640. Additionally or alternatively, the overall home score may be indicated by dial 642, which may optionally point to color coded icons 643. Regarding the color coding, in some embodiments, a red color (e.g., towards the left of the range of icons 643) may indicate a lower overall home score, a yellow color (e.g., towards the top of the color-coded icons 643) may indicate an intermediate overall home score, and a green color (e.g., towards the right of the color-coded icons 643) may indicate a higher overall home score.

The second portion 627 may further include a plurality of home subscores, such as home safety subscore 632, fire protection subscore 634, sustainability subscore 638, and/or home automation subscore 636. Each of the subscores 632, 634, 636, 638 may have a corresponding link 633, 635, 637, 639 that allows the user to see recommendations for how to improve the overall home score, and/or any of the home subscores.

The exemplary screen 625 may further include a third portion 628, which may include an option for requesting an insurance quote.

FIG. 6C illustrates an exemplary subscore screen 650 including exemplary recommendations. In particular, the exemplary screen 650 shows fire protection recommendation 655, home safety recommendation 660, sustainability recommendation 665, and home automation recommendation 670.

FIG. 6D illustrates an exemplary homeowners community screen 675. The exemplary screen 675 includes new member welcome area 680, maintenance 681, home shopping 682, home selling 683, home security 684, home automation 685, sustainable living 686, and remodeling 687.

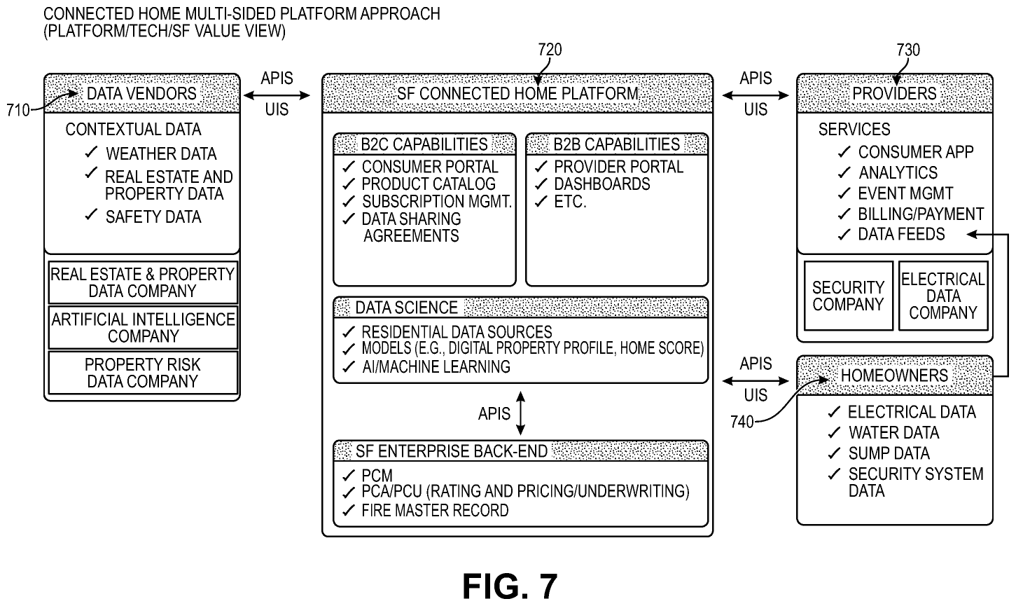

FIG. 7 illustrates interactions between entities. In particular, FIG. 7 illustrates data vendors 710 (e.g., real estate & property data company 430, AI company 440, property risk data company 470, etc.) exchanging data with an insurance company 720 (e.g., insurance company 420 (e.g., State Farm, etc.), requestor 114, request server 140, etc.). Further illustrated are providers 730 (e.g., electrical data company 450, security company 460, etc.), and homeowners 740 (e.g., a user, such as an insurance company customer or prospective customer).

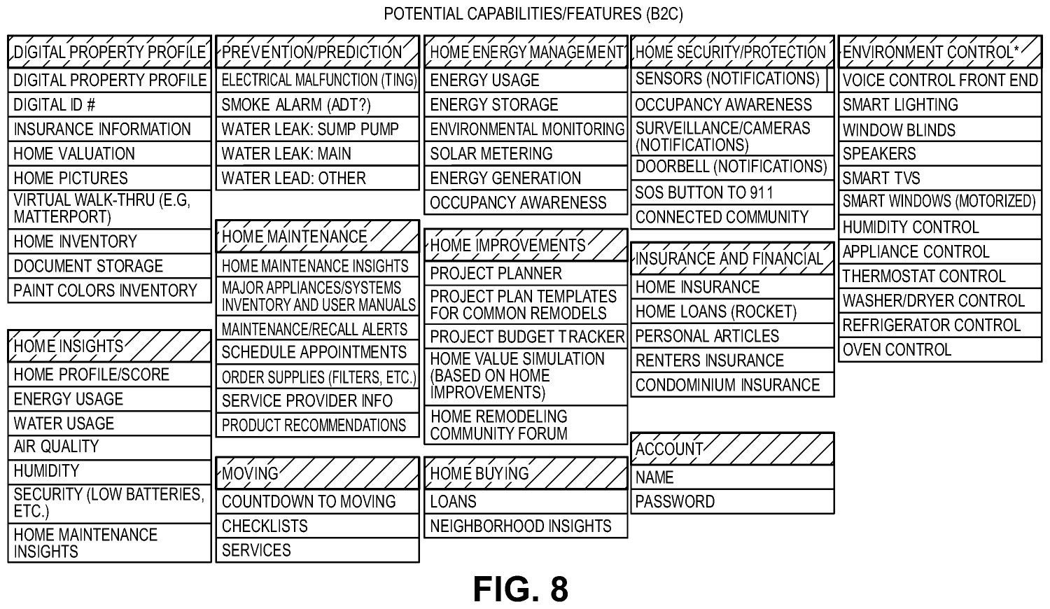

FIG. 8 illustrates potential business-to-customer (B2C) capabilities and/or features of an example system. In particular, FIG. 8 depicts a digital property profile, home insights, prevention/prediction, home maintenance, moving, home energy management, home improvements, home buying, home security/protection, insurance and financial, account, and environment control.

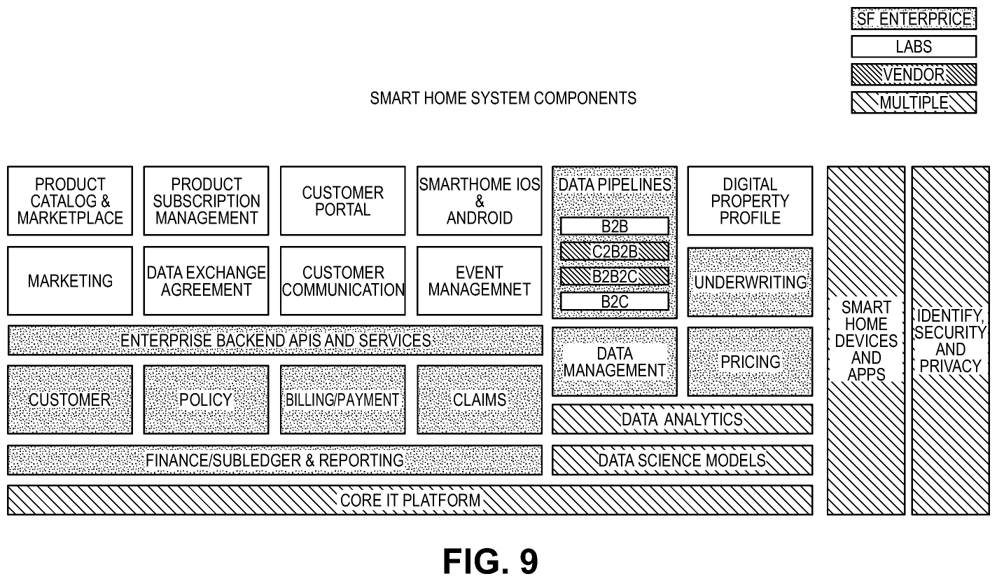

FIG. 9 illustrates exemplary system components. FIG. 9 further illustrates data pipelines business-to-business (B2B), customer-to-business-to-business (C2B2B), business-to-business-customer (B2B2C), and B2C.

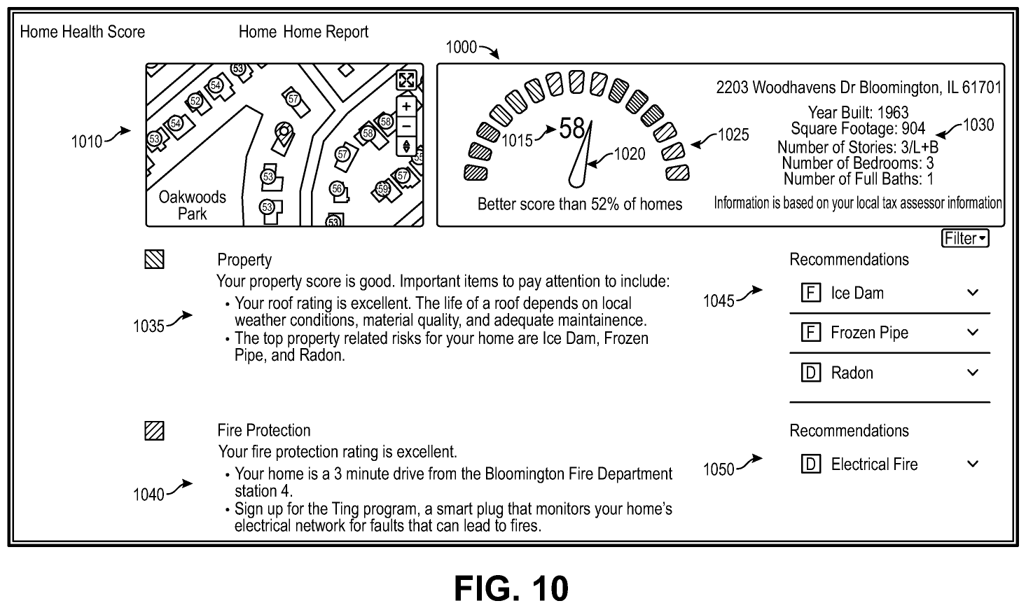

FIG. 10 illustrates an exemplary home health score report 1000, which may be displayed, for example, on the display 160. The exemplary home health score report 1000 may include a map 1010 (e.g., indicating a location of the home). The exemplary home health score report 1000 may further include an alphanumeric overall home health score 1015. The overall home health score may additionally or alternatively be indicated by a dial 1020 pointing to optionally color-coded icons 1025. The color-coding on the icons 1025 may generally indicate the home health score. For example, a red color (e.g., towards the left of the range of icons 1025) may indicate a lower overall home score, a yellow color (e.g., towards the top of the color-coded icons 1025) may indicate an intermediate overall home score, and a green color (e.g., towards the right of the color-coded icons 1025) may indicate a higher overall home score.

The exemplary home health score report 1000 may further display home parameters 1030 (e.g., a year built of the home, square footage of the home, a number of stories of the home, a number of bedrooms of the home, and/or a number of bathrooms of the home, etc.). The exemplary home health score report 1000 may further include an overall property summary 1035. The exemplary home health score report 1000 may further include subscore summary 1040. In the illustrated example, the subscore summary 1040 corresponds to the fire protection subscore.

The exemplary home health score report 1000 may further include overall home recommendations 1045 (e.g., one or more recommendations to improve the overall home score). The exemplary home health score report 1000 may further include home subscore recommendations 1050 (e.g., one or more recommendations to improve a particular home subscore). In the illustrated example, the home subscore recommendations 1050 correspond to the fire protection subscore.

### Exemplary Computer-Implemented Methods

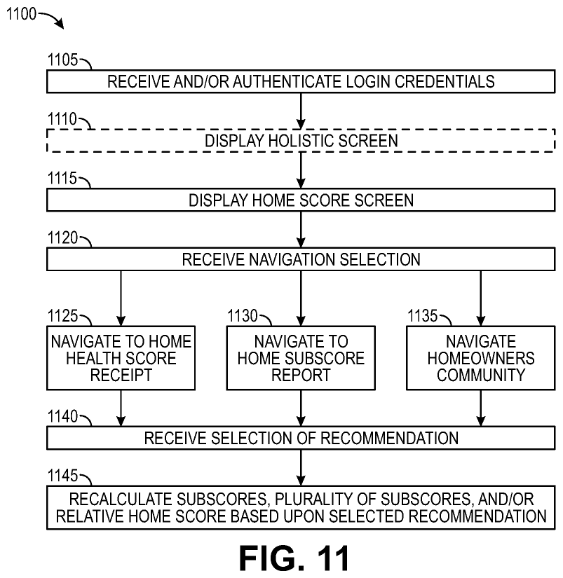

FIG. 11 shows an exemplary computer-implemented method or implementation 1100 for displaying home scores and/or subscores. Although the following discussion refers to the exemplary method or implementation 1100 as being performed by the one or more processors 150, it should be understood that any or all of the blocks may be alternatively or additionally performed by any other suitable component as well (e.g., the one or more processors 142, the one or more processors 122, etc.).

The exemplary implementation 1100 may begin at block 1105 when the one or more processors 150 receive and/or authenticate login credentials (e.g., from the user, such as an insurance company customer or prospective customer) (e.g., as in the example screen 600).

At optional block 1110, the one or more processors 150 display a holistic screen, such as the example screen 200 of FIG. 2. In some examples, this includes displaying: a holistic risk profile score 220; a self icon 230; an auto icon 250; and/or a residential icon 240. In some embodiments, selecting any of the icons 230, 240, 250, causes the selected icon to move away from the other icons (e.g., thereby creating a distance, such as distance 360), and/or causes a score corresponding to the score corresponding to the selected icon to be displayed (e.g., displaying an overall home score 320, such as in the example of FIG. 3).

In some embodiments, the any or all of the icons 230, 240, 250 include links to other screens. For example, selecting the residential icon 240 may (instead of causing the icon 240 to move away from the other icons 230, 250) cause a home score screen (e.g., screen 625 or screen 1000, etc.) to be displayed at block 1115.

In some embodiments, in a first portion 626 of the home score screen 625, identifying information 630 of a home 116 may be displayed. Examples of the identifying information include an image of the home 116, an address of the home 116, etc. In some embodiments, a link to a real estate agent and/or an insurance agent is also displayed alongside the identifying information.

In some embodiments, in the first portion 626 of the display, home parameters 631 are also displayed. Examples of the home parameters 631 include: a year built of the home, square footage of the home, a number of stories of the home, a number of bedrooms of the home, and/or a number of bathrooms of the home.

In some embodiments, in a second portion 627 of the display, an overall home score 640 may be displayed. As will be described elsewhere herein, the overall home score determined by any suitable technique, such as via a machine learning model.

Additionally or alternatively, a relative home score comprising a comparison between the overall home score and scores of other homes may be displayed. For instance, in the example of FIG. 6B, the screen 625 displays that the home score is better than 78% of homes. In some embodiments, the comparison is made to other homes within: a predetermined distance from the home 116; a same zip code as the home 116; a same county as the home 116; a same state as the home 116; or a same country as the home 116.

In some embodiments, the displayed relative home score is displayed as: (i) a numerical score 640, and/or (ii) a dial 642 pointing to icons 643, which may be color coded to indicate relative differences between home scores.

Additionally or alternatively, in the second portion 627 of the display, a plurality of home subscores may be displayed. Examples of the subscores include: a home safety subscore, a fire protection subscore, a sustainability subscore, and/or a home automation subscore. As will be discussed elsewhere herein, the subscores may be determined by any suitable technique, such as via a machine learning model(s).

In some embodiments, the home score may be displayed in a center of the second portion 627 of the display; and/or the subscores may be displayed in corner portions of the second portion 627 display.

Optionally, in a third portion 628 of the display, a link to obtain an insurance quote may be displayed. The quote may be for any type of insurance policy, such as a homeowners insurance policy, a renters insurance policy, a life insurance policy, a disability insurance policy, an auto insurance policy, an umbrella insurance policy, etc. In some embodiments, more than one insurance quote may be displayed. For example, a profile of the user may be accessed to determine which insurance policies the user already has with the insurance company. The one or more processors 150 may then display insurance quotes for types of insurance policies that the user does not have with the company. In some such examples, the one or more processors 150 compare the insurance policies that the user already has with a list of insurance policies offered by the company (e.g., a list including a homeowners insurance policy, a renters insurance policy, a life insurance policy, a disability insurance policy, an auto insurance policy, an umbrella insurance policy, etc.).

At block 1120, a navigation selection is received from the user. For example, the user may choose to navigate to a home health score report (e.g., by clicking on the home score in the second portion 627 of the display). Or the user may choose to navigate to a home subscore report (e.g., by clicking on any of the sub score reports 632, 634, 636, 638, clicking on links 633, 635, 637, 639, etc.). Or the user may choose to navigate to a homeowners community screen.

If the user selects to navigate to a home health score report screen, a display, such as the exemplary display 1000 may be displayed at block 1125.

If the user selects to navigate to a subscore screen, a display, such as the exemplary display 650 may be displayed at block 1130.

If the user selects to navigate to a homeowners community screen, a display, such as the exemplary display 675 may be displayed at block 1135.

At any of the home health score report screen, the subscore screen, and/or the homeowners community screen, one or more recommendations for how to improve any of the home subscores or the overall home score may be displayed. It should thus be understood that the following discussion applies to any of the home health score report screen, the subscore screen, and/or the homeowners community screen.

In some examples, the recommendation may be a recommendation to perform a particular repair using a particular vendor. Examples of the repair include roofing repairs, pluming repairs, driveway repairs, window repairs, insulation repairs, security system repairs, smoke alarm repairs, carbon dioxide sensor repairs, carbon monoxide sensor repairs, etc.

In other examples, the recommendation may be a recommendation to make a home improvement. Examples of home improvements include adding: an electrical monitoring system (e.g., thereby improving prevention of electrical fires), a security system, a smart home device (e.g., a smart thermostat, etc., thereby improving the home automation subscore), insulation (e.g., thereby improving the sustainability subscore), a fire escape ladder (e.g., thereby improving the fire protection subscore), babyproofing devices (e.g., thereby improving the home safety subscore), etc.

In some examples, the recommendations may be presented as a list of recommendations from a person (e.g., an influencer, a home improvement TV show host, etc.).

Additionally or alternatively, the recommendations may be made by the “community.” For example, other people in the same geographic region (e.g., within a predetermined distance of the home, within the same town, within the same zip code, within the same county, etc.) may post recommendations, such as recommendations for vendors, etc.

Additionally or alternatively, the recommendations may be made by a chatbot, such as an artificial intelligence (AI) and/or machine learning (ML) chatbot, a ChatGPT bot, ChatGPT-based bot, or other voice bot.

In some embodiments, once a user has selected a recommendation (e.g., any of the recommendations 655, 660, 665, 670, etc.) (e.g., at block 1140), the subscores and/or overall home score may be recalculated (e.g., updated) based upon the selection (e.g., at block 1145). In one such example, the system returns to the home score screen 650, which then displays the recalculated score(s); in this way, the system may be “dynamically” updated. Advantageously, dynamically updating the system to show score improvements may increase a user's interest in the system, and may increase the chance that the user makes the recommended improvement to the home. For example, if the recommendation is to have babyproofing devices installed, the user may be more likely to have the devices installed if she sees how they improve her score. And, once the babyproofing devices are installed, the home is advantageously more safe.

In some embodiments, the system verifies that the improvement or addition corresponding to the recommendation has been completed before recalculating the score. For example, the system may display a screen requesting confirmation from the user that the work has been completed. Additionally or alternatively, the system may request verification from a vendor 182 that the work has been completed before recalculating the score(s).

It should be understood that not all blocks and/or events of the exemplary signal diagrams and/or flowcharts are required to be performed. Moreover, more blocks may be performed even though they are not specifically illustrated. The exemplary signal diagrams and/or flowcharts may include additional, less, or alternate functionality, including that discussed elsewhere herein.

Exemplary Al and/or ML Techniques

Broadly speaking, AI and/or ML algorithm(s) and/or model(s) may be used to determine any of the overall home score and/or the home subscores. Although the following discussion refers to an ML algorithm, it should be appreciated that it applies equally to ML and/or AI algorithms and/or models.

In some embodiments, individual machine learning algorithms are used to determine the home subscores, and then the home subscores are aggregated together (e.g., either by averaging, or by taking a weighted average) to determine the overall home score. To this end, in some examples: the home safety subscore is calculated via a home safety subscore machine learning algorithm; the fire protection subscore, is calculated via a fire protection subscore machine learning algorithm; the sustainability subscore is calculated via a sustainability subscore machine learning algorithm; and/or the home automation subscore is calculated via a home automation machine subscore learning algorithm.

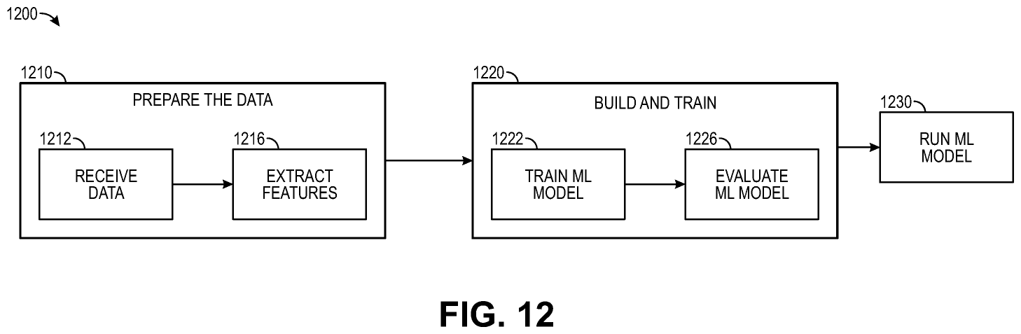

FIG. 12 is a block diagram of an exemplary machine learning modeling method 1200 for training and evaluating a ML algorithm (e.g., an overall home score ML algorithm, a home safety subscore machine learning algorithm, a fire protection subscore machine learning algorithm, a sustainability subscore machine learning algorithm, and/or a home automation machine learning algorithm, etc.), in accordance with various embodiments. In some embodiments, the model “learns” an algorithm capable of performing the desired function, such as determining any of the overall home score, the home safety subscore, the fire protection subscore, and/or the home automation subscore. It should be understood that the principles of FIG. 12 may apply to any machine learning algorithm discussed herein.

Although the following discussion refers to the blocks of FIG. 12 as being performed by the one or more processors 142, it should be appreciated that the blocks of FIG. 12 may be performed by any suitable component or combinations of components (e.g., the one or more processors 122, the one or more processors 142, the one or more processors 150, etc.).

At a high level, the machine learning modeling method 1200 includes a block 1210 to prepare the data, a block 1220 to build and train the model, and a block 1230 to run the model.

Block 1210 may include sub-blocks 1212 and 1216. At block 1212, the one or more processors 142 may receive (e.g., from any of the data sources 410, a tech company, a home automation company, etc.) the historical information to train the machine learning algorithm. In some examples, the historical information comprises: (i) inputs to the machine learning model (e.g., also referred to as independent variables, or explanatory variables), and/or (ii) outputs of the machine learning model (e.g., also referred to as dependent variables, or response variables). In some such examples, the dependent variables are the scores that the ML algorithm is trained to determine (e.g., the dependent variable of the fire protection subscore ML algorithm is the fire protection subscore); and the independent variables are used to determine the dependent variables (e.g., an independent variable of the fire protection subscore ML algorithm may be a distance of the home to a fire station, etc.). Put another way, the independent variables may have an impact on the dependent variables; and the ML algorithms may be trained to find this impact. Therefore, when using a trained ML algorithm to determine a score, information of the home corresponding to the historical information that the ML was trained on may be routed into the ML algorithm to determine the score/subscore (e.g., a home safety subscore machine learning algorithm trained on historical radon information of homes may have information of the home including radon information routed to it to determine the home safety subscore).

More specifically, for the historical information used to train the home safety subscore machine learning algorithm, examples of the independent variables may include historical: radon information of homes, tree overhang information of homes, climate information of a geographic area of homes (e.g., home in known earthquake area, known tornado area, known flood area, etc.), crime rate information of a geographic area, security system information of homes, geographic (e.g., physical) distance from homes to police stations, estimated time distances from homes to police stations (e.g., in certain areas it may take longer for the police to reach a particular property due to the roads, etc.), physical distance of homes to medical care facilities, estimated time distances to the medical care facilities, building materials of an interior of homes (e.g., entire house is carpeted, thereby reducing the risk of harm if a person falls in the house), lighting on a street that homes are located on, roof condition information of homes, structural information of homes, mold information of homes, plumbing information of homes, elevation data (e.g., elevation of the geographic area of homes, etc.), babyproofing devices of homes, frequencies with which a home occupant forgets to lock doors and/or close windows, number of people who live in homes full time, number of people who live in homes part time, number of hours someone is typically present at a home, hazards of homes, etc. An example of the dependent variable in the historical information is the home safety subscore.

Therefore, when using the home safety subscore machine learning algorithm to determine the home safety subscore, examples of the information of the home routed to the home safety subscore machine learning algorithm may include: radon information of a home, tree overhang information of the home, climate information of a geographic area of the home (e.g., home in known earthquake area, known tornado area, known flood area, etc.), crime rate information of a geographic area of the home, security system information of the home, geographic (e.g., physical) distance from the home to a police station, estimated time distance from the home to a police station (e.g., in certain areas it may take longer for the police to reach a particular property due to the roads, etc.), physical distance of the home to a medical care facility, estimated time distance from the home to the medical care facility, building materials of an interior of the home (e.g., entire house is carpeted, thereby reducing the risk of harm if a person falls in the house), lighting on a street that the home is located on, roof condition information of the home, structural information of the home, mold information of the home, plumbing information of the home, elevation data (e.g., elevation of the geographic area of the home, etc.), babyproofing devices of the home, frequency of occupant forgetting to lock doors and/or close windows, how many people live at the home full time, how many people live at the home part-time, how many hours a day someone is typically present at the home, hazards present at the home, etc.

For the historical information used to train the fire protection subscore machine learning algorithm, examples of the independent variables may include historical: geographic (e.g., physical) distances of homes to fire stations, estimated time distance from homes to fire stations (e.g., in certain areas it may take longer for the fire truck to reach a particular property due to the roads, etc.), quality of smoke alarms of homes, number of smoke alarms of homes, other types of devices (e.g., cameras, and/or other smart devices) of homes that may detect fires, percentage of the year that properties are occupied, building materials of homes, structural design of homes, geographic area of homes (e.g., home near known wildfire location, etc.), electrical usage information of homes, proximity of homes to fire hydrants, fire extinguisher information (e.g., how many fire extinguishers are in the home; where the fire extinguishers are kept within the home; etc.) of homes, etc. An example of the dependent variable in the historical information is the fire protection subscore.

Therefore, when using the fire protection subscore machine learning algorithm to determine fire protection subscores, examples of the information of the home routed to the fire protection machine learning algorithm may include: geographic (e.g., physical) distance of the home to a fire station, estimated time distance from the home to fire station (e.g., in certain areas it may take longer for the fire truck to reach a particular property due to the roads, etc.), quality of smoke alarms of the home, number of smoke alarms of the home, other types of devices (e.g., cameras, and/or other smart devices) of the home that may detect fires, percentage of the year that a property is occupied, building materials of the home, structural design of the home, geographic area of the home (e.g., home near known wildfire location, etc.), electrical usage information of the home, proximity of the home to a fire hydrant, fire extinguisher information (e.g., how many fire extinguishers are in the home; where the fire extinguishers are kept within the home; etc.), etc.

For the historical information used to train the sustainability subscore machine learning algorithm, examples of the independent variables may include historical: electricity use of homes, water use of homes, natural gas use of homes, insulation quality (e.g., materials used for insulation, amount of insulation) of homes, home structure information (e.g., one home design leaks more heat than another, etc.), square footage of homes, etc. An example of the dependent variable in the historical information is the sustainability subscore.

Therefore, when using the sustainability subscore machine learning algorithm to determine the sustainability subscore, examples of the examples of the information of the home routed to the sustainability subscore machine learning algorithm may include: electricity use of the home, water use, natural gas use of the home, insulation quality (e.g., materials used for insulation, amount of insulation) of the home, home structure information (e.g., one home design leaks more heat than another, etc.), square footage of the home, etc.

For the historical information used to train the home automation subscore machine learning algorithm, examples of the independent variables may include historical: numbers of smart devices in homes, types of smart devices in homes, functions of smart devices in homes, quality of smart devices in homes, age of smart devices in homes, condition of smart devices in homes, etc. An example of the dependent variable in the historical information is the home automation subscore.

Thus, when using the home automation subscore machine learning algorithm to determine the home automation subscore, examples of the information of the home routed to the home automation subscore machine learning algorithm may include: a number of smart devices of the home, types of smart devices in the home, functions of smart devices in the home, quality of smart devices in the home, ages of smart devices in the home, condition of smart devices in home, etc.

In certain embodiments where an overall home score ML algorithm is trained to determine an overall home score, examples of the independent variables include any of the examples given above with respect to the subscore machine learning algorithms. And an example of the dependent variable is the overall home score. Therefore, when using the overall home score machine learning algorithm to determine the overall home score, examples of the information of the home routed to the overall home score machine learning algorithm include any of those given above with respect to the subscore machine learning algorithms.

The historical information and/or information of the home may be received from any suitable source. Examples of sources that any of the historical information and/or information of the home may be received from include: mobile device 112, smart product 110, request server 140, requestor 114, vendor 182, security company 180, insurance company 420, real estate & property data 430, artificial intelligence (AI) company 440, electrical data company 450, security company 460, property risk data company 470, a database holding insurance profiles of insurance customers, etc. It should be appreciated that the historical information and/or information of the home may be received from combinations of these sources as well.

Block 1220 may include sub-blocks 1222 and 1226. At block 1222, the machine learning (ML) model is trained (e.g. based upon the data received from block 1210). In some embodiments where associated information is included in the historical information, the ML model “learns” an algorithm capable of calculating or predicting the target feature values (e.g., determining score(s), etc.) given the predictor feature values.

At block 1226, the one or more processors 142 may evaluate the machine learning model, and determine whether or not the machine learning model is ready for deployment.

Further regarding block 1226, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information, such as the historical information discussed above), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

In some embodiments, ML algorithms are used to determine the subscores, and then the subscores are averaged to determine the overall home score.

In some embodiments, ML algorithms are used to determine the subscores, and then the overall home score is determined by taking a weighted average of the subscores. The weights may be determined by any suitable technique. For example, the weights may be based upon geographic region of the home, time of year, climate data, weather data, etc. In one working example, in a geographic region known for wildfires, during the wildfire season, the fire protection subscore may be given a greater weight than during the non-wildfire season.

Advantageously, using separate machine learning algorithms to determine individual subscores, and then determining the overall home score based upon the subscores improves accuracy of the overall home score determination, thereby improving technical functioning.

Moreover, it should be appreciated the ML algorithm(s) may be any kind of ML algorithms (e.g., neural networks, convolutional neural networks, deep learning algorithms, etc.).

In addition, in some embodiments, ML algorithms may be used to determine the recommendations for how to improve the subscores. For example, the one or more processors 142 may use the ML algorithms to determine how much of a change particular house modifications will make to a subscore, and then present the particular modifications with the most positive change to the user as the recommendations to improve the subscore(s). Additionally or alternatively, the ML algorithm(s) may directly determine the recommendation(s) (e.g., determine recommendations according to the input variables discussed above).

However, the recommendations do not necessarily need to be determined with the use of a ML algorithm. For example, there may be default recommendations, which may be presented if a home does not have them (e.g., home does not have a security system, so a recommendation is made to install a security system).

### Additional Exemplary Embodiments—Determining and/or Displaying Home Scores

In one aspect, computer-implemented method for determining and/or displaying home scores may be provided. The method may be implemented via one or more local or remote processors, sensors, transceivers, servers, memory units, augmented reality glasses or headsets, extended or virtual reality headsets, smart glasses or watches, wearables, voice bots or chatbots, and/or other electronic or electrical components. For instance, in one example, the method may include: (1) displaying, via one or more processors, in a first portion of a display, identifying information of a home; and/or (2) displaying, via one or more processors, in a second portion of the display: (a) an overall home score determined based upon a plurality of home subscores; (b) the plurality of home subscores comprising: a home safety subscore determined via a home safety subscore machine learning algorithm, a fire protection subscore determined via a fire protection subscore machine learning algorithm, a sustainability subscore determined via a sustainability subscore machine learning algorithm, and/or a home automation subscore determined via a home automation subscore machine learning algorithm; and/or (c) a relative home score comprising a comparison between the overall home score and scores of other homes. The method may include additional, fewer, or alternate actions, including those discussed elsewhere herein.

In some embodiments, the method may further include displaying, via the one or more processors, at least one recommendation for how to improve a subscore of the plurality of subscores.

In some embodiments, the at least one recommendation is displayed in response to a user selecting a link located in the second portion of the screen. In some embodiments, the at least one recommendation may include a recommendation to perform a particular repair using a particular vendor.

In some embodiments, the plurality of home subscores comprises the home safety subscore, the fire protection subscore, the sustainability subscore, and the home automation subscore; and/or the method further includes: displaying, via the one or more processors, a link corresponding to the home safety subscore, a link corresponding to the fire protection subscore, a link corresponding to the sustainability subscore, and/or a link corresponding to the home automation subscore; in response to a user selecting the link corresponding to the home safety subscore, displaying, via the one or more processors, at least one recommendation to improve the home safety subscore; in response to a user selecting the link corresponding to the fire protection subscore, displaying, via the one or more processors, at least one recommendation to improve the fire protection subscore; in response to a user selecting the link corresponding to the sustainability subscore, displaying, via the one or more processors, at least one recommendation to improve the sustainability subscore; and/or in response to a user selecting the link corresponding to the home automation subscore, displaying, via the one or more processors, at least one recommendation to improve the home automation subscore.

In some embodiments, the displayed relative home score is displayed as a percentage indicating the comparison between the overall home score and the scores of the other homes.

In some embodiments, the other homes may include homes within: a predetermined distance from the home; a same zip code as the home; a same county as the home; a same state as the home; or a same country as the home.

In some embodiments, the displayed relative home score is displayed as: (i) a numerical score, and (ii) a dial pointing to icons, wherein the icons are color coded to indicate relative differences between home scores.

In some embodiments, the method may further include: displaying, via the one or more processors, at least one recommendation for how to improve a subscore of the plurality of subscores; receiving, via the one or more processors, an indication that the at least one recommendation has been selected; and/or in response to receiving that at least one indication that the at least one recommendation has been selected, updating, via the one or more processors the displayed: (i) numerical score, and/or (ii) dial pointing to icons.

In some embodiments, the home score is displayed in a center of the second portion of the display; and/or the subscores are displayed in corner portions of the second portion of the display.

In some embodiments, the method may further include displaying, via the one or more processors, in a third portion of the display, a link to obtain a homeowners insurance quote.

In some embodiments, the displayed identifying information may include an address of the home, and/or the method further may include: displaying, via the one or more processors, in the first portion of the display, home parameters including: a year built of the home, square footage of the home, a number of stories of the home, a number of bedrooms of the home, and/or a number of bathrooms of the home.

In some embodiments, the method may further include displaying a holistic screen displaying: a holistic risk profile score; a self icon; an auto icon; and/or a residential icon; and/or wherein: selecting the self icon causes: (i) on the display, the self icon to move away from the auto icon and the residential icon, and (ii) a self-risk score to be displayed; selecting the auto icon causes: (i) on the display, the auto icon to move away from the self icon and/or the residential icon, and/or (ii) an auto risk score to be displayed; and/or selecting the residential icon causes: (i) on the display, the residential icon to move away from the self icon and the auto icon, and/or (ii) the overall home score to be displayed.

In some embodiments, the method may further include displaying a holistic screen displaying: a holistic risk profile score; a self icon including a self risk score link; an auto icon including an auto risk score link; and/or a residential icon including a home risk score link; and/or wherein displaying the identifying information of the home and displaying the overall home score, the relative home score and the plurality of home subscores occurs in response to a user selecting the home risk score link.

In some embodiments, the plurality of home subscores may include the home safety subscore, the fire protection subscore, the sustainability subscore, and the home automation subscore; and/or the overall home score is determined based upon a weighted average of each of the home safety subscore, the fire protection subscore, the sustainability subscore, and/or the home automation subscore.

In some embodiments, the method may further include determining, via the one or more processors, the weighted average by setting weights of each of the home safety subscore, the fire protection subscore, the sustainability subscore, and the home automation subscore based upon geographic region of the home, time of year, and/or climate data.

In another aspect, a computer system for determining and/or displaying home scores may be provided. The computer system may include one or more local or remote processors, sensors, transceivers, servers, memory units, augmented reality glasses or headsets, extended or virtual reality headsets, smart glasses or watches, wearables, and/or other electronic or electrical components. For example, in one instance, the computer system may include one or more processors configured to: (1) display, in a first portion of a display, identifying information of a home; and/or (2) display, in a second portion of the display: (a) an overall home score determined based upon a plurality of home subscores; (b) the plurality of home subscores including: a home safety subscore determined via a home safety subscore machine learning algorithm, a fire protection subscore determined via a fire protection subscore machine learning algorithm, a sustainability subscore determined via a sustainability subscore machine learning algorithm, and/or a home automation subscore determined via a home automation subscore machine learning algorithm; and/or (c) a relative home score including a comparison between the overall home score and scores of other homes. The computer system may include additional, less, or alternate functionality, including that discussed elsewhere herein.

In some embodiments, the one or more processors are further configured to: train a fire protection machine learning algorithm by inputting historical information into the fire protection machine learning algorithm, the historical information comprising: (i) independent variables comprising (a) historical geographic distances of homes to fire stations, and/or (b) historical estimated time distances from homes to fire stations, and/or (ii) dependent variables comprising historical fire protection subscores; and/or determine the fire protection subscore by routing information of the home into the fire protection machine learning algorithm.

In yet another aspect, a computer device for determining and/or displaying home scores may be provided. The computer device may include one or more local or remote processors, sensors, transceivers, servers, memory units, augmented reality glasses or headsets, virtual reality headsets, extended or mixed reality headsets, smart glasses or watches, wearables, voice or chatbots, and/or other electronic or electrical components. For instance, in one example, the computer device may include: one or more processors; and/or one or more non-transitory memories. The one or more non-transitory memories having stored thereon computer-executable instructions that, when executed by the one or more processors, cause the computer device to: (1) display, in a first portion of a display, identifying information of a home; and/or (2) display, in a second portion of the display: (a) an overall home score determined based upon a plurality of home subscores; (b) the plurality of home subscores including: a home safety subscore determined via a home safety subscore machine learning algorithm, a fire protection subscore determined via a fire protection subscore machine learning algorithm, a sustainability subscore determined via a sustainability subscore machine learning algorithm, and/or a home automation subscore determined via a home automation subscore machine learning algorithm; and/or (c) a relative home score including a comparison between the overall home score and scores of other homes. The computer device may include additional, less, or alternate functionality, including that discussed elsewhere herein.

In some embodiments, the one or more non-transitory memories having stored thereon computer executable instructions that, when executed by the one or more processors, cause the computer device to: train a home automation machine learning algorithm by inputting historical information into the home automation machine learning algorithm, the historical information comprising: (i) independent variables including (a) historical numbers of smart devices of homes, and/or (b) historical types of smart devices in homes, and/or (ii) dependent variables comprising historical homes automation subscores; and/or determine the home automation subscore by routing information of the home into the home automation machine learning algorithm.

### Embodiments Relating to Ecosystems for: (i) Prediction and/or Prevention of Loss, and/or (ii) Initiating an Action Following Occurrence of an Event

Additionally or alternatively to home scores, some embodiments create a home ecosystem app. In some such embodiments, the home ecosystem app: (i) predicts and/or prevents loss, and/or (ii) initiates an action following occurrence of an event.

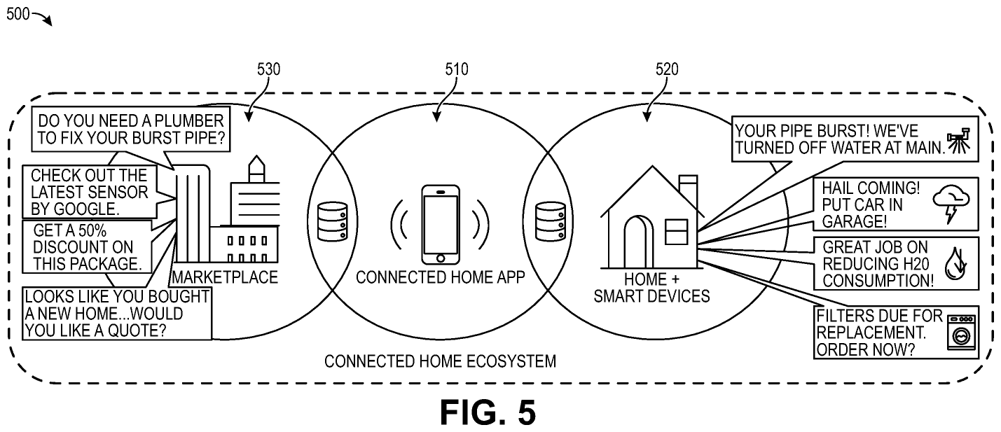

To this end, FIG. 5 depicts an exemplary ecosystem 500, including app 510 (e.g., which may run on the mobile device 112), home & smart devices 520, and marketplace 530.

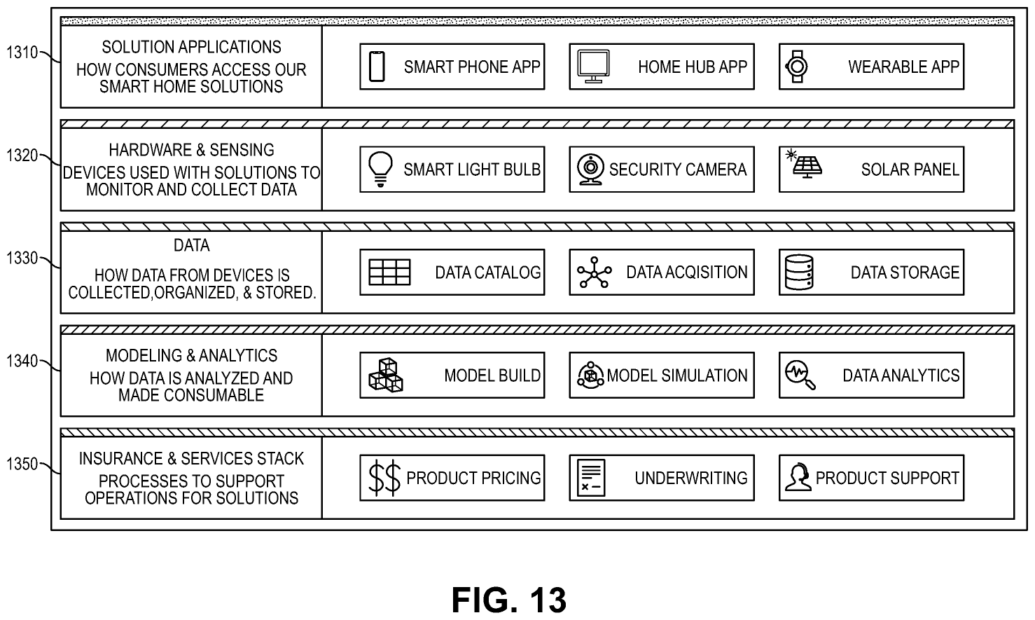

In some examples, the ecosystem 500 may include one or more layers, such as illustrated in the example of FIG. 13. More specifically, the exemplary layers of the exemplary ecosystem 500 comprise a solution applications layer 1310, a hardware & sensing layer 1320, a data layer 1330, a modeling and analytics layer 1340, and an insurance & services stack layer 1350.

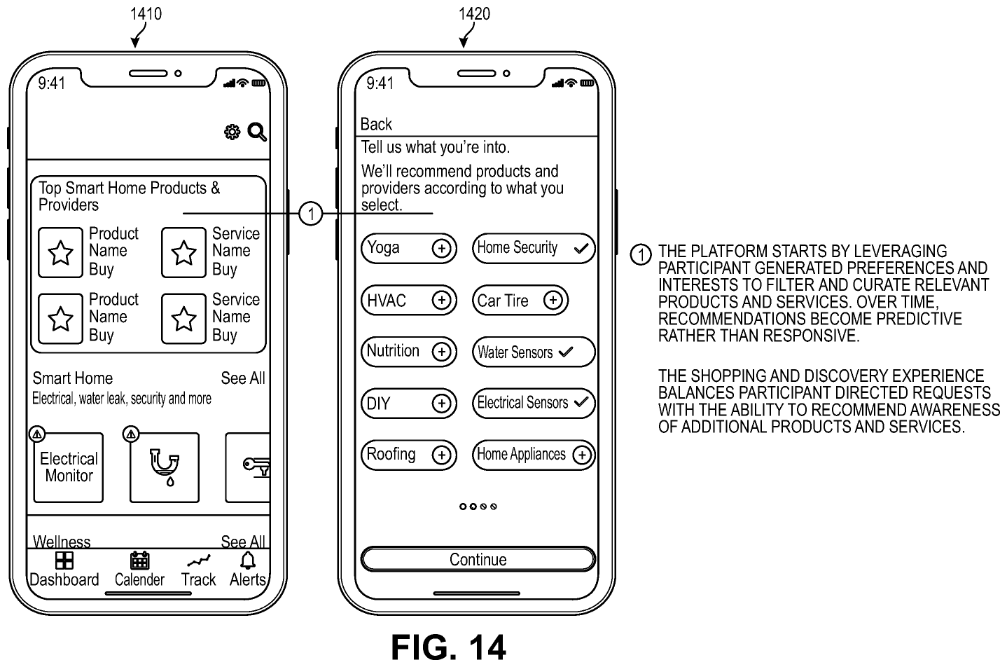

Such layers may form the basis for screens of the app 510, such as those shown in the examples of FIGS. 14-20.

Broadly speaking, regarding FIG. 14, exemplary screens 1410 and 1420 illustrate exemplary interactions enabling app users (e.g., insurance customers) to collect, connect, and monitor various products and services they may need to manage everyday life.

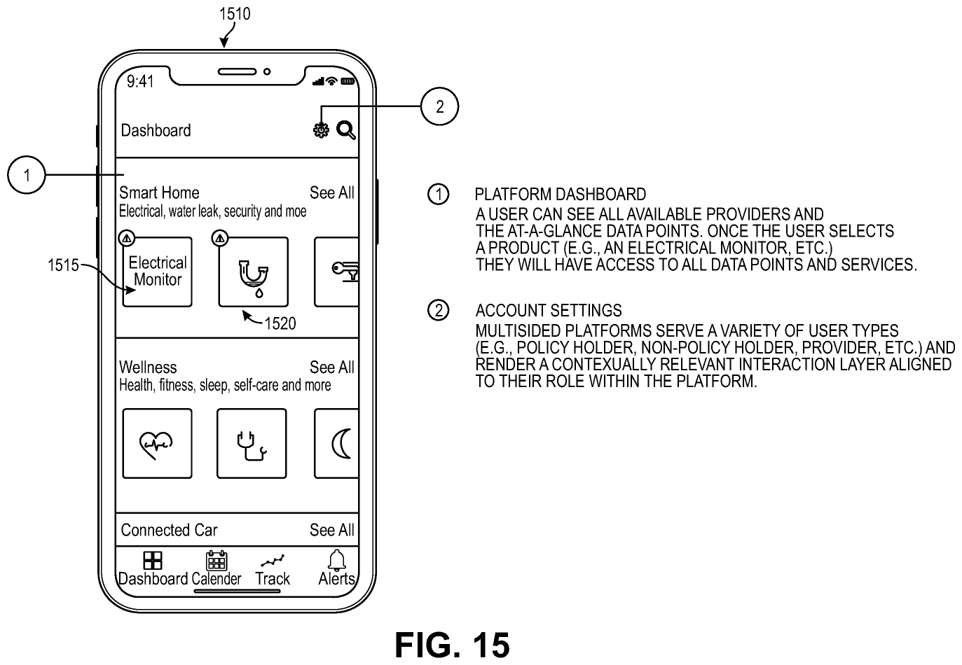

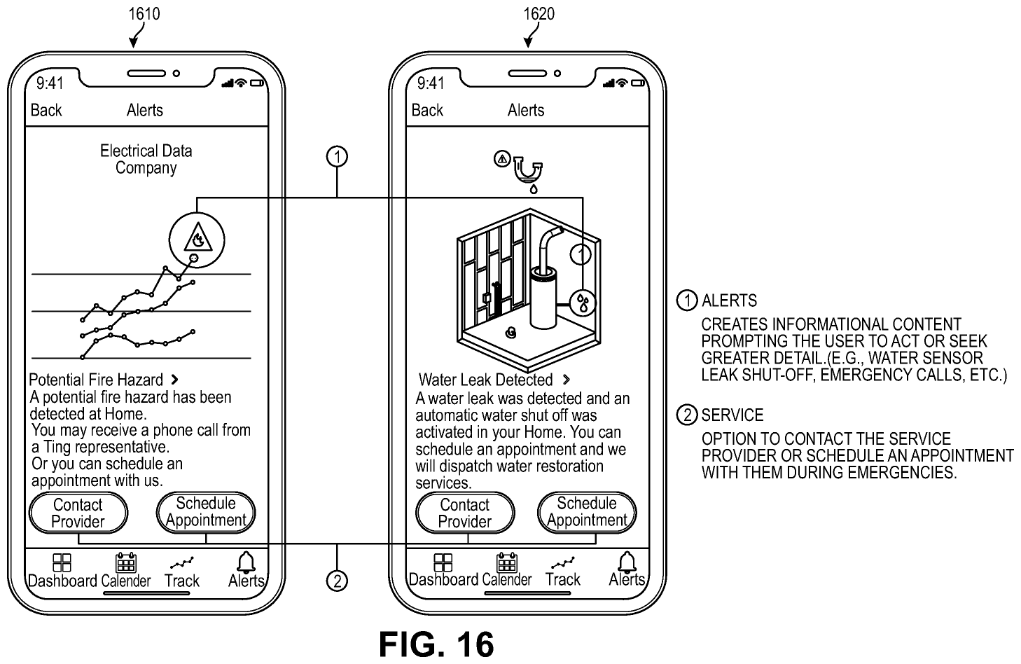

FIG. 15 illustrates exemplary screen 1510 allowing a user to access data from smart devices (e.g., smart product 110, etc.), such as an electrical monitor, a water-related smart device (e.g., a flow monitor in a pipe, a smart water heater, etc.). In some examples, pressing the button 1515 may cause the example screen 1610 of FIG. 16 to be displayed (e.g., a screen that provides data from the electrical monitor). And pressing the button 1520 may cause the example screen 1620 of FIG. 16 to be displayed (e.g., a screen that provides data from the water-related smart device).

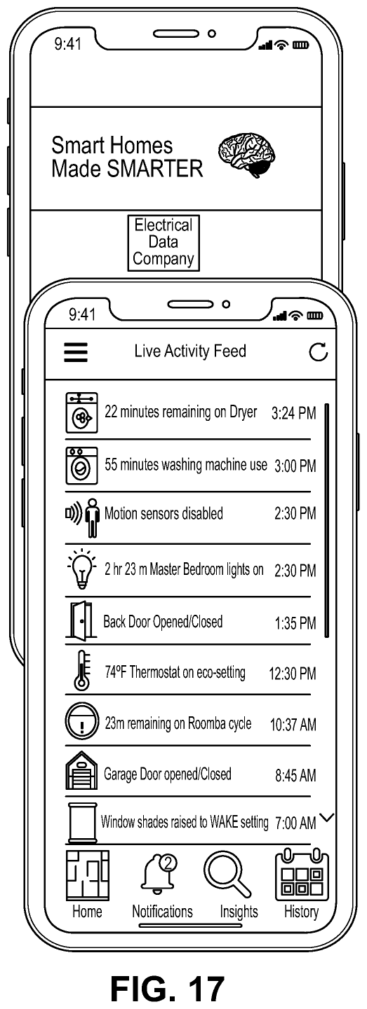

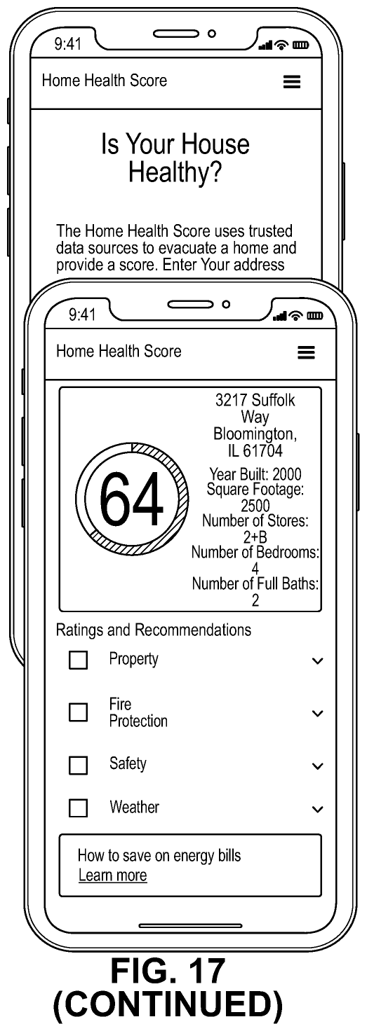

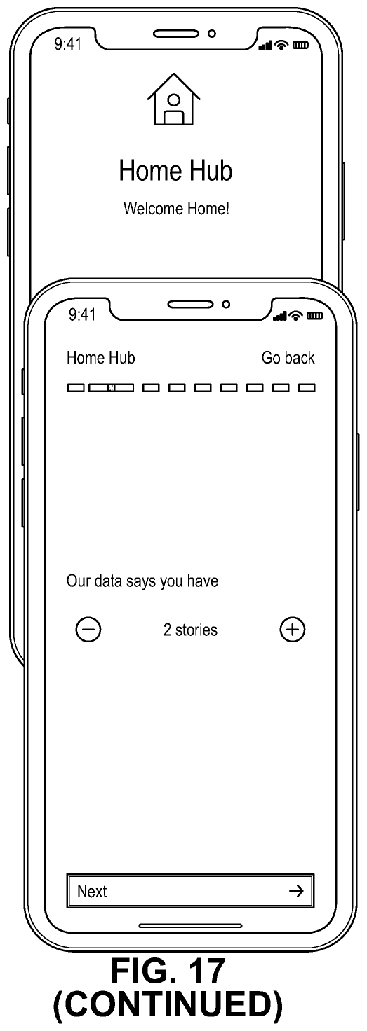

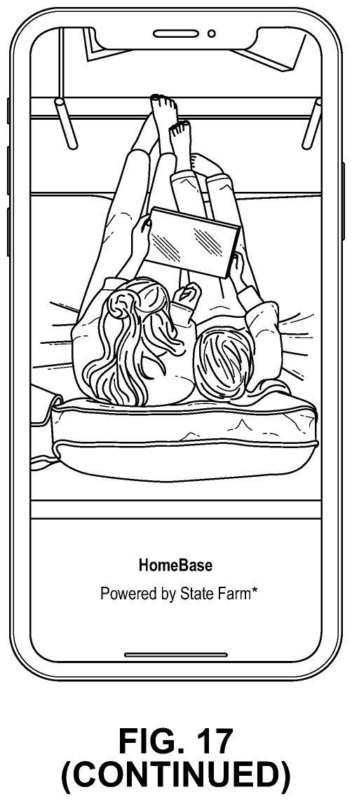

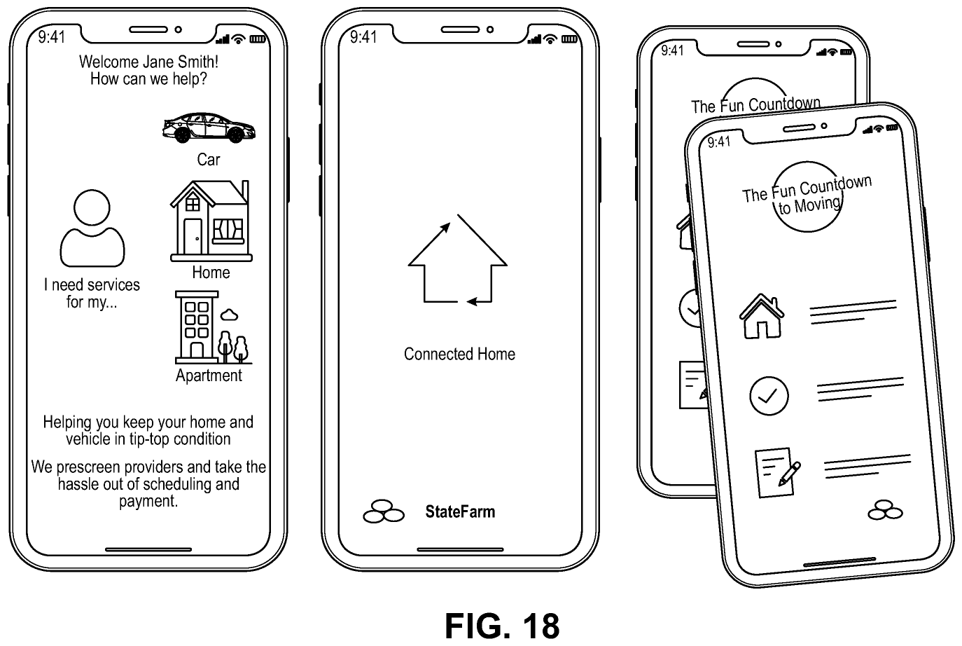

FIGS. 17 and 18 illustrate additional exemplary screens of an exemplary app, in accordance with embodiments described herein.

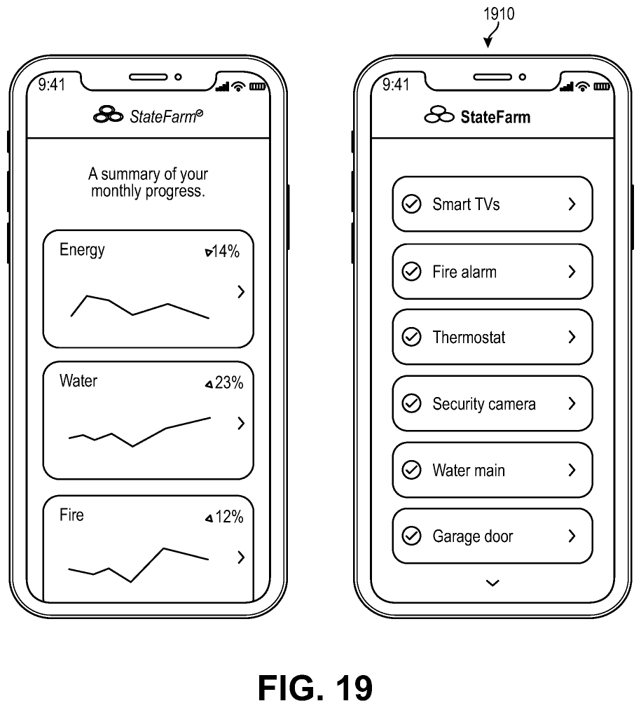

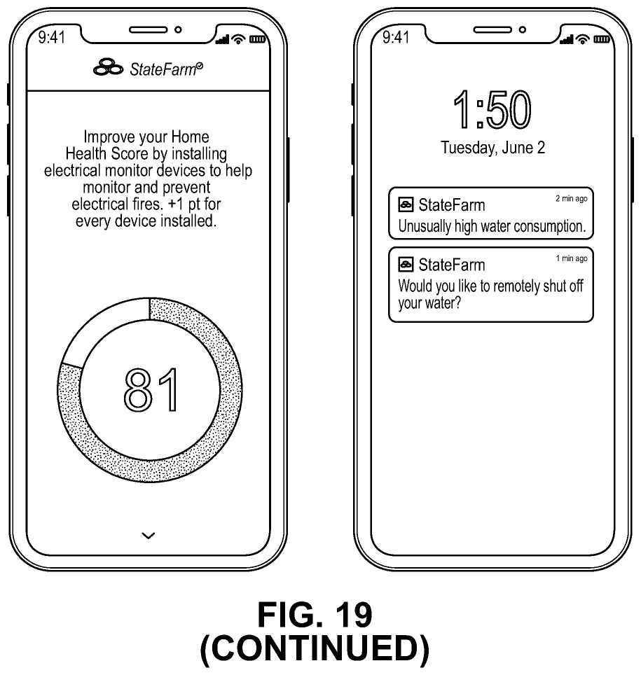

FIG. 19 illustrates additional exemplary screens of an exemplary app, including screen 1910, which allows access to various smart home devices.

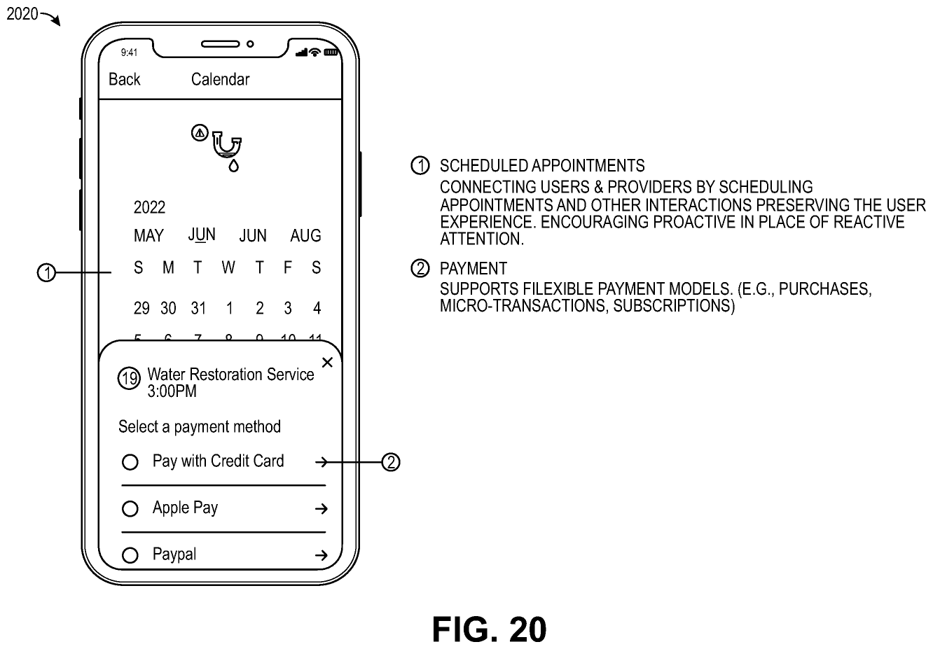

FIG. 20 illustrates an exemplary screen 2010 facilitating scheduling of water restoration.

Exemplary Computer-Implemented Methods—Ecosystems for Prediction and/or Prevention of Loss

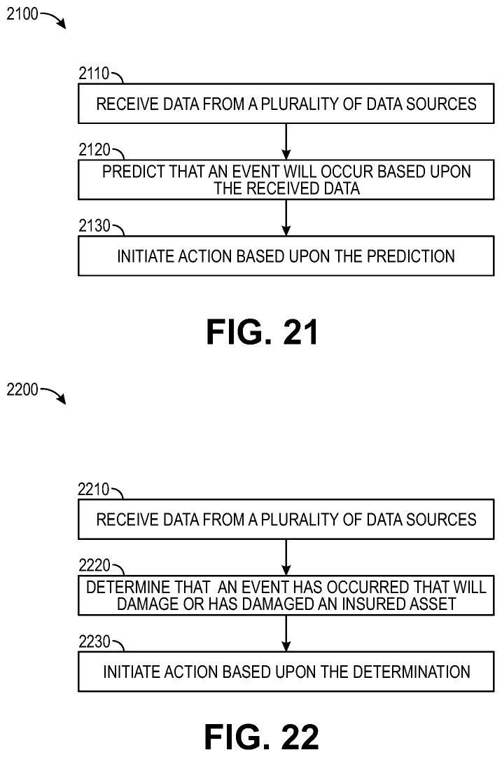

FIG. 21 shows an exemplary computer-implemented method or implementation 2100 for an ecosystem for prediction and/or prevention of loss. Although the following discussion refers to the exemplary method or implementation 2100 as being performed by the one or more processors 150, it should be understood that any or all of the blocks may be alternatively or additionally performed by any other suitable component as well (e.g., the one or more processors 142, the one or more processors 122, etc.).

The exemplary implementation 2100 may begin at block 2110 when the one or more processors 150 receive data from a plurality of data sources. Examples of the plurality of data sources may include: smart home devices, a weather database 199, an insurance company (e.g., insurance company 420), a real estate & property data company (e.g., estate & property data company 430), AI company (e.g., AI company 440), an electrical data company (e.g., electrical data company 450), a security company (e.g., security company 460), and/or a property risk data company (e.g., property risk data company 470). The data may be received via the network 130.

The smart home devices may include any smart home devices, such as a smart: dryer, washer, sump pump, water heater, thermostat, dishwasher, sprinkler system, refrigerator, freezer, microwave, clock, light bulb, toaster, air fryer, toothbrush, etc.

Each of the smart home devices, weather database 199, insurance company 420, real estate & property data company 430, AI company 440, electrical data company 450, security company 460, and/or a property risk data company 470 may have corresponding one or more processors, one or more non-transitory memories, etc.

At block 2120, the one or more processors 150 may predict, based upon the received data from the plurality of data sources, that an event will occur that will damage an insured asset.

Examples of the event include: a weather event (e.g., a hailstorm, a flood, a rainstorm, an earthquake, a tornado, a hurricane, a temperature drop, etc.), an electrical fire, a wildfire, a break-in, a leak, water damage event, etc.

Examples of the insured assets include a house, an automobile, a motorcycle, a boat, an antique, etc.

The prediction may be made by any suitable technique. For instance, the one or more processors 150 may make the prediction based upon any of the data received from any of the data sources individually. For example, the one or more processors 150 may determine from weather data received from the weather database 199 that a hurricane (or other weather event, such as a hailstorm, etc.) is approaching the insured asset (e.g., a house, etc.). In another example, the one or more processors 150 may use data from an electrical monitor or other smart device to predict that an electrical fire may occur. In another example, the one or more processors 150 may analyze insurance claims data (e.g., from the insurance company, and possibly of insurance claims placed automatically in real time, etc.) to determine that a wildfire may affect an insurance customer (e.g., such as by damaging a home, a car, etc.).

In some examples, data from multiple data sources is leveraged. In one such example, the plurality of data sources includes the insurance company 420 and the weather database 199, and predication may be based upon both data from the insurance company (e.g., data including insurance claims, etc.), and weather data. For instance, insurance claims (e.g., possibly placed automatically in real time, etc.) corresponding to flood damage may be combined with weather data to predict that an event of a flood will damage a home. In some such examples, the one or more processors 150 may associate the flood with the home based upon geographic data, such as an address of the home, and/or geographic data corresponding to the flood.

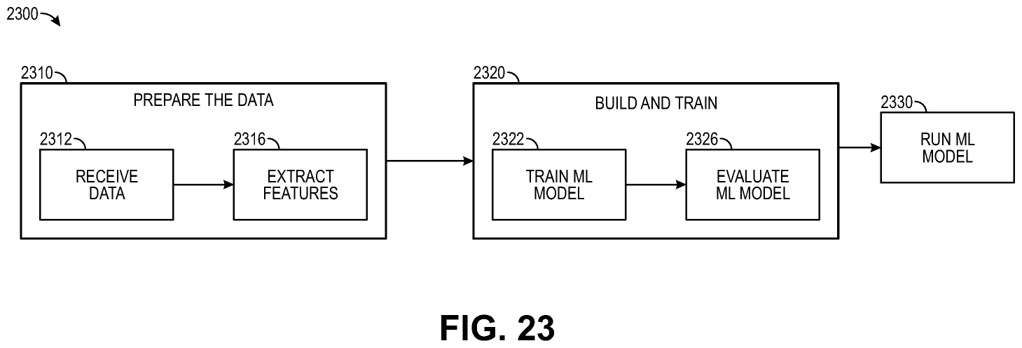

In other examples, the prediction is made via a machine learning algorithm, such as an event prediction machine learning algorithm, as described elsewhere herein, such as with respect to FIG. 23.

At block 2130, the one or more processors 150 may initiate an action (e.g., a prevention action, etc.) based upon the prediction that the event will occur. In some examples, the action comprises presenting a warning of the predicted event. For example, a warning may be presented (e.g., via mobile device 112 and/or a smart home device) that comprises a visual, audio, and/or haptic warning. Additionally or alternatively, the action may comprise: shutting off a water valve; activating a sump pump; activating a sprinkler system; contacting an emergency responder; moving an autonomous vehicle into a garage; and/or shutting off a smart appliance. Additionally or alternatively, the action may comprise offering a product or service to a customer, and/or presenting a list of vendors (e.g., via the mobile device 112).

Which action to take may be determined by any suitable technique, such as determined based upon the predicted event and the insured asset. In one example, the insured asset is an automobile, the predicted event comprises a hailstorm, and the action may include presenting (e.g., via a smart phone and/or smart home device) an indication to move the automobile to prevent damage to the automobile, and/or automatically moving the automobile into a garage (e.g., if the automobile is an autonomous vehicle).

In some examples, the action may include activating a sump pump. For instance, at block 2120 the one or more processors 150 may predict that a flood will occur at a home based upon insurance claims placed by other insurance customers; in response to the prediction, the one or more processors may activate a sump pump of a home (e.g., the home may be the insured asset).

In another example, the one or more processors 150 may determine from smart home device data and/or insurance claims data that a particular house is on fire; the one or more processors 150 may then activate sprinkler systems (e.g., indoor and/or outdoor sprinkler systems in neighboring houses (e.g., the neighboring houses are the insured assets), send alerts (e.g., indicating that a house is on fire) to smartphones of the neighbors, etc.

In yet another example, the one or more processors 150 may determine from data from the security company and/or the insurance company that there has been a recent increase in break-ins to nearby homes. In some such examples, the action includes presenting a list of vendors for security services (e.g., security companies), and/or security products (e.g., smart cameras, smart doorbells, dog breeders for guard dogs, etc.).

In some embodiments, the determination of what action to take is made via a machine learning algorithm, such as a prevention action determination machine learning algorithm, as described elsewhere herein, such as with respect to FIG. 23.

It should be understood that not all blocks and/or events of the exemplary signal diagrams and/or flowcharts are required to be performed. Moreover, more blocks may be performed even though they are not specifically illustrated. The exemplary signal diagrams and/or flowcharts may include additional, less, or alternate functionality, including that discussed elsewhere herein.

### Exemplary Computer-Implemented Methods-Ecosystems for Initiating an Action Following Occurrence of an Event

FIG. 22 shows an exemplary computer-implemented method or implementation 2200 for initiating an action following occurrence of an event. Although the following discussion refers to the exemplary method or implementation 2200 as being performed by the one or more processors 150, it should be understood that any or all of the blocks may be alternatively or additionally performed by any other suitable component as well (e.g., the one or more processors 142, the one or more processors 122, etc.).

The exemplary implementation 2200 may begin at block 2210 when the one or more processors 150 receive data from a plurality of data sources. Examples of the plurality of data sources may include: smart home devices, a weather database 199, an insurance company (e.g., insurance company 420), a real estate & property data company (e.g., estate & property data company 430), AI company (e.g., AI company 440), an electrical data company (e.g., electrical data company 450), a security company (e.g., security company 460), and/or a property risk data company (e.g., property risk data company 470). The data may be received via the network 130.

The smart home devices may include any smart home devices, such as a smart: dryer, washer, sump pump, water heater, thermostat, dishwasher, sprinkler system, refrigerator, freezer, microwave, clock, light bulb, toaster, air fryer, toothbrush, etc.

Each of the smart home devices, weather database 199, insurance company 420, real estate & property data company 430, AI company 440, electrical data company 450, security company 460, and/or a property risk data company 470 may have corresponding one or more processors, one or more non-transitory memories, etc.

In some examples, additional data may be requested based upon the received data. For example, the one or more processors 150 may receive insurance claims data from the insurance company (e.g., insurance claims corresponding to properties in geographic proximity to a home). Based upon analysis of the insurance claims data, the one or more processors 150 may request smart home data from smart devices of the home. For example, the insurance claims data may be used to determine that nearby homes have flooded, and so the one or more processors 150 request smart device data (e.g., imagery data) from the home 116 to determine if the home has flooded.

In some examples, insurance claims data from the insurance company is analyzed to determine to request additional data from any of: the smart home devices, the weather database 199, the real estate & property data company, the AI company, the electrical data company, the security company, and/or the property risk data company.

In another example, the one or more processors 150 may receive weather data from the weather database 199; and, based upon analysis of the weather data, the one or more processors 150 may request smart home data from the smart devices of the home. For example, the weather data may indicate that a home is at a high risk of flooding, so the one or more processors 150 request smart device data (e.g., imagery data) from the home 116 to determine if the home has flooded.

At block 2220, the one or more processors 150 may determine, based upon the received data from the plurality of data sources, that an event has occurred that will damage or has damaged an insured asset.

Examples of the event include: a weather event (e.g., a hailstorm, a flood, a rainstorm, an earthquake, a tornado, a hurricane, a temperature drop, etc.), an electrical fire, a wildfire, a break-in, a water damage event (e.g., leaking roof or windows), a leak, broken pipes, failing or defective equipment (such as sump pumps, home sensors, appliances, smart equipment, smart electronics, smart valves, etc.), etc.

Examples of the insured assets include a house, an automobile, a motorcycle, a boat, an antique, etc.

The determination may be made by any suitable technique. For instance, the one or more processors 150 may make the determination based upon any of the data received from any of the data sources individually. For example, the one or more processors 150 may determine from data received from the smart home devices that a pipe has burst (e.g., a smart device sends imagery information indicating that a pipe has burst).

In some embodiments, the determination of the event is made via a machine learning algorithm, such as an event determination machine learning algorithm, as described elsewhere herein, such as with respect to FIG. 23.

At block 2230, the one or more processors 150 initiate an action (e.g., a remedial action, etc.) based upon the determination that the event has occurred. In some examples, the action comprises presenting, via a smart phone and/or smart home device, an instruction or suggestion to protect the insured asset. For example, if the event comprises a burst pipe, a suggestion to shut off the water may be displayed on the mobile device 112.

In other example, where the event comprises a burst pipe, the action may comprise controlling a water valve to shut off water to the house 116.

In still other examples, the action may comprise: (i) presenting (e.g., via the mobile device 112 and/or a smart home device) a question asking if an insurance customer would like to place an insurance claim for the insured asset; or electronically placing (e.g., via the one or more processors 150) an insurance claim for the insured asset.

In still other examples, the action may comprise presenting (e.g., via the mobile device 112 and/or a smart home device), a question asking if the insured asset has been damaged. If the one or more processors 150 receive a response indicating that the insured asset has been damaged, the one or more processors 150 may take a further action, such as: presenting (e.g., via the mobile device 112 and/or a smart home device) a question asking if an insurance customer would like to place an insurance claim for the insured asset; or electronically placing (e.g., via the one or more processors 150) an insurance claim for the insured asset.

Additionally or alternatively, if the one or more processors 150 receive a response indicating that the insured asset has been damaged, the one or more processors 150 may provide a list of vendors (e.g., on a screen of the mobile device 112) to repair the damage. The vendors may include: contractors, plumbers, roofers, electricians, painters, etc.

In some embodiments, the determination of the event is made via a machine learning algorithm, such as a remedial action determination machine learning algorithm, as described elsewhere herein, such as with respect to FIG. 23.

It should be understood that not all blocks and/or events of the exemplary signal diagrams and/or flowcharts are required to be performed. Moreover, more blocks may be performed even though they are not specifically illustrated. The exemplary signal diagrams and/or flowcharts may include additional, less, or alternate functionality, including that discussed elsewhere herein.

Exemplary Al and/or ML Techniques—Ecosystems for: (i) Prediction and/or Prevention of Loss, and/or (ii) Initiating an Action Following Occurrence of an Event

Broadly speaking, AI and/or ML algorithm(s) and/or model(s) may be used to: predict an event (e.g., at block 2120 with an event prediction machine learning algorithm), determine a prevention action (e.g., at block 2130 with a prevention action determination machine learning algorithm), determine that an event has occurred (e.g., at block 2220 with an event determination machine learning algorithm), and/or determine a remedial action (e.g., at block 2230 with a remedial action determination machine learning algorithm). Although the following discussion refers to an ML algorithm, it should be appreciated that it applies equally to ML and/or AI algorithms and/or models.

FIG. 23 is a block diagram of an exemplary machine learning modeling method 2300 for training and evaluating a ML algorithm (e.g., an event prediction machine learning algorithm, a prevention action determination machine learning algorithm, an event determination machine learning algorithm, a remedial action determination machine learning algorithm, etc.), in accordance with various embodiments. In some embodiments, the model “learns” an algorithm capable of performing the desired function, such as predicting an event (e.g., block 2120 with an event prediction machine learning algorithm), determining a prevention action (e.g., at block 2130 with a prevention action determination machine learning algorithm), determining that an event has occurred (e.g., at block 2220 with an event determination machine learning algorithm), and/or determining a remedial action (e.g., at block 2230 with a remedial action determination machine learning algorithm). It should be understood that the principles of FIG. 23 may apply to any machine learning algorithm discussed herein.

Although the following discussion refers to the blocks of FIG. 23 as being performed by the one or more processors 142, it should be appreciated that the blocks of FIG. 23 may be performed by any suitable component or combinations of components (e.g., the one or more processors 122, the one or more processors 142, the one or more processors 150, etc.).

At a high level, the machine learning modeling method 2300 includes a block 2310 to prepare the data, a block 2320 to build and train the model, and a block 2330 to run the model.

Block 2310 may include sub-blocks 2312 and 2316. At block 2312, the one or more processors 142 may receive (e.g., from any of a plurality of data sources, such as smart home devices, a weather database 199, an insurance company 420, a real estate & property data company 430, an AI company 440, an electrical data company 450, a security company 460, and/or a property risk data company 470, etc.) the historical information to train the machine learning algorithm(s). In some examples, the historical information comprises: (i) inputs to the machine learning model (e.g., also referred to as independent variables, or explanatory variables), and/or (ii) outputs of the machine learning model (e.g., also referred to as dependent variables, or response variables). In some such examples, the dependent variables are the scores that the ML algorithm is trained to determine (e.g., the dependent variable of the event prediction ML algorithm is the predicted event); and the independent variables are used to determine the dependent variables (e.g., an independent variable of the event prediction ML algorithm may be weather data, etc.). Put another way, the independent variables may have an impact on the dependent variables; and the ML algorithms may be trained to find this impact. Therefore, when using a trained ML algorithm to, for example, predict an event, information corresponding to the historical information that the ML was trained on may be routed into the ML algorithm to predict the event (e.g., an event prediction ML algorithm trained on historical weather data may have weather data routed to it to predict an event, such as a hailstorm).

More specifically, for the historical information used to train the event prediction ML algorithm, examples of the independent variables may include historical: weather data, insurance data (e.g., insurance claims data, e.g., including geographic information of where the claims were placed, types of assets the claims were placed for, times the claims were placed, etc.), smart device data, smart equipment data, property data (e.g., if a property has protections against floods, such as having a sump pump; if a property is located on a hill; etc.) etc. An example of the dependent variable in the historical information includes historical events (and/or historical predicted events).

Therefore, when using the event prediction machine learning algorithm to predict an event, examples of the information routed to the event prediction machine learning algorithm may include: weather data, smart device data, insured asset data (e.g., types of insured assets, geographic locations of insured assets, etc.), property data (e.g., if a property has protections against floods, such as having a sump pump; if a property is located on a hill; etc.), etc.

For the historical information used to train the prevention action machine learning algorithm, examples of the independent variables may include historical: predicted events, weather data, smart device data, insurance data, property data (e.g., if a property has protections against floods, such as having a sump pump; if a property is located on a hill; etc.), etc. An example of the dependent variable in the historical information includes the prevention actions.

Therefore, when using the prevention action machine learning algorithm to determine prevention actions, examples of the information routed to the prevention action machine learning algorithm may include: predicted events, weather data, smart device data, insurance data, property data (e.g., if a property has protections against floods, such as having a sump pump; if a property is located on a hill; etc.), etc.

For the historical information used to train the event determination machine learning algorithm, examples of the independent variables may include historical: smart device data, weather data, insurance data (e.g., insurance claims data, e.g., including geographic information of where the claims were placed, types of assets the claims were placed for, times the claims were placed, etc.), insured asset data (e.g., types of insured assets, geographic locations of insured assets, etc.), property data (e.g., if a property has protections against floods, such as having a sump pump; if a property is located on a hill; etc.), etc. An example of the dependent variable in the historical information includes historical events.

Hence, when using the event determination machine learning algorithm to determine the event, examples of the examples of the information routed to the event determination machine learning algorithm may include: smart device data, weather data, insurance data, insured asset data (e.g., types of insured assets, geographic locations of insured assets, etc.), property data (e.g., if a property has protections against floods, such as having a sump pump; if a property is located on a hill; etc.), etc.

For the historical information used to train the remedial action determination machine learning algorithm, examples of the independent variables may include historical: determined events, weather data, smart device data, insurance data, property data (e.g., if a property has protections against floods, such as having a sump pump; if a property is located on a hill; if a property has a smart shutoff water valve; etc.), etc. An example of the dependent variable in the historical information includes remedial actions.

As a result, when using the remedial action determination machine learning algorithm to determine the remedial action, examples of the information routed to the remedial action determination machine learning algorithm may include: the determined event, weather data, smart device data, insurance data, property data (e.g., if a property has protections against floods, such as having a sump pump; if a property is located on a hill; if a property has a smart shutoff water valve; etc.), etc.

The historical information and/or information of the home may be received from any suitable source. Examples of sources that any of the historical information and/or information of the home may be received from include: weather database 199, mobile device 112, smart product 110 (e.g., a smart device), request server 140, requestor 114, vendor 182, security company 180, insurance company 420, real estate & property data 430, artificial intelligence (AI) company 440, electrical data company 450, security company 460, property risk data company 470, a database holding insurance profiles of insurance customers, etc. It should be appreciated that the historical information and/or information of the home may be received from combinations of these sources as well.

Block 2320 may include sub-blocks 2322 and 2326. At block 2322, the machine learning (ML) model is trained (e.g., based upon the data received from block 2310). In some embodiments where associated information is included in the historical information, the ML model “learns” an algorithm capable of calculating or predicting the target feature values (e.g., determining score(s), etc.) given the predictor feature values.

At block 2326, the one or more processors 142 may evaluate the machine learning model, and determine whether or not the machine learning model is ready for deployment.

Further regarding block 2326, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information, such as the historical information discussed above), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

Moreover, it should be appreciated the ML algorithm(s) may be any kind of ML algorithms (e.g., neural networks, convolutional neural networks, deep learning algorithms, etc.).

### Additional Exemplary Embodiments: Ecosystems for Prediction and/or Prevention of Loss

In one aspect, a computer-implemented method for an ecosystem to predict and/or prevent loss may be provided. The method may be implemented via one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, ChatGPT-based bot, and/or other electronic or electrical components. For instance, in one example, the method may include: (1) receiving, via one or more processors, data from a plurality of data sources, the plurality of data sources including: smart home devices, a weather database, an insurance company, a real estate & property data company, artificial intelligence (AI) company, an electrical data company, a security company, and/or a property risk data company; (2) predicting, via the one or more processors, based upon the received data from the plurality of data sources, that an event will occur that will damage an insured asset; and/or (3) initiating, via the one or more processors, an action based upon the prediction that the event will occur. The method may include additional, fewer, or alternate actions, including those discussed elsewhere herein.

In some embodiments, the action comprises presenting, via a smart phone and/or smart home device, a warning of the predicted event, and/or wherein the warning comprises a visual, audio, and/or haptic warning.

In some embodiments, the action may include: shutting off a water valve; activating a sump pump; activating a sprinkler system; contacting an emergency responder; moving an autonomous vehicle into a garage; and/or shutting off a smart appliance.

In some embodiments, the event may include: a weather event including: a hailstorm, a flood, a rainstorm, an earthquake, a tornado, and/or a hurricane; an electrical fire; and/or a wildfire.

In some embodiments, the insured asset is an automobile, and wherein the predicting that the event will occur may include: determining, via the one or more processors, based upon weather data from the weather database, that a hailstorm is approaching the automobile; and/or determining, via the one or more processors, that the hailstorm will damage the automobile.

In some embodiments, the action may include presenting, via a smart phone and/or smart home device, an indication to move the automobile to prevent damage to the automobile.

In some embodiments, the insured asset is of a first insurance customer; the plurality of data sources includes the insurance company and the weather database; and/or the predicting that the event will occur that will damage the insured asset comprises: identifying, via the one or more processors, an insurance claim (i) placed by a second insurance customer, and (ii) associated with a weather event; and/or determining, via the one or more processors, an association between the weather event and the first insurance customer.

In some embodiments, the insured asset is of a first insurance customer; the plurality of data sources includes the insurance company; the event includes a wildfire; and/or the predicting that the event will occur that will damage the insured asset may include analyzing, via the one or more processors, insurance claims of other insurance customers to predict that the wildfire will affect the first insurance customer.

In some embodiments, training, via the one or more processors, an event prediction machine learning algorithm by inputting historical information into the event prediction machine learning algorithm, the historical information may include: (i) independent variables comprising (a) historical weather data, (b) historical insurance claims data, and/or (c) historical smart device data, and/or (ii) dependent variables comprising historical events; and/or predicting, via the one or more processors, the event by routing the received data from the plurality of data sources into the event protection machine learning algorithm.

In some embodiments, training, via the one or more processors, a prevention action machine learning algorithm by inputting historical information into the prevention action machine learning algorithm, the historical information comprising: (i) independent variables comprising (a) historical predicted events, (b) historical weather data, and/or (c) historical smart device data, and/or (ii) dependent variables comprising historical prevention actions; and/or the initiating the action includes determining, via the one or more processors, the action by routing the received data from the plurality of data sources into the prevention action machine learning algorithm.

In another aspect, a computer system for an ecosystem to predict and/or prevent loss may be provided. The computer system may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, ChatGPT-based bot, and/or other electronic or electrical components. For example, in one instance, the computer system may include one or more processors configured to: (1) receive data from a plurality of data sources, the plurality of data sources including: smart home devices, a weather database, an insurance company, a real estate & property data company, artificial intelligence (AI) company, an electrical data company, a security company, and/or a property risk data company; (2) predict, based upon the received data from the plurality of data sources, that an event will occur that will damage an insured asset; and/or (3) initiate an action based upon the prediction that the event will occur.

In some embodiments, the action may include causing a smart phone and/or smart home device to present a warning of the predicted event, and/or wherein the warning comprises a visual, audio, and/or haptic warning.

In some embodiments, the action may include: shutting off a water valve; activating a sump pump; activating a sprinkler system; contacting an emergency responder; moving an autonomous vehicle into a garage; and/or shutting off a smart appliance.

In some embodiments, the event may include: a weather event comprising: a hailstorm, a flood, a rainstorm, an earthquake, a tornado, and/or a hurricane; an electrical fire; and/or a wildfire.

In some embodiments, the insured asset is an automobile, and/or wherein the one or more processors are further configured to: determine, based upon weather data from the weather database, that a hailstorm is approaching the automobile; and/or determine, that the hailstorm will damage the automobile.

In yet another aspect, a computer device for an ecosystem to predict and/or prevent loss may be provided. The computer device may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, ChatGPT-based bot, and/or other electronic or electrical components. For instance, in one example, the computer device may include: one or more processors; and/or one or more non-transitory memories. The one or more non-transitory memories having stored thereon computer-executable instructions that, when executed by the one or more processors, cause the computer device to: (1) receive data from a plurality of data sources, the plurality of data sources including: smart home devices, a weather database, an insurance company, a real estate & property data company, artificial intelligence (AI) company, an electrical data company, a security company, and/or a property risk data company; (2) predict, based upon the received data from the plurality of data sources, that an event will occur that will damage an insured asset; and/or (3) initiate an action based upon the prediction that the event will occur. The method may include additional, less, or alternate functionality, including that discussed elsewhere herein.

For instance, in some embodiments, the action may include causing a smart phone and/or smart home device to present a warning of the predicted event, and wherein the warning comprises a visual, audio, and/or haptic warning.

In some embodiments, the action may include: shutting off a water valve; activating a sump pump; activating a sprinkler system; contacting an emergency responder; moving an autonomous vehicle into a garage; and/or shutting off a smart appliance.

In some embodiments, the event may include: a weather event comprising: a hailstorm, a flood, a rainstorm, an earthquake, a tornado, and/or a hurricane; an electrical fire; and/or a wildfire.

In some embodiments, the insured asset is an automobile, and wherein the one or more non-transitory memories having stored thereon computer executable instructions that, when executed by the one or more processors, cause the computer device to: determine, based upon weather data from the weather database, that a hailstorm is approaching the automobile; and/or determine, that the hailstorm will damage the automobile.

### Additional Exemplary Embodiments: Initiating an Action Following Occurrence of an Event

In one aspect, a computer-implemented method for an ecosystem that initiates an action following an occurrence of an event may be provided. The method may be implemented via one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, ChatGPT-based bot, and/or other electronic or electrical components. For instance, in one example, the method may include: (1) receiving, via one or more processors, data from a plurality of data sources, the plurality of data sources including: smart home devices, a weather database, an insurance company, a real estate & property data company, artificial intelligence (AI) company, an electrical data company, a security company, and/or a property risk data company; (2) determining, via the one or more processors, based upon the received data from the plurality of data sources, that an event has occurred that will damage or has damaged an insured asset; and/or (3) initiating, via the one or more processors, an action based upon the determination that the event has occurred. The method may include additional, fewer, or alternate actions, including those discussed elsewhere herein.

For instance, in some embodiments, the action includes presenting, via a smart phone and/or smart home device, an instruction or suggestion to protect the insured asset.

In some embodiments, the action includes: (a) presenting, via a smart phone and/or smart home device, a question asking if the insured asset has been damaged; (b) presenting, via a smart phone and/or smart home device, a question asking if an insurance customer would like to place an insurance claim for the insured asset; and/or (c) electronically placing, via the one or more processors, an insurance claim for the insured asset.

In some embodiments, the action includes presenting, via a smart phone and/or smart home device, a list of suggested vendors to repair or replace the insured asset.

In some embodiments, the insured asset includes a house, an automobile, a motorcycle, or a boat.

In some embodiments, the event includes a burst pipe, and wherein the action comprises: shutting off a water valve; and/or presenting a warning advising that water should be shut off.

In some embodiments, the receiving the data includes: (i) receiving, via the one or more processors, weather data from the weather database; (ii) analyzing, via the one or more processors, the received weather data; (iii) requesting, via the one or more processors, based upon the analysis of the weather data, smart home data from the smart home devices; and/or (iv) receiving, via the one or more processors, the smart home data in response to the request; and/or determining that the event has occurred comprises determining that the event has occurred based upon the received smart home data.

In some embodiments, the receiving the data may include: receiving, via the one or more processors, insurance claims data from the insurance company; analyzing, via the one or more processors, the received insurance claims data; requesting, via the one or more processors, based upon the analysis of the insurance claims data, smart home data from the smart home devices; and/or receiving, via the one or more processors, the smart home data in response to the request; and/or determining that the event has occurred includes determining that the event has occurred based upon the received smart home data.

In some embodiments, the method further includes: training, via the one or more processors, an event determination machine learning algorithm by inputting historical information into the event determination machine learning algorithm, the historical information comprising: (i) independent variables comprising (a) historical weather data, (b) historical insurance claims data, and/or (c) historical smart device data, and/or (ii) dependent variables comprising historical events; and/or determining, via the one or more processors, the event by routing the received data from the plurality of data sources into the event determination machine learning algorithm.

In some embodiments, the method further includes: training, via the one or more processors, a remedial action machine learning algorithm by inputting historical information into the remedial action machine learning algorithm, the historical information comprising: (i) independent variables comprising (a) historical determined events, (b) historical weather data, and/or (c) historical smart device data, and/or (ii) dependent variables comprising historical remedial actions; and/or the initiating the action includes determining, via the one or more processors, the action by routing the received data from the plurality of data sources into the remedial action machine learning algorithm.

In another aspect, computer system for an ecosystem that initiates an action following an occurrence of an event may be provided. The computer system may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, ChatGPT-based bot, and/or other electronic or electrical components. For example, in one instance, the computer system may include one or more processors configured to: (1) receive data from a plurality of data sources, the plurality of data sources including: smart home devices, a weather database, an insurance company, a real estate & property data company, artificial intelligence (AI) company, an electrical data company, a security company, and/or a property risk data company; (2) determine, based upon the received data from the plurality of data sources, that an event has occurred that will damage or has damaged an insured asset; and/or (3) initiate an action based upon the determination that the event has occurred. The computer system may include additional, less, or alternate functionality, including that discussed elsewhere herein.

In some embodiments, the action includes presenting, via a smart phone and/or smart home device, an instruction or suggestion to protect the insured asset.

In some embodiments, the action includes: causing a smart phone and/or smart home device to present a question asking if the insured asset has been damaged; causing via the smart phone and/or smart home device to present a question asking if an insurance customer would like to place an insurance claim for the insured asset; or electronically placing an insurance claim for the insured asset.

In some embodiments, the action includes causing a smart phone and/or smart home device to present a list of suggested vendors to repair or replace the insured asset.

In some embodiments, the insured asset includes a house, an automobile, a motorcycle, or a boat.

In yet another aspect, a computer device for an ecosystem that initiates an action following an occurrence of an event may be provided. The computer device may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, ChatGPT-based bot, and/or other electronic or electrical components. For instance, in one example, the computer device may include: one or more processors; and/or one or more non-transitory memories. The one or more non-transitory memories having stored thereon computer-executable instructions that, when executed by the one or more processors, cause the computer device to: (1) receive data from a plurality of data sources, the plurality of data sources including: smart home devices, a weather database, an insurance company, a real estate & property data company, artificial intelligence (AI) company, an electrical data company, a security company, and/or a property risk data company; (2) determine, based upon the received data from the plurality of data sources, that an event has occurred that will damage or has damaged an insured asset; and/or (3) initiate an action based upon the determination that the event has occurred. The computer device may include additional, less, or alternate functionality, including that discussed elsewhere herein.

In some embodiments, the action includes presenting, via a smart phone and/or smart home device, an instruction or suggestion to protect the insured asset.

In some embodiments, the action includes: causing a smart phone and/or smart home device to present a question asking if the insured asset has been damaged; causing via the smart phone and/or smart home device to present a question asking if an insurance customer would like to place an insurance claim for the insured asset; or electronically placing an insurance claim for the insured asset.

In some embodiments, the action includes causing a smart phone and/or smart home device to present a list of suggested vendors to repair or replace the insured asset.

In some embodiments, the insured asset includes a house, an automobile, a motorcycle, or a boat.

### Recommendation System and Methods for Purchasing a New Device to Improve a Home Score

Some embodiments relate even more particularly to purchasing a new device to improve a home score. For example, following determination of the overall home score, and/or the home safety, fire protection, sustainability and/or home automation subscores, the system may further determine how purchasing new device(s) may improve the overall home score or any of the subscores. For instance, a user may be displayed options for smoke detectors (or generations of smoke detectors) to purchase. The number of devices purchased and/or placement of devices in the home may also be considered in effecting the home score(s). The system may use data from any source to determine what products to recommend. For example, insurance claims data or online reviews may be used to determine that particular devices need to be replaced more often, etc. The system may also use inventory of items in home as part of determining new items to purchase to improve the home score(s). A ranked list of suggestions of devices to purchase may also be provided to the user.

### Exemplary Computer-Implemented Methods for Purchasing a New Device to Improve a Home Score

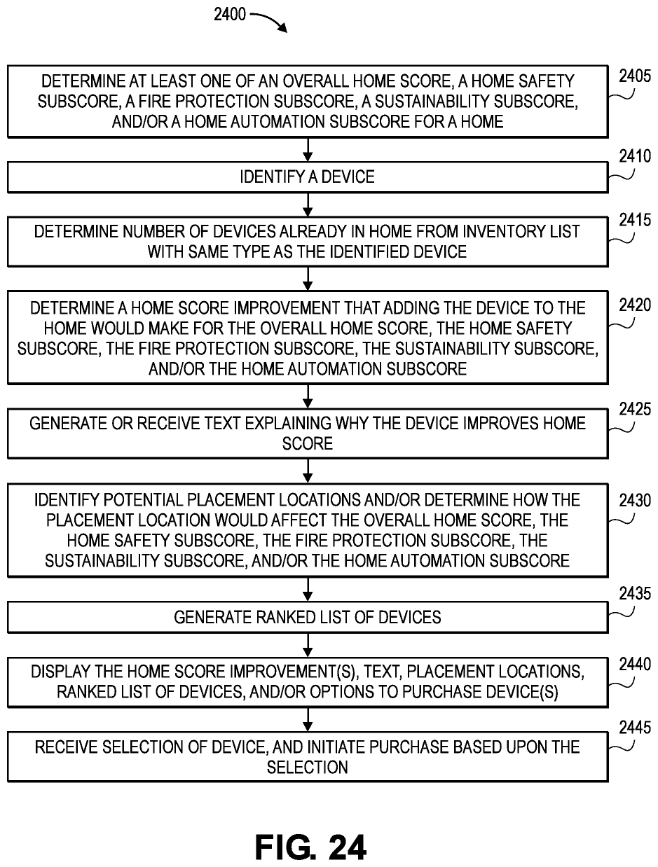

FIG. 24 shows an exemplary computer-implemented method or implementation 2400 for recommending a device to purchase to improve a home score. Although the following discussion refers to the exemplary method or implementation 2400 as being performed by the one or more processors 150, it should be understood that any or all of the blocks may be alternatively or additionally performed by any other suitable component as well (e.g., the one or more processors 142, the one or more processors 122, etc.).

The exemplary implementation 2400 may begin at block 2405 when the one or more processors 150 determine at least one of an overall home score, a home safety subscore, a fire protection subscore, a sustainability subscore, and/or a home automation subscore for a home. The home score(s) may be determined by any suitable technique, such as described elsewhere herein (e.g., using an ML algorithm trained as described with respect to FIG. 12, etc.).

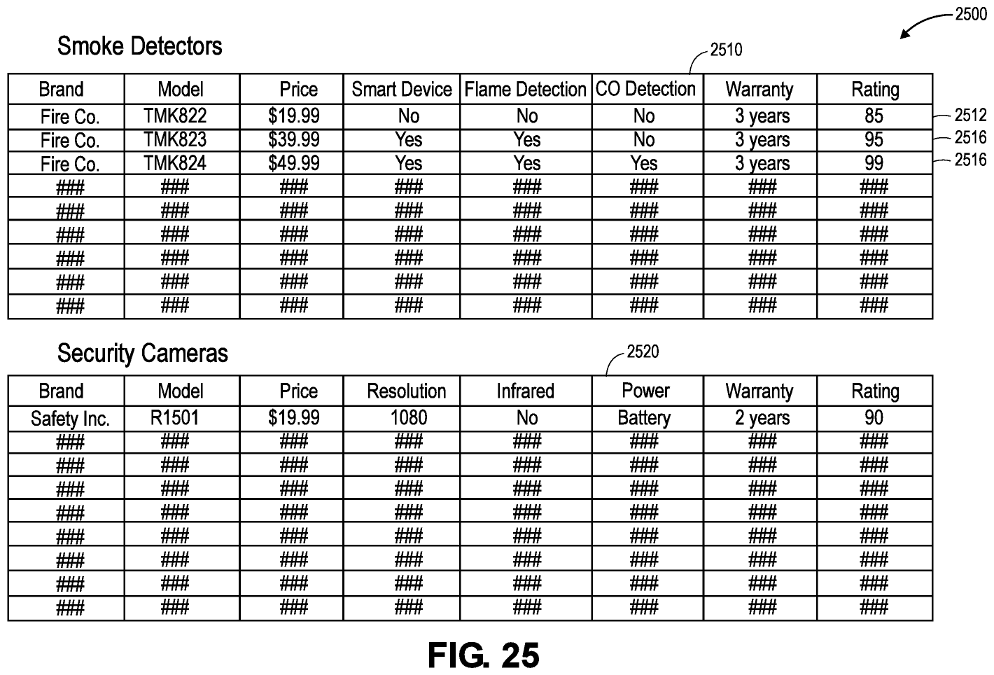

At block 2410, the one or more processors 150 may identify a device (e.g., a device that the system may recommend to a user to purchase because of how the device improves any of the home scores). The device may be identified via any suitable technique, such as identified from a catalog. FIG. 25 depicts an exemplary device catalog 2500, according to an embodiment. The device catalog 2500 may be stored at the request server 140, the requestor 114, the vendor 182, the security company 180, the mobile device 112, and/or in any other suitable storage location.

According to the example of FIG. 25, the available device catalog 2500 may comprise one or more device categories, such as smoke detectors and security cameras. Each device category may comprise information about devices currently for sale and/or no longer for sale. In one aspect, each device category may comprise a table that may further comprise a plurality of fields. For example, the smoke detectors table 2510 may comprise brand, model, price, smart device, flame detection, carbon monoxide detection, warranty, rating, and/or any other suitable fields. As a further example, the security cameras table 2520 may comprise brand, model, price, resolution, infrared, power, warranty, rating, and/or any other suitable fields. The rating field may be a score, e.g., 0 to 100, assigned to the devices in the table. The rating field may be manually assigned, obtained from a ratings data source, and/or automatically calculated based upon one or more of the fields. The rating field may be adjusted based upon claims data associated with the devices. The rating field may contribute to a device recommendation and/or home score improvement calculation.

In another aspect, the tables, such as smoke detectors table 2510 and security cameras table 2520, may comprise a plurality of records in which each record may correspond to a device. For example, the smoke detectors table 2510 may comprise a plurality of records for smoke detector devices, including records 2512, 2514, 2516.

In one aspect, the device catalog 2500 may comprise one or more images of the available devices. The one or more images may comprise a plurality of images of a device from different perspectives, e.g., top, bottom, side, etc.

In one aspect, the device catalog 2500 may be obtained from a vendor 182, such as a smoke detector vendor, a security camera vendor, etc. Information in the device catalog 2500, including one or more fields and/or one or more records, may obtained from one or more public data sources, proprietary data sources, and/or via manual entry. Information in the device catalog 2500 may be periodically updated.

In one aspect, as will be described elsewhere herein, the data used to train the home improvement score machine learning engine 2605, such as training data 2620, comprises the device catalog 2500.

In some embodiments, the identifying at block 2410 includes receiving a selection of a device type (e.g., smoke detector, security camera, etc.) from a mobile device 112, and then accessing and/or obtaining a device catalog corresponding to the selected device type.

At block 2415, the one or more processors 150 determine a number of devices with the same device type (e.g., smoke detector, security camera, etc.) as the device. Any suitable technique may be used to determine the number of devices. For example, the one or more processors 150 may access an insurance profile associated with a life insurance policy of an insurance customer to obtain an inventory list. The insurance profile may be stored at any of the request server 140, the requestor 114, the mobile device 112, and/or any other storage location. The inventory list may then be used to determine an existing number of devices already in the home 116 with a same device type as the device.

In other examples, the number of devices is determined by a user inputting the number of devices into the mobile device 112 (e.g., user inputs that she has nine smoke detectors in her home).

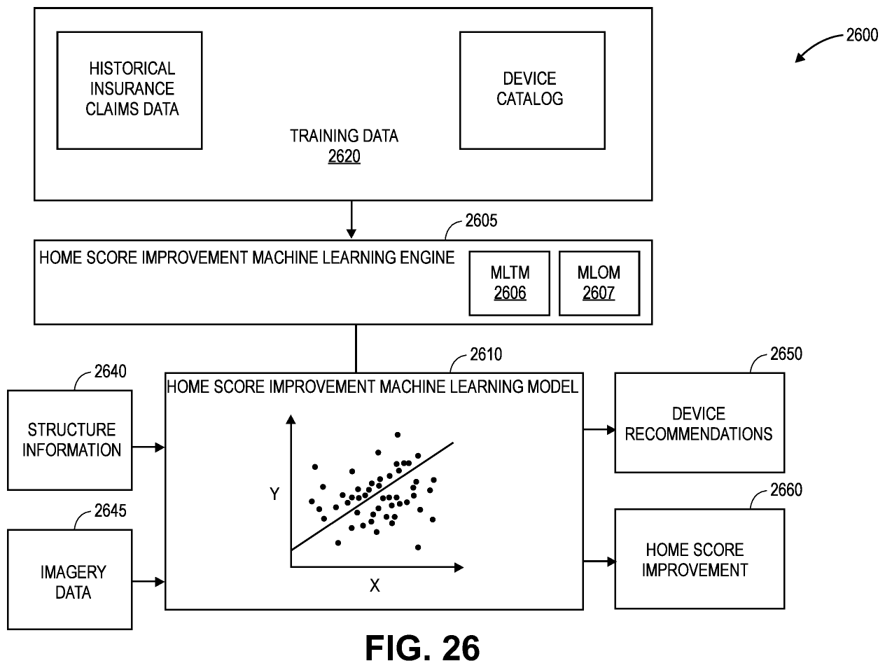

As described herein, the number of devices of the same type already present in a home can affect the improvement to the home score(s) that adding another device of the same type will have. For example, if a home already has ten smoke detectors, adding an additional smoke detector might not significantly affect the home score(s); on the other hand, if a home has few smoke detectors, adding an additional smoke detector may result in a large improvement to the home score(s). In this regard, by training the home score improvement machine learning model(s) (e.g., in accordance with the principles of FIG. 26), the machine learning model(s) “learn” how the number of devices affect the home score.

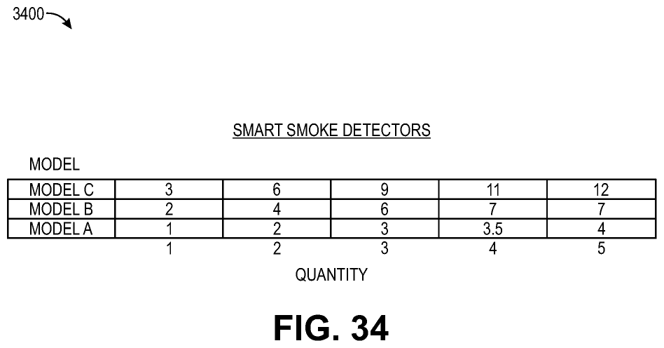

At block 2420, the one or more processors 150 determine a home score improvement that adding the device to the home 116 would make for the overall home score, the home safety subscore, the fire protection subscore, the sustainability subscore, and/or the home automation subscore. The determination may be made by any suitable technique. For example, as described in more detail elsewhere herein, the home score improvement(s) may be determined by a home score machine learning model (e.g., trained as described with respect to FIG. 26, etc.). In another example, first, the home scores without the device may be determined (e.g., as described with respect to FIG. 12, etc.); second, the home scores with the device may be determined (e.g., again as described with respect to FIG. 12, etc.); and third, the home scores with and without the device may be compared to determine the home score improvement. Additionally or alternatively, the home score improvement may be a fixed number that adding the device to the home would bring. For example, adding a particular model of smart smoke detector may improve a home automation subscore by 1 point, whereas adding a more advanced model of smoke detector may improve a home automation subscore by 2 points. Furthermore, the amount of the improvement may also be based upon the number of devices. An example of this is illustrated by exemplary matrix 3400 in FIG. 34, which depicts how quantity and model of smart smoke detectors would improve a home automation subscore.

At block 2425, the one or more processors 150 may receive or generate text explaining why the device improves the home score. For example, the chatbot 145 may generate the text, which may then be sent to the one or more processors 150. In another example, the mobile device may include the chatbot 145, which may generate the text.

All of the home scores and other scores discussed herein may be presented to the user or homeowner in several ways. For instance, the scores and other information and outputs may be visually or verbally presented to the homeowner. In certain embodiments, the scores, the home improvement score and related information, and any other outputs generated may be presented visually, graphically, textually, audibly, or verbally, such as via a processor, screen, voice bot, chatbot, or other bot.

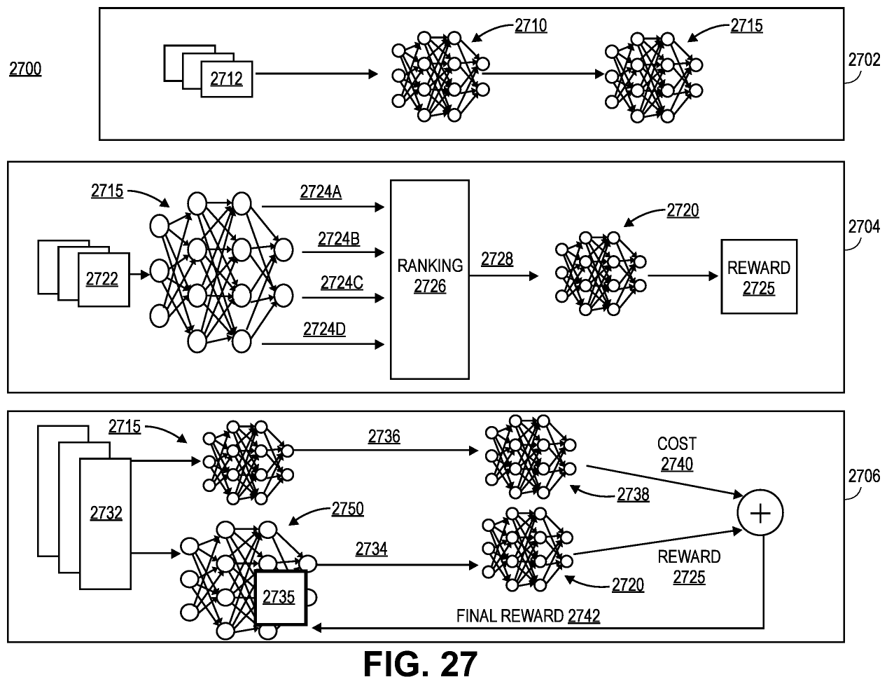

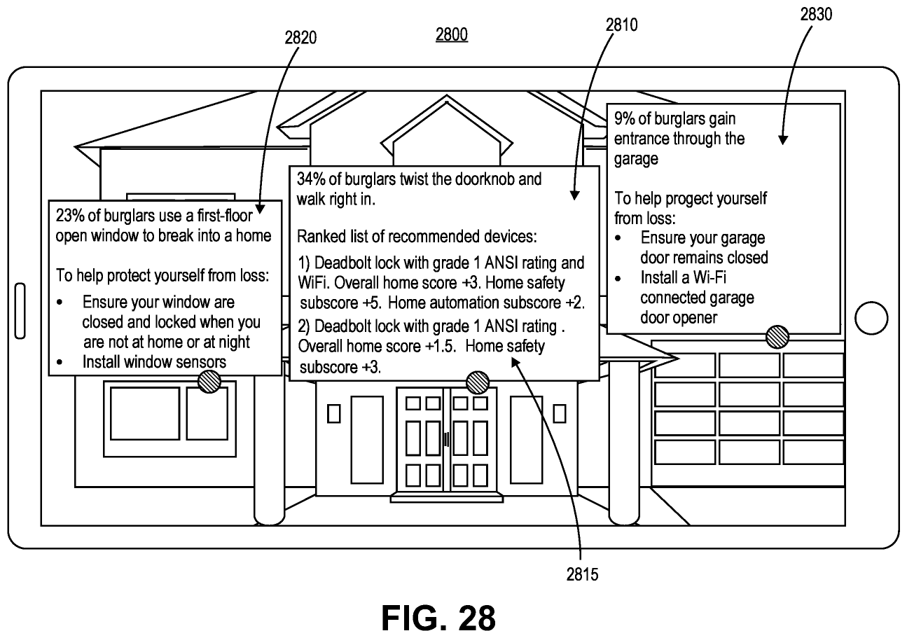

The training of the chatbot 145 will be described elsewhere herein (e.g., with respect to FIG. 27). However, broadly speaking, the generated text may explain why the device improves the home score. In this regard, FIG. 28 depicts an exemplary display 2800 including generated text 2810. In this example, the device is a deadbolt lock, and the generated text explains “34% of burglars twist the doorknob and walk right in.”

The exemplary display 2800 also includes exemplary generated text 2820 stating, “23% of burglars use a first-floor open window to break into a home.” In the example of text 2820, the device may comprise a window sensor.

The exemplary display 2800 also includes exemplary generated text 2830 stating, “9% of burglars gain entrance through the garage.” In the example of text 2830, the device may comprise a Wi-Fi connected garage door opener.

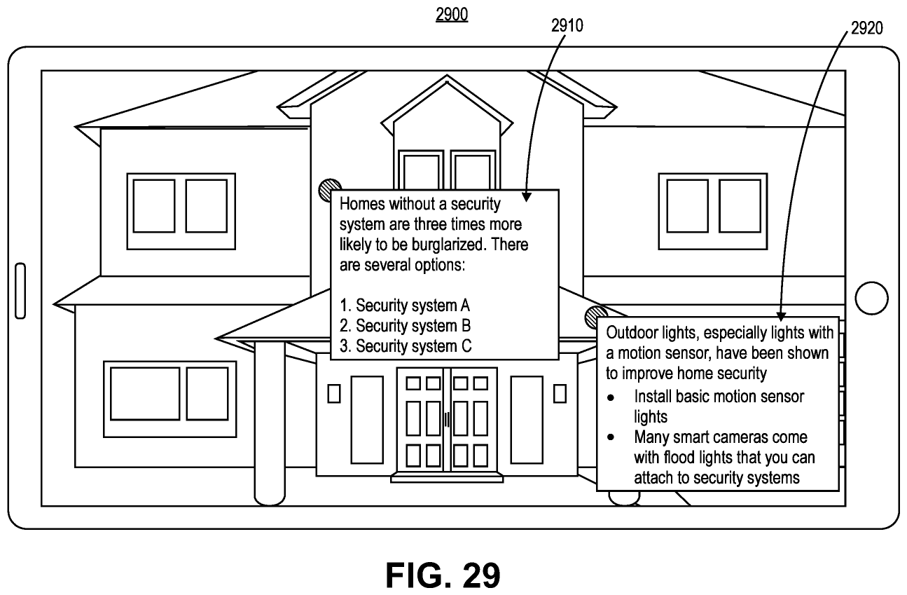

FIG. 29 depicts an additional exemplary display 2900 including generated text 2910 stating, “Homes without a security system are three times more likely to be burglarized.” In the example of text 2910, the device may be a security system.

The exemplary display 2900 also includes exemplary generated text 2920 stating, “Outdoor lights, especially lights with a motion sensor, have been shown to improve home security.” In the example of text 2920, the device may comprise a Wi-Fi connected garage door opener. Again any of the items displayed within the Figures may be presented to the user or homeowner in other means, i.e., any of the scores, text, and other outputs generated may be visually, graphically, textually, audibly, or verbally presented, such as via a processor, screen, voice bot, chatbot, or other bot.

At block 2430, the one or more processors 150 identify potential placement locations and/or determine how the placement location would affect the overall home score, the home safety subscore, the fire protection subscore, the sustainability subscore, and/or the home automation subscore. In some embodiments, the potential placement locations are general locations, such as a room of a house, a door of a house, a side of a house, etc. For example, for a smoke detector, the potential placement location may be a room a house (e.g., a kitchen, a particular bedroom, etc.). In another example, for a deadbolt lock, the potential placement location may be a particular door (e.g., the front door, the back door, a particular side door, etc.).

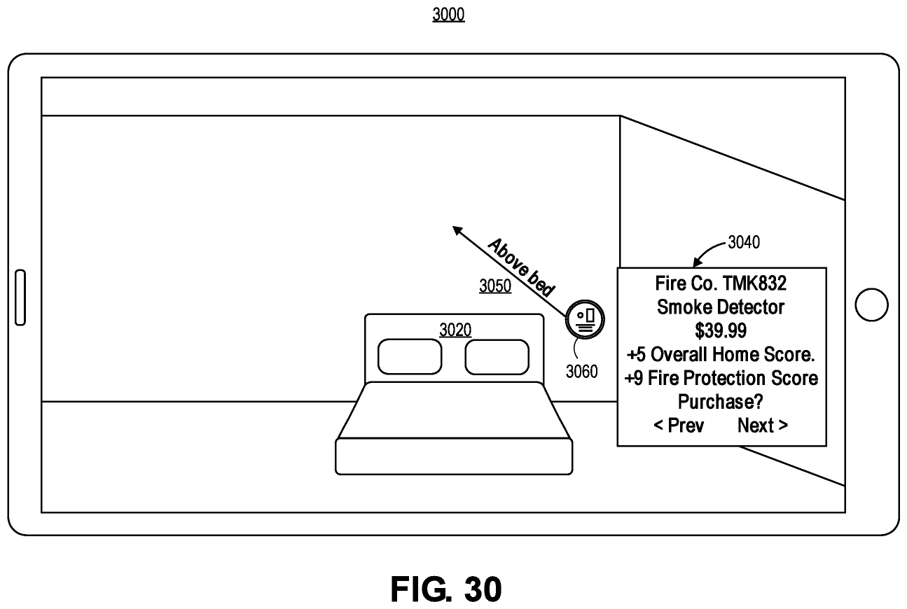

Additionally or alternatively, the potential placement locations may be more specific locations, for example, a particular room and/or a location within the particular room. For instance, exemplary screen 3000 (e.g., as viewed on the mobile device 112, etc.) of FIG. 30 depicts an example where the device 3060 is smoke detector 3060, and the identified location is both a particular bedroom and a location within the particular bedroom (e.g., indicated by arrow 3050).

In another example of the more specific location, a location on a particular door may be identified for a deadbolt lock (e.g., a particular height from the ground, etc.).

In some embodiments, the more specific locations are identified via a coordinate system, such as a Cartesian coordinate system, a spherical coordinate system, a cylindrical coordinate system, etc. It should be appreciated that the structure information 2640 may include dimensional data of each room of a house 116, which may be used to construct 3D models (e.g., with corresponding coordinate systems) of rooms of the house 116.

The more specific placement locations may also be used in the determination of the improvement to the home score(s). For example, placing a smoke detector near an entrance to a room may improve a home score(s) more or less than placing the smoke detector centrally in the room.

In some embodiments, the determination of how the placement effects the home score(s) may be made via the home score improvement machine learning model (e.g., trained as described with respect to FIG. 26, etc.).

At block 2435, the one or more processors 150 may generate a ranked list of devices. For example, the device identified at block 2410 may be ranked against other devices which the home score(s) has already determined. Additionally or alternatively, one or more of the blocks of the exemplary method 2400 may be iterated through to determine improvement(s) in home score(s) so that the devices may be ranked against each other. The devices may be ranked against each other based upon any or all of the improvement(s) to the home score(s). An exemplary ranked list of devices 2815 is depicted by the exemplary screen 2800 of FIG. 28. As can be seen by the exemplary ranked list, a Wi-Fi enabled deadbolt lock improves the home safety subscore more than a deadbolt lock without Wi-Fi; furthermore, the Wi-Fi enabled deadbolt lock improves the home automation subscore, whereas the deadbolt lock without Wi-Fi does not. In some embodiments, a highest-ranked device is made a recommended device that the system recommends to the user for purchase.

At block 2440, the one or more processors 150 may display the device, the home score improvement(s), the text, the placement locations, the ranked list of devices, and/or options to purchase the device(s) on a display.

Examples of the display are illustrated by FIGS. 28-30. For instance, with reference to FIG. 30, the exemplary screen 3000 may include a popup message 3040. The popup message 3040 may include a description of the device, a price of the device, a home score improvement, and/or an option to purchase the device 3060. The option to purchase may comprise a hyperlink that, when selected, displays the device 3060 on an online retailer website. The option to purchase may automatically purchase the device 3060 when selected (e.g., block 2445). The popup message 3040 may include a menu and/or other navigation features that allow the user to browse different models of recommended devices 3060.

It should be understood that not all blocks and/or events of the exemplary signal diagrams and/or flowcharts are required to be performed. Moreover, more blocks may be performed even though they are not specifically illustrated. The exemplary signal diagrams and/or flowcharts may include additional, less, or alternate functionality, including that discussed elsewhere herein.

### Exemplary ML Model to Determine Recommended Devices

In some embodiments, determining recommendations for deploying one or more devices (e.g., one or more devices proximate a structure) and/or determining a resulting improvement to a home score may use ML. The structure may include a home, business, and/or other structure.

FIG. 26 exemplary diagram 2600 schematically illustrates how an ML model may generate device recommendations and home score improvements based upon structure information. Some of the blocks in FIG. 26 represent hardware and/or software components (e.g., block 2605), other blocks represent data structures or memory storing these data structures, registers, or state variables (e.g., block 2620), and other blocks represent output data (e.g., blocks 2650 and 2660). Input signals are represented by arrows labeled with corresponding signal names.

The home score improvement ML engine 2605 may include one or more hardware and/or software components, such as the ML training module (MLTM) 2606 and/or the ML operation module (MLOM) 2607, to obtain, create, (re) train, operate and/or save one or more ML models 2610. To generate the ML model 2610, the ML engine 2605 may use the training data 2620.

As described herein, the server such as request server 140 may obtain and/or have available various types of training data 2620 (e.g., stored on database of server 140). In one aspect, the training data 2620 may labeled to aid in training, retraining and/or fine-tuning the ML model 2610. The training data 2620 may include data associated with historical insurance claims which may indicate one or more of a type of loss, amount of loss, devices present or absent in the structure, and/or a type of structure. For example, the historical insurance claims data may indicate that a two-story, 2600 sq. ft home with no security system was burglarized.

The training data 2620 may include a catalog of devices. The device catalog may include any type of device, such as smoke detectors, carbon monoxide detectors, water leak sensors, motion detectors, security cameras, floodlights, smart locks, door and/or window open/close sensors, alarm systems, etc. The device catalog may include prices, ratings, features, and/or any other suitable information about the devices. The device catalog may include images the devices. The device catalog may include information about new devices for sale and/or older devices no longer for sale. An ML model may process this type of training data 2620 to determine the presence of existing devices proximate a structure and/or derive associations between a structure and one or more recommended devices.

While the example training data includes indications of various types of training data 2620, this is merely an example for case of illustration only. The training data 2620 may include any suitable data which may indicate associations between historical claims data, potential sources of loss, devices for mitigating the risk of loss, home score improvements, as well as any other suitable data which may train the ML model 2610 to generate a recommendation of one or more devices and a resulting home score improvement.

In an aspect, the server may continuously update the training data 2620, e.g., based upon obtaining additional historical insurance claims data, additional devices, or any other training data. Subsequently, the ML model 2610 may be retrained/fine-tuned based upon the updated training data 2620. Accordingly, the device recommendations 2650 and resulting home score improvement 2660 may improve over time.

In an aspect, the ML engine 2605 may process and/or analyze the training data 2620 (e.g., via MLTM 2606) to train the ML model 2610 to generate the device recommendations 2650 and/or home score improvements 2660. The ML model 2610 may be trained to generate the device recommendations 2650 and/or home score improvements 2660 via a neural network, deep learning model, Transformer-based model, generative pretrained transformer (GPT), generative adversarial network (GAN), regression model, k-nearest neighbor algorithm, support vector regression algorithm, and/or random forest algorithm, although any type of applicable ML model/algorithm may be used, including training using one or more of supervised learning, unsupervised learning, semi-supervised learning, and/or reinforcement learning.

Once trained, the ML model 2610 may perform operations on one or more data inputs to produce a desired data output. In one aspect, the ML model 2610 may be loaded at runtime (e.g., by MLOM 2607) from a database (e.g., database of server 140) to process the structure information 2640 and/or imagery data 2645 inputs. The server, such as server 140, may obtain the structure information 2640 and/or imagery data 2645 and use them as input to determine device recommendations 2650 and/or resulting home score improvements 2660.

In one aspect, the server may obtain the structure information 2640 via user input on a user device, such as the mobile device 112 (e.g., of the property owner) which may be running a mobile app and/or via a website, the chatbot 145, or any other suitable user device. The server may obtain the structure information 2640 from available data associated with the structure, such as: government databases of land/property records; a business such as a real estate company which may have publicly listed the property for sale including structure information 2640; an insurance company which may have insured the structure and gathered relevant structure information 2640 in the process; and/or any other suitable source.

The structure information 2640 may include the floorplan of the structure, such as the number of floors, square footage, the location, dimensions, number and/or type of rooms (such as a bathroom), etc. The structure information 2640 may include structural components of the structure, such as the type of roof, drain systems, decks, foundation, as well as other suitable structure components. The structure information 2640 may include the property the structure is located upon including whether it includes a yard, obstructed views of the street, and/or a water feature on the property, as well as other suitable information regarding the property. The structure information 2640 may include the plumbing at the structure such as the number, location, age, condition and/or type of plumbing, pipes, toilets, sewage lines, drains, and/or water lines throughout the structure and/or property. In one aspect, the structure information 2640 may include device information (e.g., information of devices at the structure), such as the number, type, location, age, and/or condition of the devices at the structure. The structure information 2640 may include any information which may be relevant to generating device recommendations 2650 and/or home score improvements 2660.

In one aspect, the server may obtain the imagery data 2645 via the mobile device 112 or any other suitable user device, such as a camera, a database, etc. The imagery data 2645 may include images and/or video of the interior, exterior, and/or property proximate the structure. The imagery data 2645 may comprise images and/or video of existing devices proximate the structure 116. The ML model 2610 may use the imagery data 2645 to detect the presence of and/or identify existing devices proximate the structure.

In one aspect, the ML model 2610 may weigh one or more attributes of the structure information 2640 and/or imagery data 2645 such that they are of unequal importance. For example, a bedroom lacking a smoke detector may be deemed more important than a portion of the structure lacking floodlights. Thus, the ML model 2610 may apply an increased weight to the missing smoke detector and rank, score, or otherwise indicate the smoke detector recommendation more strongly as compared to the floodlight recommendation.

In one embodiment, the ML model 2610 may use a regression model to determine a score associated with the device recommendations based upon the structure information 2640 and/or imagery data 2645 inputs, which may be a preferred model in situations involving scoring output data. In one aspect, the ML model 2610 may rank locations of potential loss where a recommended device may be placed. This may include scored ranking such that locations having certain scores may be considered as having the highest potential as a source of a loss and thus be optimal candidate locations for placement of a recommended device 2650. For example, based upon the structure information 2640 and/or imagery data 2645, the ML model may indicate locations within a fenced backyard would be ideal locations for floodlights based upon associated home improvement scores, but floodlights in a more visible front portion of the house may not have as high of a home improvement score.

Furthermore, it should be appreciated that one home score improvement ML model may be trained to determine improvements for any or all of: the overall home score, the home safety subscore, the fire protection subscore, the sustainability subscore, and/or the home automation subscore. Additionally or alternatively, individual home score improvement ML models may be trained to determine improvements in one of: the overall home score, the home safety subscore, the fire protection subscore, the sustainability subscore, or the home automation subscore.

Once the device recommendations 2650 and/or home score improvements 2660 are generated by the ML model 2610, they may be provided to a user device (e.g., mobile device 112, etc.). For example, the server may provide the device recommendations 2650 and resulting home score improvements 2660 via a mobile app to mobile, device such as mobile device 112, in an email, a website, via a chatbot (such as the ML chatbot 145), and/or in any other suitable manner as further described herein.

In one aspect, the owner, renter and/or other party associated with the structure may be entitled to one or more incentives on an insurance policy associated with the structure upon receiving the device recommendation and/or installing one or more recommended devices.

It should be understood that not all blocks and/or events of the exemplary signal diagrams and/or flowcharts are required to be performed. Moreover, more blocks may be performed even though they are not specifically illustrated. The exemplary signal diagrams and/or flowcharts may include additional, less, or alternate functionality, including that discussed elsewhere herein.

### Exemplary Training of the ML Chatbot Model

In certain embodiments, the machine learning chatbot 145 may be configured to utilize artificial intelligence and/or machine learning techniques. For instance, the machine learning chatbot or voice bot may be a ChatGPT chatbot. The machine learning chatbot may employ supervised or unsupervised machine learning techniques, which may be followed by, and/or used in conjunction with, reinforced or reinforcement learning techniques. The machine learning chatbot may employ the techniques utilized for ChatGPT. The machine learning chatbot may be configured to generate verbal, audible, visual, graphic, text, or textual output for either human or other bot/machine consumption or dialogue.

In some embodiments, the chatbot 145 may be trained and/or operated by the request server 140 and/or the mobile device 112 and/or any other suitable component. In certain embodiments, the chatbot 145 is trained by the request server 140, and operated by the mobile device 112.

Programmable chatbots, such the chatbot 145, may provide tailored, conversational-like abilities relevant to recommending new devices for purchase, and/or placement of new devices proximate a structure. The chatbot may be capable of understanding user requests/responses, providing relevant information, etc. Additionally, the chatbot may generate data from user interactions which the enterprise may use to personalize future support and/or improve the chatbot's functionality, e.g., when retraining and/or fine-tuning the chatbot.

In some embodiments, the chatbot 145 comprises an ML chatbot. The ML chatbot may provide advanced features as compared to a non-ML chatbot, which may include and/or derive functionality from a large language model (LLM). The ML chatbot may be trained on a server, such as server 140, using large training datasets of text which may provide sophisticated capability for natural-language tasks, such as answering questions and/or holding conversations. The ML chatbot may include a general-purpose pretrained LLM which, when provided with a starting set of words (prompt) as an input, may attempt to provide an output (response) of the most likely set of words that follow from the input. In one aspect, the prompt may be provided to, and/or the response received from, the ML chatbot and/or any other ML model, via a user interface of the server. This may include a user interface device operably connected to the server via an I/O module. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances and/or prompts, which may require the ML chatbot to keep track of an entire conversation history as well as the current state of the conversation. The ML chatbot may rely on various techniques to engage in conversations with users, which may include the use of short-term and long-term memory. Short-term memory may temporarily store information (e.g., in a memory of the server 140) that may be required for immediate use and may keep track of the current state of the conversation and/or to understand the user's latest input in order to generate an appropriate response. Long-term memory may include persistent storage of information (e.g., on a database of the server 140) which may be accessed over an extended period of time. The long-term memory may be used by the ML chatbot to store information about the user (e.g., preferences, chat history, etc.) and may be useful for improving an overall user experience by enabling the ML chatbot to personalize and/or provide more informed responses.

The system and methods to generate and/or train an ML chatbot model (e.g., the server 140) which may be used by the ML chatbot, may consist of three steps: (1) a supervised fine-tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning ML Model

FIG. 27 depicts a combined block and logic diagram 2700 for training an ML chatbot model, in which the techniques described herein may be implemented, according to some embodiments. Some of the blocks in FIG. 27 may represent hardware and/or software components, other blocks may represent data structures or memory storing these data structures, registers, or state variables (e.g., data structures for training data 2712), and other blocks may represent output data (e.g., 2725). Input and/or output signals may be represented by arrows labeled with corresponding signal names and/or other identifiers. The methods and systems may include one or more servers 2702, 2704, 2706, such as the server 140 of FIG. 1.

In one aspect, the server 2702 may fine-tune a pretrained language model 2710. The pretrained language model 2710 may be obtained by the server 2702 and be stored in a memory (e.g., a memory of the server). The pretrained language model 2710 may be loaded into an ML training module, such as MLTM 2606, by the server 2702 for retraining/fine-tuning. A supervised training dataset 2712 may be used to fine-tune the pretrained language model 2710 wherein each data input prompt to the pretrained language model 2710 may have a known output response for the pretrained language model 2710 to learn from. The supervised training dataset 2712 may be stored in a memory of the server 2702. In one aspect, the data labelers may create the supervised training dataset 2712 prompts and appropriate responses. The pretrained language model 2710 may be fine-tuned using the supervised training dataset 2712 resulting in the SFT ML model 2715 which may provide appropriate responses to user prompts once trained. The trained SFT ML model 2715 may be stored in a memory of the server 2702.

In one aspect, the supervised training dataset 2712 may include prompts and responses which may be relevant to determining recommended devices proximate a structure. For example, a user prompt may include a request of what new devices placed around a home would improve a home score. Appropriate responses from the trained SFT ML model 2715 may include requesting from the user information regarding the floorplan, structural components, the property the structure is located upon, existing devices at the structure, or other information associated with determining recommended devices. The responses from the trained SFT ML model 2715 may include an indication of one or more optimal placement locations of the one or more recommended devices. The responses from the trained SFT ML model 2715 may include an indication of a home score improvement based upon placement of the one or more recommended devices proximate the home. The indications may be via text, audio, multimedia, etc.

In another example, the prompt may be an indication of the device, and the response may be text explaining why the device improves the home score. For example, the device may be a deadbolt lock, and the response may be “34% of burglars twist the doorknob and walk right in,” as in the example text 2810 of the example of FIG. 28.

In another example, the prompt may be an indication of the device, and the response may be instructions on how to install the device.

### Training the Reward Model

In one aspect, training the ML chatbot model 2750 may include the server 2704 training a reward model 2720 to provide as an output a scaler value/reward 2725. The reward model 2720 may be required to leverage reinforcement learning with human feedback (RLHF) in which a model (e.g., ML chatbot model 2750) learns to produce outputs which maximize its reward 2725, and in doing so may provide responses which are better aligned to user prompts.

Training the reward model 2720 may include the server 2704 providing a single prompt 2722 to the SFT ML model 2715 as an input. The input prompt 2722 may be provided via an input device (e.g., a keyboard) via the I/O module of the server 140. The prompt 2722 may be previously unknown to the SFT ML model 2715, e.g., the labelers may generate new prompt data, the prompt 2722 may include testing data stored on database, and/or any other suitable prompt data. The SFT ML model 2715 may generate multiple, different output responses 2724A, 2724B, 2724C, 2724D to the single prompt 2722. The server 2704 may output the responses 2724A, 2724B, 2724C, 2724D via an I/O module to a user interface device, such as a display (e.g., as text responses), a speaker (e.g., as audio/voice responses), and/or any other suitable manner of output of the responses 2724A, 2724B, 2724C, 2724D for review by the data labelers.

The data labelers may provide feedback via the server 2704 on the responses 2724A, 2724B, 2724C, 2724D when ranking 2726 them from best to worst based upon the prompt-response pairs. The data labelers may rank 2726 the responses 2724A, 2724B, 2724C, 2724D by labeling the associated data. The ranked prompt-response pairs 2728 may be used to train the reward model 2720. In one aspect, the server 2704 may load the reward model 2720 via the MTLM 2606 module and train the reward model 2720 using the ranked response pairs 2728 as input. The reward model 2720 may provide as an output the scalar reward 2725.

In one aspect, the scalar reward 2725 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 2720 may generate a winning reward. Inputting a “losing” prompt-response pair data to the same reward model 2720 may generate a losing reward. The reward model 2720 and/or scalar reward 2736 may be updated based upon labelers ranking 2726 additional prompt-response pairs generated in response to additional prompts 2722.

In one example, a data labeler may provide to the SFT ML model 2715 as an input prompt 2722, “Describe the sky.” The input may be provided by the labeler via the server 2704 running a chatbot application utilizing the SFT ML model 2715. The SFT ML model 2715 may provide as output responses to the labeler via the server 2704: (i) “the sky is above” 2724A; (ii) “the sky includes the atmosphere and may be considered a place between the ground and outer space” 2724B; and (iii) “the sky is heavenly” 2724C. The data labeler may rank 2726, via labeling the prompt-response pairs, prompt-response pair 2722/2724B as the most preferred answer; prompt-response pair 2722/2724A as a less preferred answer; and prompt-response 2722/2724C as the least preferred answer. The labeler may rank 2726 the prompt-response pair data in any suitable manner. The ranked prompt-response pairs 2728 may be provided to the reward model 2720 to generate the scalar reward 2725.

While the reward model 2720 may provide the scalar reward 2725 as an output, the reward model 2720 may not generate a response (e.g., text). Rather, the scalar reward 2725 may be used by a version of the SFT ML model 2715 to generate more accurate responses to prompts, i.e., the SFT model 2715 may generate the response such as text to the prompt, and the reward model 2720 may receive the response to generate a scalar reward 2725 of how well humans perceive it. Reinforcement learning may optimize the SFT model 2715 with respect to the reward model 2720 which may realize the configured ML chatbot model 2750.

### RLHF to Train the ML Chatbot Model

In one aspect, the server 2706 may train the ML chatbot model 2750 (e.g., via the MLTM 2606) to generate a response 2734 to a random, new and/or previously unknown user prompt 2732. To generate the response 2734, the ML chatbot model 2750 may use a policy 2735 (e.g., algorithm) which it learns during training of the reward model 2720, and in doing so may advance from the SFT model 2715 to the ML chatbot model 2750. The policy 2735 may represent a strategy that the ML chatbot model 2750 learns to maximize its reward 2725. As discussed herein, based upon prompt-response pairs, a human labeler may continuously provide feedback to assist in determining how well the ML chatbot's 2750 responses match expected responses to determine rewards 2725. The rewards 2725 may feed back into the ML chatbot model 2750 to evolve the policy 2735. Thus, the policy 2735 may adjust the parameters of the ML chatbot model 2750 based upon the rewards 2725 it receives for generating good responses. The policy 2735 may update as the ML chatbot model 2750 provides responses 2734 to additional prompts 2732.

In one aspect, the response 2734 of the ML chatbot model 2750 using the policy 2735 based upon the reward 2725 may be compared using a cost function 2738 to the SFT ML model 2715 (which may not use a policy) response 2736 of the same prompt 2732. The server 2706 may compute a cost 2740 based upon the cost function 2738 of the responses 2734, 2736. The cost 2740 may reduce the distance between the responses 2734, 2736, i.e., a statistical distance measuring how one probability distribution is different from a second, in one aspect the response 2734 of the ML chatbot model 2750 versus the response 2736 of the SFT model 2715. Using the cost 2740 to reduce the distance between the responses 2734, 2736 may avoid a server over-optimizing the reward model 2720 and deviating too drastically from the human-intended/preferred response. Without the cost 2740, the ML chatbot model 2750 optimizations may result in generating responses 2734 which are unreasonable but may still result in the reward model 2720 outputting a high reward 2725.

In one aspect, the responses 2734 of the ML chatbot model 2750 using the current policy 2735 may be passed by the server 2706 to the rewards model 2720, which may return the scalar reward or discount 2725. The ML chatbot model 2750 response 2734 may be compared via cost function 2738 to the SFT ML model 2715 response 2736 by the server 2706 to compute the cost 2740. The server 2706 may generate a final reward 2742 which may include the scalar reward 2725 offset and/or restricted by the cost 2740. The final reward or discount 2742 may be provided by the server 2706 to the ML chatbot model 2750 and may update the policy 2735, which in turn may improve the functionality of the ML chatbot model 2750.

To optimize the ML chatbot 2750 over time, RLHF via the human labeler feedback may continue ranking 2726 responses of the ML chatbot model 2750 versus outputs of earlier/other versions of the SFT ML model 2715, i.e., providing positive or negative rewards or adjustments 2725. The RLHF may allow the servers (e.g., servers 2704, 2706) to continue iteratively updating the reward model 2720 and/or the policy 2735. As a result, the ML chatbot model 2750 may be retrained and/or fine-tuned based upon the human feedback via the RLHF process, and throughout continuing conversations may become increasingly efficient.

Although multiple servers 2702, 2704, 2706 are depicted in the exemplary block and logic diagram 2700, each providing one of the three steps of the overall ML chatbot model 2750 training, fewer and/or additional servers may be utilized and/or may provide the one or more steps of the ML chatbot model 2750 training. In one aspect, one server may provide the entire ML chatbot model 2750 training.

### Additional Exemplary Embodiments—Recommending a New Device to Purchase to Improve a Home Score

In one aspect, a computer-implemented method for recommending a device to purchase to improve a home score may be provided. The method may be implemented via one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components, which may be in wired or wireless communication with one another. For instance, in one example, the method may include: (1) determining, via one or more processors, at least one of an overall home score, a home safety subscore, a fire protection subscore, a sustainability subscore, and/or a home automation subscore for a home; (2) identifying, via the one or more processors, a device; (3) determining, via the one or more processors, a home score improvement that adding the device to the home would make for the overall home score, the home safety subscore, the fire protection subscore, the sustainability subscore, and/or the home automation subscore; and/or (4) displaying, via the one or more processors, the home score improvement on a display, and/or otherwise visually, graphically, textually, audibly, or verbally outputting the home score improvement, such as via a processor, screen, voice bot, chatbot, or other bot. The method may include additional, fewer, or alternate actions, including those discussed elsewhere herein.

In some embodiments, the determining the at least one of the overall home score, the home safety subscore, the fire protection subscore, the sustainability subscore, and/or the home automation subscore comprises determining the home safety subscore; the determining the home score improvement comprises determining a home score improvement that adding the device to the home would make for the home safety subscore; and/or device comprises: a deadbolt lock, a security camera, a motion detector, a smart outdoor lightbulb.

In some embodiments, the determining the at least one of the overall home score, the home safety subscore, the fire protection subscore, the sustainability subscore, and/or the home automation subscore comprises determining the fire protection subscore; the determining the home score improvement comprises determining a home score improvement that adding the device to the home would make for the fire protection subscore; and/or device comprises: a smoke detector, an indoor sprinkler system, or a security camera.

In some embodiments, the determining the at least one of the overall home score, the home safety subscore, the fire protection subscore, the sustainability subscore, and/or the home automation subscore comprises determining the sustainability subscore; the determining the home score improvement comprises determining a home score improvement that adding the device to the home would make for the sustainability subscore; and/or device comprises: a smart thermostat, a smart washing machine, a smart dryer, or a light emitting diode (LED) lightbulb.

In some embodiments, the determining the at least one of the overall home score, the home safety subscore, the fire protection subscore, the sustainability subscore, and/or the home automation subscore comprises determining the home automation subscore; the determining the home score improvement comprises determining a home score improvement that adding the device to the home would make for the home automation subscore; and/or device comprises: a smart main water shutoff valve, a smart thermostat, a smart washing machine, a smart dryer, a smart stove, a smart refrigerator, or a smart lightbulb.

The overall home score and its individual components may be presented in various means to a user and/or homeowner. For instance, the overall home score and related information may be visually, graphically, textually, audibly, or verbally outputted or presented, such as via a processor, screen, voice bot, chatbot, or other bot.

In some embodiments, the method further comprises identifying, via the one or more processors, potential placement locations of the device; and/or determining, via the one or more processors, respective improvements that placing the device in each of the potential placement locations would make for the overall home score, the home safety subscore, the fire protection subscore, the sustainability subscore, and/or the home automation subscore; and/or wherein the displaying includes displaying, via the one or more processors, on the display, respective indications of the respective improvements that placing the device in each of the potential placement locations would make.

In some embodiments, the method further comprises receiving, via the one or more processors, a selection of the device from a mobile device; and/or in response to receiving the selection, initiating, via the one or more processors, a purchase of the device.

In some embodiments, the displaying further comprises displaying text explaining why the device improves the overall home score, the home safety subscore, the fire protection subscore, the sustainability subscore, and/or the home automation subscore.

In some embodiments, (i) the device is a first device, (ii) the home score improvement is a first home score improvement, and/or (iii) the method further comprises: determining, via the one or more processors, a second home score improvement that adding a second device to the home would make for the overall home score, the home safety subscore, the fire protection subscore, the sustainability subscore, and/or the home automation subscore; and/or ranking, via the one or more processors, the first device and the second device based upon the first home score improvement and the second home score improvement to thereby create a ranked list of devices; and/or wherein the displaying includes displaying, via the one or more processors, the ranked list of devices.

In some embodiments, the determination of the home score improvement is based upon an existing number of devices already in the home with a same device type as the device.

In some embodiments, the method further comprise accessing, via the one or more processors, an insurance profile associated with a life insurance policy of an insurance customer to obtain an inventory list; and/or determining, via the one or more processors, from the inventory list, an existing number of devices already in the home with a same device type as the device; and/or wherein the determination of the home score improvement is based upon the existing number of devices already in the home with a same device type as the device.

In some embodiments, the one or more processors determine the home score improvement by using a home score improvement machine learning model trained using insurance claims data.

In another aspect, a computer system for recommending a device to purchase to improve a home score may be provided. The computer system may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components, which may be in wired or wireless communication with one another. For example, in one instance, the computer system may include one or more processors configured to: (1) determine at least one of an overall home score, a home safety subscore, a fire protection subscore, a sustainability subscore, and/or a home automation subscore for a home; (2) identify a device; (3) determine a home score improvement that adding the device to the home would make for the overall home score, the home safety subscore, the fire protection subscore, the sustainability subscore, and/or the home automation subscore; and/or (4) display the home score improvement on a display. The computer system may include additional, less, or alternate functionality, including that discussed elsewhere herein.

In some embodiments, the one or more processors are further configured to: receive a selection of the device from a mobile device; and/or in response to receiving the selection, initiate a purchase of the device.

In some embodiments, the one or more processors are further configured to perform the display by displaying the home score improvement along with text explaining why the device improves the overall home score, the home safety subscore, the fire protection subscore, the sustainability subscore, and/or the home automation subscore.

In some embodiments, the determination of the home score improvement is based upon an existing number of devices already in the home with a same device type as the device.

In yet another aspect, a computer device for recommending a device to purchase to improve a home score may be provided. The computer device may include one or more local or remote processors, sensors, transceivers, servers, memory units, augmented reality glasses or headsets, virtual reality headsets, extended or mixed reality headsets, smart glasses or watches, wearables, voice bot or chatbot, ChatGPT bot, and/or other electronic or electrical components. For instance, in one example, the computer device may include: one or more processors; and/or one or more non-transitory memories coupled to the one or more processors. The one or more non-transitory memories including computer executable instructions stored therein that, when executed by the one or more processors, may cause the one or more processors to: (1) determine at least one of an overall home score, a home safety subscore, a fire protection subscore, a sustainability subscore, and/or a home automation subscore for a home; (2) identify a device; (3) determine a home score improvement that adding the device to the home would make for the overall home score, the home safety subscore, the fire protection subscore, the sustainability subscore, and/or the home automation subscore; and/or (4) display the home score improvement on a display. The computer device may include additional, less, or alternate functionality, including that discussed elsewhere herein.

In some embodiments, the one or more non-transitory memories having stored thereon computer executable instructions that, when executed by the one or more processors, cause the computer device to: receive a selection of the device from a mobile device; and/or in response to receiving the selection, initiate a purchase of the device.

In some embodiments, the one or more non-transitory memories having stored thereon computer executable instructions that, when executed by the one or more processors, cause the computer device to perform the display by displaying the home score improvement along with text explaining why the device improves the overall home score, the home safety subscore, the fire protection subscore, the sustainability subscore, and/or the home automation subscore.

In some embodiments, the determination of the home score improvement is based upon an existing number of devices already in the home with a same device type as the device.

### Recommendation System and Methods for Determining an Improvement to a Home Score for Replacing or Repairing an Existing Device

The present embodiments may also relate to, inter alia, determining an improvement to a home score based upon replacing and/or repairing an existing device. For example, an insurance app may determine and/or display the overall home score determined from the home safety, fire protection, sustainability and/or home automation subscores. The system may determine if replacing or repairing an existing device would improve any of the score(s) (e.g., if replacing a thermostat with a smart thermostat would improve any of the score(s)). In some examples, imagery information may be used to identify existing devices. In some instances, some users may prefer to replace existing devices at specific points in time (e.g., replacing a smoke alarm when it runs out of batteries), so the system may recommend times for replacing particular devices. The recommended timeframes may also take into account the age of existing devices (e.g., account for a smoke detector lifespan of 10 years, etc.). The system may also recommend maintenance at certain time intervals (e.g., recommend replacing smoke alarm batteries before the smoke alarm starts chirping). The system may also determine if it is better to repair or replace an existing device if it has been damaged.

### Exemplary Computer-Implemented Methods for Determining an Improvement to a Home Score for Replacing or Repairing an Existing Device

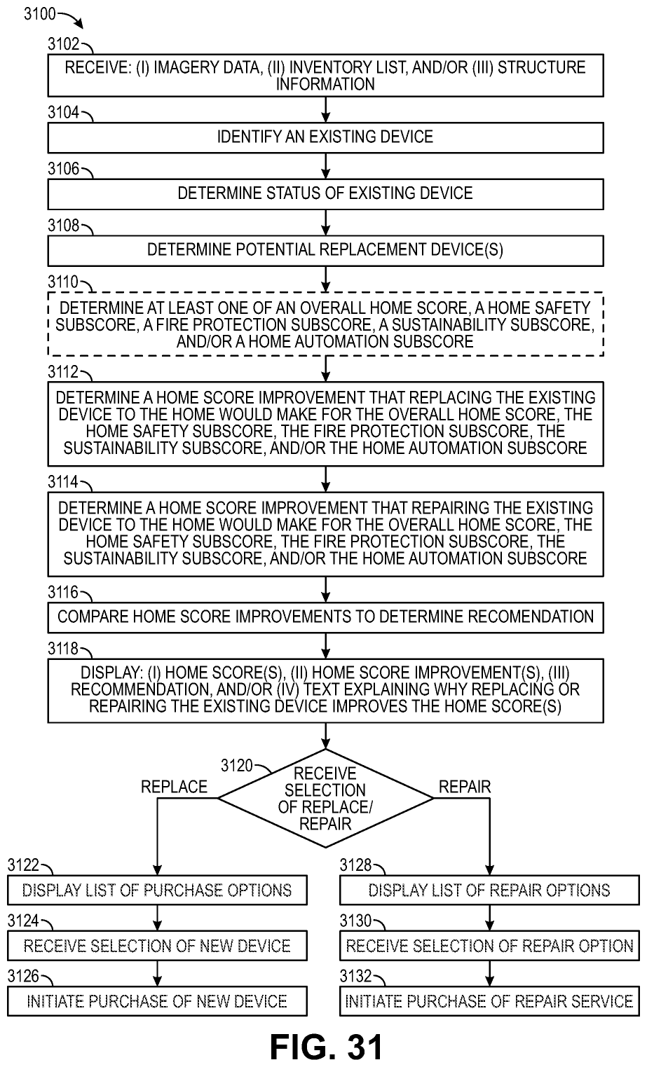

FIG. 31 shows an exemplary computer-implemented method or implementation 3100 for determining an improvement to a home score for replacing or repairing an existing device. Although the following discussion refers to the exemplary method or implementation 3100 as being performed by the one or more processors 150, it should be understood that any or all of the blocks may be alternatively or additionally performed by any other suitable component as well. For example, the exemplary method or implementation 3100 may be performed wholly or partially by the one or more processors 142, the one or more processors 122, or any suitable device including those discussed elsewhere herein, such as one or more local or remote processors, transceivers, memory units, sensors, mobile devices, unmanned aerial vehicles (e.g., drones), etc.

The exemplary implementation 3100 may begin at block 3102 when the one or more processors 150 may receive: (i) imagery data, (ii) an inventory list, and/or (iii) structure information.

The imagery data (e.g., image data and/or video data) may be received from a mobile device 112 and/or a smart home device 110 (e.g., generated by the sensors 120, such as a camera). The smart home device 110 may be in a fixed or semi fixed position within the home 116 (e.g., a security camera, etc.). Alternatively, the smart home device 110 may be mobile (e.g., smart vacuum cleaner with camera attached). The imagery data may be of any portion of the inside or the outside of the home 116. As will be seen, the imagery data may be used to identify existing devices, determine home score(s) and/or improvements to home score(s), etc.

The inventory list may be received via any suitable technique. For example, a user may enter the inventory list into the mobile device 112. In another example, the one or more processors 150 may access an insurance profile associated with a life insurance policy of an insurance customer (e.g., the user) to obtain the inventory list. The insurance profile may be stored at any of the request server 140, the requestor 114, the mobile device 112, and/or any other storage location. The inventory list may then be used to determine existing devices (e.g., include type and number of the devices) already in the home 116.

The structure information may include the floorplan of the structure, such as the number of floors, square footage, the location, dimensions, number and/or type of rooms (such as a bathroom), etc. The structure information may include structural components of the structure, such as the type of roof, drain systems, decks, foundation, as well as other suitable structure components. The structure information may include the property the structure is located upon including whether it includes a yard, obstructed views of the street, and/or a water feature on the property, as well as other suitable information regarding the property. The structure information may include the plumbing at the structure such as the number, location, age, condition and/or type of plumbing, pipes, toilets, sewage lines, drains, and/or water lines throughout the structure and/or property. In one aspect, the structure information may include device information (e.g., information of devices at the structure), such as the number, type, location, age, and/or condition of the devices at the structure. In this regard, it should be appreciated that the system may determine the existing devices existing in the home 116 from any of the imagery data, inventory list, and/or structure information. The structure information may include any information which may be relevant to generating home score improvements for replacing devices and/or home score improvements for repairing existing devices. The structure information may be received via any suitable source, such as the user entering the structure information into the mobile device 112, an online database, from insurance claim information, etc.

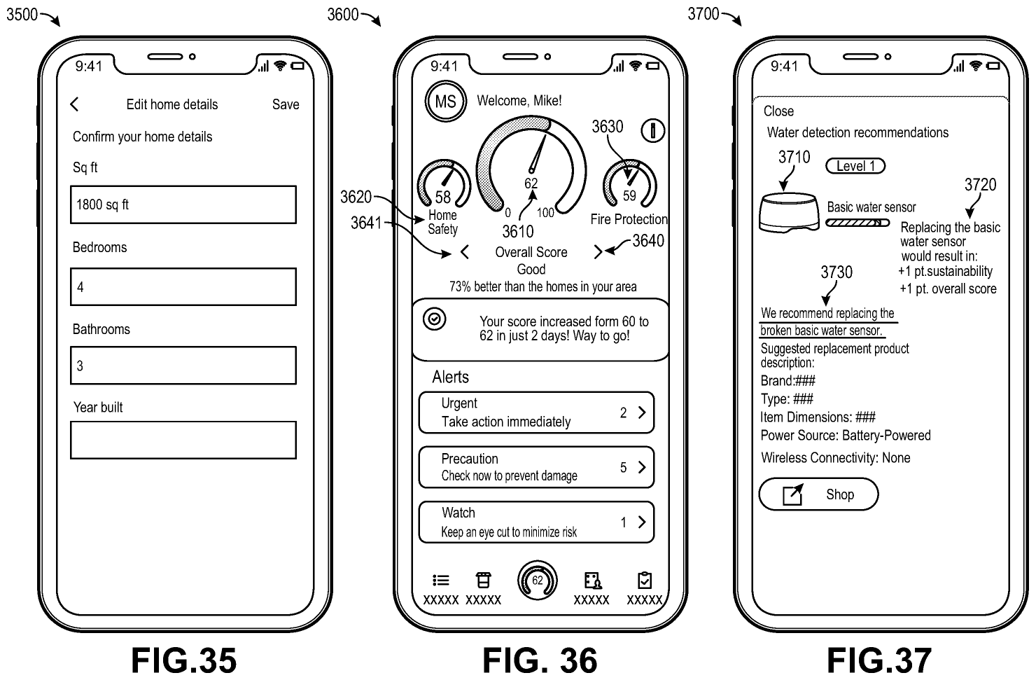

In some embodiments, a user enters or confirms structure information via the mobile device 112. Furthermore, advantageously, in some embodiments, the user may be given a “bonus” to any of the home score(s) for entering and/or confirming structural information (e.g., plus four points to the overall home score for entering and/or confirming structural information, such as devices existing at the home 116, square footage of the home 116, number of bedrooms of the home 116, number of bathrooms of the home 116, year built of the home 116, etc.). A user entering and/or confirming structural information advantageously improves accuracy of the system in determining home score(s), improvements in home scores, recommendations to purchase, etc. FIG. 35 depicts an exemplary screen allowing a user to enter and/or confirm structural information.

At block 3104, the one or more processors 150 may identify an existing device (e.g., a device that is already existing within the home 116). The existing device may be identified via any suitable technique, such as identified from any of the imagery data, the inventory list and/or the structure information.

At block 3106, the one or more processors 150 may determine a status of the existing device. For example, the status may be determined to be: (i) operational, (ii) damaged, (iii) broken, (iv) expired, and/or (v) low on electrical energy.

Examples of operational devices include devices that are fully functional, devices that are operating at their normal or expected capacity, etc.

Examples of damaged devices include devices that are not operating at their normal expectancy and/or capacity. For example, a smart refrigerator or smart air conditioning condenser may be able to lower the temperature to a moderate level, but not all the way to an optimal level. Another example of a damaged device may be a smart thermostat or other smart device with a cracked screen so that the display contents are harder to view than would be expected.

Examples of broken devices include devices that are not functioning. In some examples, a broken devices comprises a device that will not turn on or start.

Examples of expired devices includes devices that are past their expiration date and/or life expectancy. For example, a smoke detector may have an expiration date and/or life expectancy of 10 years.

Examples of devices with a status of low on electrical energy include devices that are low on batteries. In some examples, this includes devices that are entirely out of batteries. In other examples, it includes devices with an electrical charge below a predetermined threshold (e.g., 15% of battery capacity, 10% of battery capacity, 5% of battery capacity, etc.).

The operational status may be determined by any suitable technique. For example, the user may enter the operational status of the existing device into the mobile device 112. In another example, an existing device may send a signal to the one or more processors 112 of its operational status. In some such examples, the mobile device 112 sends a request to the existing device requesting the operational status of the existing device, and the existing device responds by sending its operational status to the mobile device (or other device that sent the request). In some examples, the existing device sends its battery charge level to the mobile device so that the mobile device may determine if the existing device has a low on electrical energy status.

Additionally or alternatively, the status of the existing device may be determined from the imagery data. For example, a machine learning algorithm may determine from the imagery data that the existing device is damaged or broken. For example, the machine learning algorithm may determine that a smart device has a cracked screen to determine that the device is damaged or broken. In another example, the machine learning algorithm may determine that smoke has come out of the smart device indicating that the smart device is damaged or broken.

At block 3108, the one or more processors 150 may determine potential replacement devices for the existing device. The potential replacement devices may be determined by any suitable technique. For example, based upon type of existing device, the potential replacement devices may be determined from a catalog, such as the exemplary catalog 2500.

In certain embodiments, the one or more processors 150 may determine the potential replacement devices in response to a determination at block 3106 that the status of the existing device is damaged, broken, expired, and/or low on electrical energy.

Advantageously, replacing an existing device at a particular point in time may improve the system. For example, some users may wish to replace a device if it is both running low on batteries and nearing the end of its useful life (e.g., smoke detector running low on batteries and also nearing the end of its lifespan). To this end, in some embodiments, the potential replacement devices are determined in response to a determination of both: (i) the existing device being within a predetermined time of an expiration date, and (ii) the existing device being low on electrical energy. Advantageously, this reduces the amount of time that the user will have to spend on maintenance (e.g., the user will have to climb a latter once to reach a smoke detector rather than twice with one time to replace a battery and another shortly thereafter to replace the entire smoke detector).

At optional block 3110, the one or more processors 150 may determine at least one of an overall home score, a home safety subscore, a fire protection subscore, a sustainability subscore, and/or a home automation subscore for a home.

The home score(s) may be determined by any suitable technique. In some examples, the home scores may be determined without the use of machine learning. For example, in some embodiments, the home safety subscore, fire protection subscore, sustainability subscore, and/or home automation subscore for a home may be determined by determining attribute(s) for each subscore. Subsequently, the overall home score may be determined by combining the subscore (e.g., by taking an average or weighted average of the subscores).

Said another way, in some variations, the home safety subscore may be determined based upon one or more home safety attributes; the fire protection subscore may be determined based upon one or more fire protection attributes; the sustainability subscore may be determined based upon one or more sustainability attributes; and/or the home automation subscore may be determined based upon one or more home automation attributes.

Any or all of the attributes may be valued (e.g., measured, etc.) in the form of a “grade.” In this regard, such attributes may be “categorical” attributes. In some examples, the grades may be letter grades of A through F. Further, the grades may be assigned numerical scores.

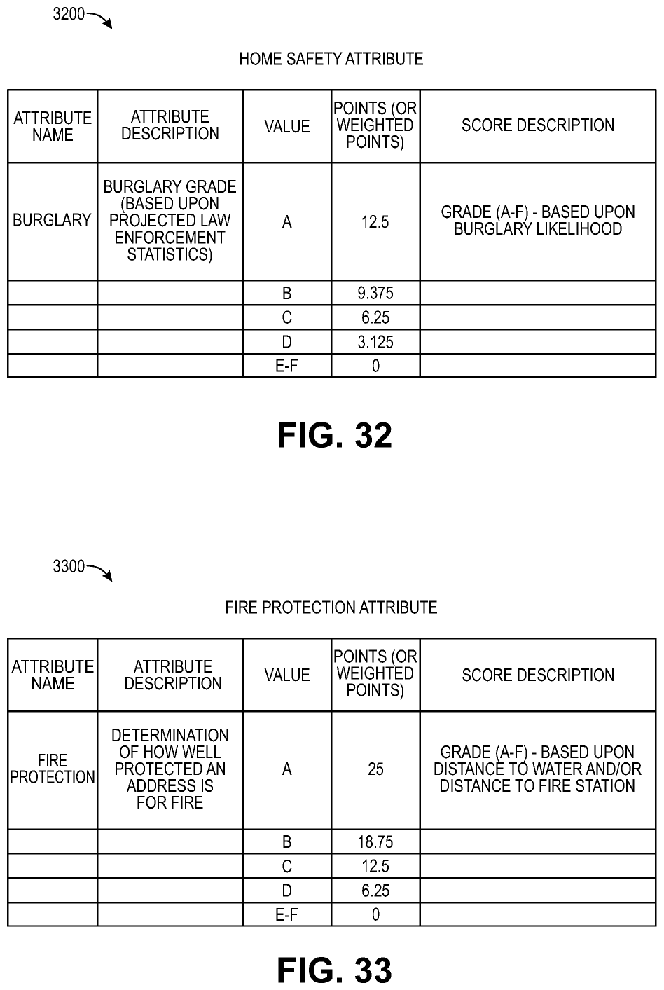

By way of exemplary illustration, FIG. 32 shows an exemplary table 3200 indicating information of an exemplary home safety attribute. The attribute may have a name, which, in the illustrated example, is a burglary attribute. The exemplary attribute may be assigned a grade (e.g., a value), such as a grade of A through F. The grade/value may further be assigned points and/or weighted points. For instance, in the illustrated example, a grade of A may be assigned 12.5 points; a grade of B may be assigned 9.375 points; a grade of C may be assigned 6.25 points; a grade of D assigned 3.125 points; and/or a grade of E or F assigned 0 points.

FIG. 33 shows an exemplary table 3300 indicating information of a fire protection attribute. In the illustrated example, the fire protection attribute may be assigned a grade (e.g., a value), such as a grade of A through F. The grade/value may further be assigned points and/or weighted points. For instance, in the illustrated example, a grade of A may be assigned 25 points; a grade of B may be assigned 18.75 points; a grade of C may be assigned 12.5 points; a grade of D assigned 6.25 points; and/or a grade of E or F assigned 0 points. As discussed elsewhere herein, the points or weighted points may be used, for example, as part of determining the overall home score.

In some embodiments, when values are missing (e.g., NaN, etc.), they may be filled in with a neutral value. For instance, with respect to any of the examples of FIGS. 32-33, if any of the values corresponding to attributes with a grade (A-F) are missing, they may be filled in with a value of C. For example, if the burglary value is missing (FIG. 32), it may be filled in with a value of C, and thus receive points or weighted points of 6.25.

In some implementations, the grades and/or categorical values may be assigned by a vendor evaluating the home 116. The assigned grades and/or categorical values may then be stored in a database, and/or sent directly to any other component in FIG. 1 (e.g., the request server 140, the requestor 114, the mobile device 112, the smart product 110, etc.).

Additionally or alternatively, individual devices may affect a home score(s) by a specific amount (e.g., adding an electrical meter improves a sustainability subscore by 3 points; adding a smart water meter improves a sustainability subscore by 2 points; adding a smart smoke detector improves a home automation subscore by 1 point; etc.). In addition, in some embodiments, each device affects the home score incrementally (e.g., each smart smoke detector added adds one point to the fire protection subscore, etc.). However, in some such embodiments, there is a maximum number of devices that may continue to improve the home score(s) (e.g., the first 5 smoke detectors each improve the fire protection subscore by 1 point, but the sixth does not improve the home score). In some certain embodiments, the improvements are phased out (e.g., the first four smoke detectors each improve the fire protection subscore by 1 point, the next 3 smoke detectors improve the fire protection subscore by half a point, and the subsequent smoke detectors do not improve the fire protection subscore). Furthermore, different models of a device may have different impacts on the home score(s) (e.g., a basic model smart main water shut off valve improves a home automation subscore by 2 points, and a more advanced model improves the home automation subscore by 4 points). As such, the home score(s) may be affected by both the model and the quantity of the device.

To this end, the attribute may also comprise a matrix of devices. For example, for any of the subscores, there may be an attribute including device matrixes for particular devices. For instance, FIG. 34 depicts exemplary matrix 3400 of smart smoke detectors indicating points that the smart smoke detectors increase the home automation subscore by. The exemplary matrix 3400 depicts both model and quantity of the device, with the numbers in the matrix indicating how the devices affect the home automation subscore. For example, as illustrated, a home automation subscore for a home with one model A smoke detector would get 1 point for the model A smoke detector. In another illustrated example, a home automation subscore for a home with three model C smoke detectors would get 9 points for the smoke detectors.

Additionally or alternatively, at optional block 3110, the one or more processors 150 may determine at least one of an overall home score, a home safety subscore, a fire protection subscore, a sustainability subscore, and/or a home automation subscore for a home via machine learning (e.g., as described with respect to FIG. 12).

At block 3112, the one or more processors 150 may determine a home score improvement that replacing the existing device to the home would make for the overall home score, the home safety subscore, the fire protection subscore, the sustainability subscore, and/or the home automation subscore. In some examples, the determination may be based upon the potential replacements device(s) identified at block 3108 (e.g., a determination of a home score(s) improvement is made for each identified potential replacement device, etc.).

The determination may be made by any suitable technique. In some examples, the determination is made without the use of machine learning, such as by determining that when the existing device is replaced, the home score(s) will improve by a predetermined amount (e.g., replacing an electrical meter improves a sustainability subscore by 3 points; replacing a smart water meter improves a sustainability subscore by 2 points; replacing a smart smoke detector improves a home automation subscore by 1 point; etc.).

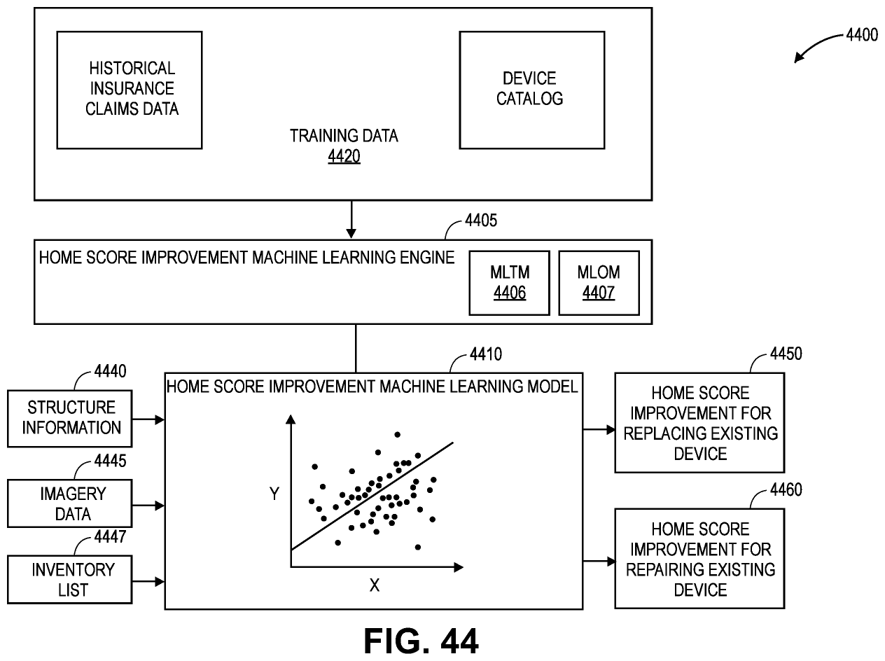

Additionally or alternatively, the determination may be made via machine learning, as will be discussed with respect to FIG. 44.

At block 3114, the one or more processors 150 may determine a home score improvement that repairing the existing device to the home would make for the overall home score, the home safety subscore, the fire protection subscore, the sustainability subscore, and/or the home automation subscore.

The determination may be made by any suitable technique. In some examples, the determination is made without the use of machine learning, such as by determining that when the existing device is repaired, the home score(s) will improve by a predetermined amount (e.g., replacing an electrical meter improves a sustainability subscore by 3 points; replacing a smart water meter improves a sustainability subscore by 2 points; replacing a smart smoke detector improves a home automation subscore by 1 point; etc.).

Additionally or alternatively, the determination may be made via machine learning, as will be discussed with respect to FIG. 44.

At block 3116, the home score improvement for replacing the existing device may be compared to the home score improvement for repairing the existing device to determine a recommendation of if to repair or replace the existing device.

In some examples, the improvement for the overall home score for replacing the existing device is compared to the improvement for the overall home score for repairing the existing device. In some such examples, the recommendation may be determined to be the higher overall home score improvement.

In some examples, the recommendation may be based at least in part on one or more of the subscores. For example, the one or more processors 150 may receive a selection of a particular subscore from the user; and the recommendation may be to recommend the higher replace or repair improvement for the particular subscore.

In some examples, the one or more processors 150 take into account the prices of the potential replacement devices in determining the recommendation. For example, the recommendation may be based both upon: (i) the difference between the replace and repair improvements, and (ii) the price differences between replacing and repairing the existing device.

In some examples, the recommendation includes a suggested date and/or range of dates to replace or repair the existing device. For example, if the status of the existing device indicates that the existing device is low on electrical energy, the recommendation may include a suggested date to replace or repair the device by to avoid running out of electrical energy. In another example, the recommendation may include a suggested date before the expiration date to replace or repair the existing device.

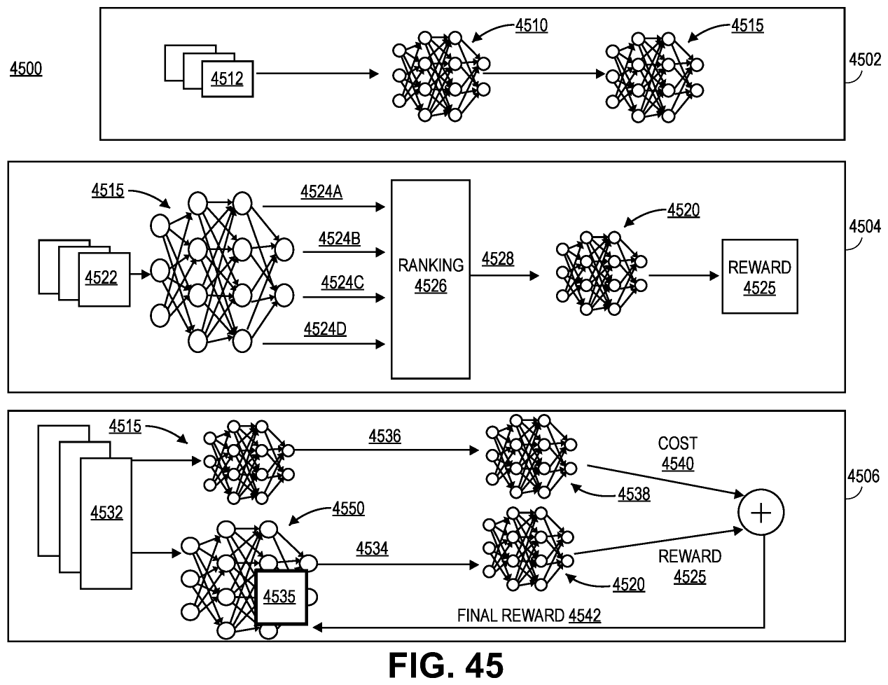

At block 3118, the system (e.g., via the one or more processors 150, etc.) may display (e.g., on display 160, a display of the request server 140, a display of the requestor 114, etc.): (i) the home score(s), (ii) the home score improvement(s), (iii) the recommendation (possibly including text explaining the recommendation), and/or (iv) text explaining why replacing or repairing the existing device improves the home score(s). In some examples, any or all of the text may be generated via a chatbot 145, such as described below with respect to FIG. 45.

Examples of displays of the home score are illustrated by FIGS. 6B, 10, 17, and 19. FIG. 36 depicts a further exemplary screen 3600 displaying the overall home score 3610, the home safety subscore 3620, and the fire protection subscore 3630. Furthermore, arrows 3640, 3641 allow the user to toggle between the home scores. For example, pressing the arrow 3640 may display the home safety subscore in the center of the screen, etc.

FIG. 37 depicts exemplary screen 3700 showing home score improvements 3720 (e.g., +1 point to the sustainability subscore, and +1 point to the overall home score) for replacing the existing device 3710 (e.g., the basic water sensor). Also illustrated is recommendation 3730 to replace the device.

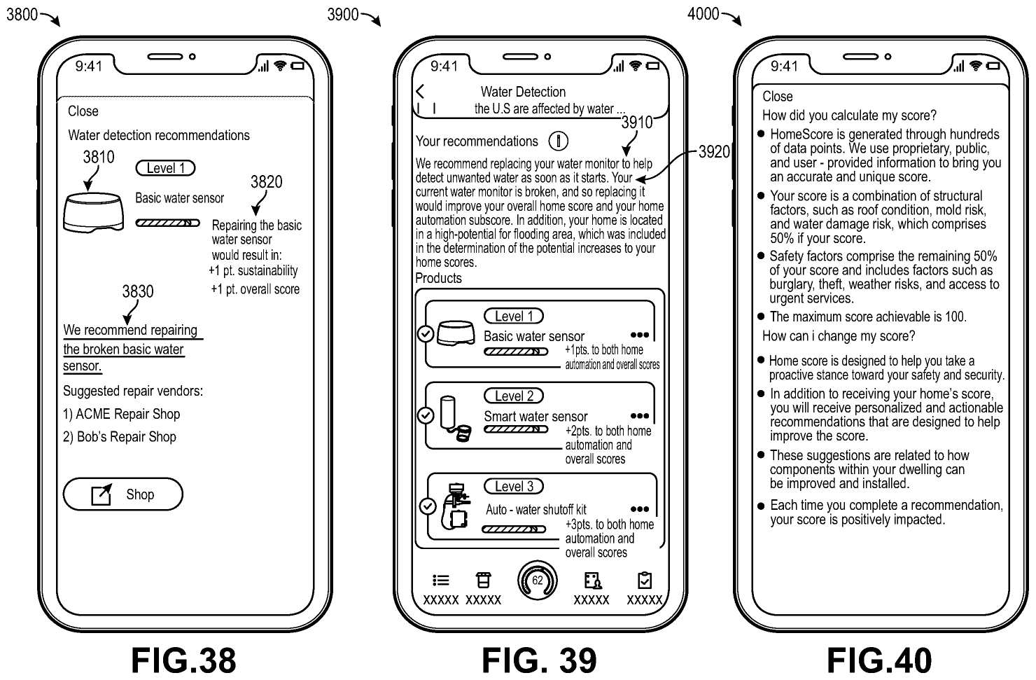

FIG. 38 depicts exemplary screen 3800 showing home score improvements 3820 (e.g., +1 point to the sustainability subscore, and +1 point to the overall home score) for replacing the existing device 3810 (e.g., the basic water sensor). Also illustrated is recommendation 3830 to repair the device.

FIG. 39 depicts exemplary screen 3900 including a recommendation 3910 to replace a water monitor. The recommendation 3910 further includes text explaining the recommendation 3920. The text 3920 is also text explaining why replacing the existing device would improve the home score(s). For example, the text 3920 explains that the existing water monitor is broken, and further explains that the home 116 is located in a high-potential for flooding area.

Furthermore, at block 3118 or at any other point in the exemplary computer-implemented method 3100, the system may display text explaining how the home score(s) are calculated, for example, as illustrated by exemplary screen 4000 of FIG. 40.

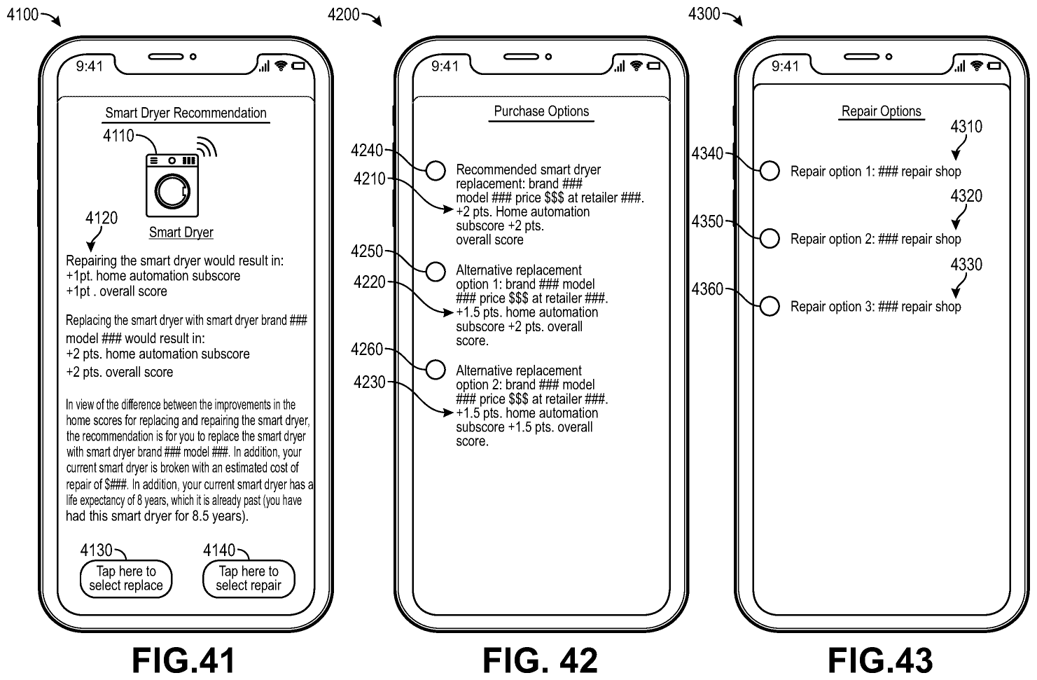

FIG. 41 depicts exemplary screen 4100 including a difference between a home score improvement for replacing an existing device, and a home score improvement for repairing the existing device. More specifically, in the illustrated example, the existing device is smart dryer 4110, and the recommendation 4120 includes displaying both the home score improvement for replacing the existing device 4110 and the home score improvement for repairing the existing device 4110 (e.g., thereby indicating/displaying the difference between the two improvements). Furthermore, text of the recommendation 4110 explains the recommendation (e.g., explains why it is recommended to replace the existing device 4110 rather than repair the existing device 4110).

At block 3120, the one or more processors 150 may receive a selection to either replace or repair the existing device (e.g., via the user pressing either of the buttons 4130 or 4140, etc.). If the selection is to replace the existing device, a user may be displayed a list of purchase options (e.g., block 3122). In this regard, FIG. 42 depicts an exemplary screen 4200 which may be displayed following a selection to replace the existing device, and which displays a list of purchase or replacement options. The first option 4210 may be, for example, the brand/model mentioned on screen 4100 in the text 4120, and/or which the recommendation was based upon. The second option 4220, and third option 4230 may be alterative options. In some examples, the alternative options may be options that do not improve the home score(s) as much as the recommended option, but are less expensive. The user may select any of the options (e.g., at block 3124) by any suitable technique, such as by clicking on any of the circles 4240, 4250, 4260. The one or more processors 150 may initiate purchase of a new device (e.g., via any suitable retailer) following selection of an option (e.g., block 3126).

If the selection is to repair the existing device, a user may be displayed a list of repair options (e.g., block 3128). FIG. 43 depicts an exemplary screen 4300 which may be displayed following a selection to repair the existing device, and which displays a list of repair options. The first, second and third options 4310, 4320, 4330 may be, for example, for different repair shops. The user may select any of the options (e.g., at block 3130) by any suitable technique, such as by clicking on any of the circles 4340, 4350, 4360. The one or more processors 150 may initiate purchase of a new device (e.g., via any suitable retailer) following selection of a repair option (e.g., block 3132).

Advantageously, first presenting a user with a recommendation to replace or repair the existing device and/or text explaining the recommendation, and subsequently presenting replace/repair selection options (e.g., following a selection between buttons 4130, 4140) streamlines the process and reduces signals that are sent throughout the system. For example, a user does not first need to be presented with lists of both replacement options and repair options. That is, following a selection to replace or repair, the user may be presented with options for only replacing or repairing the existing device. Therefore, because the processes may be streamlined (e.g., the user is able to make a replacement or repair purchase more quickly) and the amount of signals that are sent through the system may be reduced, the technical functioning of the system is improved.

It should be understood that not all blocks and/or events of the exemplary signal diagrams and/or flowcharts are required to be performed. Moreover, more blocks may be performed even though they are not specifically illustrated. The exemplary signal diagrams and/or flowcharts may include additional, less, or alternate functionality, including that discussed elsewhere herein.

### Exemplary ML Model to Determine Recommended Devices

In some embodiments, determining: (i) a home score improvement for replacing an existing device, and/or (ii) a home score improvement for repairing an existing device may use ML.

FIG. 44 exemplary diagram 4400 schematically illustrates how an ML model may generate device recommendations and home score improvements based upon structure information, imagery data, and/or an inventory list. Broadly speaking, the home score improvement for replacing an existing device 4450 may be a home score improvement that replacing the existing device in the home 116 would make for an overall home score, a home safety subscore, a fire protection subscore, a sustainability subscore, and/or a home automation subscore; and the home score improvement for repairing an existing device 4460 may be a home score improvement that repairing the existing device in the home 116 would make for the overall home score, the home safety subscore, the fire protection subscore, the sustainability subscore, and/or the home automation subscore.

Some of the blocks in FIG. 44 represent hardware and/or software components (e.g., block 4405), other blocks represent data structures or memory storing these data structures, registers, or state variables (e.g., block 4420), and other blocks represent output data (e.g., blocks 4450 and 4460). Input signals are represented by arrows labeled with corresponding signal names.

The home score improvement ML engine 4405 may include one or more hardware and/or software components, such as the ML training module (MLTM) 4406 and/or the ML operation module (MLOM) 4407, to obtain, create, (re) train, operate and/or save one or more ML models 4410. To generate the ML model 4410, the ML engine 4405 may use the training data 4420.

As described herein, the server such as request server 140 may obtain and/or have available various types of training data 4420 (e.g., stored on database of server 140). In one aspect, the training data 4420 may labeled to aid in training, retraining and/or fine-tuning the ML model 4410. The training data 4420 may include data associated with historical insurance claims which may indicate one or more of a type of loss, amount of loss, devices present or absent in the structure, and/or a type of structure. For example, the historical insurance claims data may indicate that a two-story, 2600 sq. ft home with no security system was burglarized.

The training data 4420 may include a catalog of devices. The device catalog may include any type of device, such as smoke detectors, carbon monoxide detectors, water leak sensors, motion detectors, security cameras, floodlights, smart locks, door and/or window open/close sensors, alarm systems, etc. The device catalog may include prices, ratings, features, and/or any other suitable information about the devices. The device catalog may include images the devices. The device catalog may include information about new devices for sale and/or older devices no longer for sale. An ML model may process this type of training data 4420 to “learn” how to determine the improvements in the home scores 4450, 4460.

While the example training data includes indications of various types of training data 4420, this is merely an example for case of illustration only. The training data 4420 may include any suitable data which may indicate associations between historical claims data, potential sources of loss, devices for mitigating the risk of loss, home scores, home score improvements, as well as any other suitable data which may train the ML model 4410 to generate an improvement in a home score for repairing or replacing an existing device.

In an aspect, the server may continuously update the training data 4420, e.g., based upon obtaining additional historical insurance claims data, additional devices, or any other training data. Subsequently, the ML model 4410 may be retrained/fine-tuned based upon the updated training data 4420. Accordingly, the home score improvement for replacing an existing device 4450 and home score improvement for repairing an existing device 4460 may improve over time.

In an aspect, the ML engine 4405 may process and/or analyze the training data 4420 (e.g., via MLTM 4406) to train the ML model 4410 to generate the home score improvement for replacing an existing device 4450 and home score improvement for repairing an existing device 4460. The ML model 4410 may be trained to generate the home score improvement for replacing an existing device 4450 and home score improvement for repairing an existing device 4460 via a neural network, deep learning model, Transformer-based model, generative pretrained transformer (GPT), generative adversarial network (GAN), regression model, k-nearest neighbor algorithm, support vector regression algorithm, and/or random forest algorithm, although any type of applicable ML model/algorithm may be used, including training using one or more of supervised learning, unsupervised learning, semi-supervised learning, and/or reinforcement learning.

Once trained, the ML model 4410 may perform operations on one or more data inputs to produce a desired data output. In one aspect, the ML model 4410 may be loaded at runtime (e.g., by MLOM 4407) from a database (e.g., database of server 140) to process the structure information 4440, imagery data 4445 inputs, and/or inventory list 4447. The server, such as server 140, may obtain the structure information 4440, imagery data 4445, and/or inventory list 4447 and use them as input to determine the home score improvement for replacing an existing device 4450 and home score improvement for repairing an existing device 4460.

In one aspect, the server may obtain the structure information 4440 via user input on a user device, such as the mobile device 112 (e.g., of the property owner) which may be running a mobile app and/or via a website, the chatbot 145, or any other suitable user device. The server may obtain the structure information 4440 from available data associated with the structure, such as: government databases of land/property records; a business such as a real estate company which may have publicly listed the property for sale including structure information 4440; an insurance company which may have insured the structure and gathered relevant structure information 4440 in the process; and/or any other suitable source.

The structure information 4440 may include the floorplan of the structure, such as the number of floors, square footage, the location, dimensions, number and/or type of rooms (such as a bathroom), etc. The structure information 4440 may include structural components of the structure, such as the type of roof, drain systems, decks, foundation, as well as other suitable structure components. The structure information 4440 may include the property the structure is located upon including whether it includes a yard, obstructed views of the street, and/or a water feature on the property, as well as other suitable information regarding the property. The structure information 4440 may include the plumbing at the structure such as the number, location, age, condition and/or type of plumbing, pipes, toilets, sewage lines, drains, and/or water lines throughout the structure and/or property. In one aspect, the structure information 4440 may include device information (e.g., information of devices at the structure), such as the number, type, location, age, and/or condition of the devices at the structure. The structure information 4440 may include any information which may be relevant to generating home score improvements for replacing devices 4450 and/or home score improvements for repairing existing devices 4460.

In one aspect, the server may obtain the imagery data 4445 via the mobile device 112 or any other suitable user device, such as a camera, a database, etc. The imagery data 4445 may include images and/or video of the interior, exterior, and/or property proximate the structure. The imagery data 4445 may comprise images and/or video of existing devices proximate the structure 116. The ML model 4410 may use the imagery data 4445 to detect the presence of and/or identify existing devices proximate the structure.

In one aspect, the ML model 4410 may weigh one or more attributes of the structure information 4440, imagery data 4445, and/or inventory list 4447 such that they are of unequal importance. For example, a bedroom lacking a smoke detector may be deemed more important than a portion of the structure lacking floodlights. Thus, the ML model 4410 may apply an increased weight to the missing smoke detector and rank, score, or otherwise indicate the smoke detector recommendation more strongly as compared to the floodlight recommendation.

In one embodiment, the ML model 4410 may use a regression model to determine a score associated with the device recommendations based upon the structure information 4440, imagery data 4445 and/or inventory list 4447 inputs, which may be a preferred model in situations involving scoring output data.

Furthermore, it should be appreciated that one home score improvement ML model may be trained to determine improvements for either replacing or repairing the existing device for any or all of: the overall home score, the home safety subscore, the fire protection subscore, the sustainability subscore, and/or the home automation subscore comprises determining the home safety subscore. Additionally or alternatively, individual home score improvement ML models may be trained to determine improvements for either replacing or repairing the existing device in one of: the overall home score, the home safety subscore, the fire protection subscore, the sustainability subscore, or the home automation subscore comprises determining the home safety subscore.

Once the home score improvement for replacing an existing device 4450 and home score improvement for repairing an existing device 4460 are generated by the ML model 4410, they may be provided to a user device (e.g., mobile device 112, etc.). For example, the server may provide the home score improvement for replacing an existing device 4450 and home score improvement for repairing an existing device 4460 via a mobile app to mobile device, such as mobile device 112, in an email, a website, via a chatbot (such as the ML chatbot 145), and/or in any other suitable manner as further described herein.

In one aspect, the owner, renter and/or other party associated with the home may be entitled to one or more incentives on an insurance policy associated with the home upon repairing or replacing the existing device.

It should be understood that not all blocks and/or events of the exemplary signal diagrams and/or flowcharts are required to be performed. Moreover, more blocks may be performed even though they are not specifically illustrated. The exemplary signal diagrams and/or flowcharts may include additional, less, or alternate functionality, including that discussed elsewhere herein.

### Exemplary Training of the ML Chatbot Model

In certain embodiments, the machine learning chatbot 145 may be configured to utilize artificial intelligence and/or machine learning techniques. For instance, the machine learning chatbot or voice bot may be a ChatGPT chatbot. The machine learning chatbot may employ supervised or unsupervised machine learning techniques, which may be followed by, and/or used in conjunction with, reinforced or reinforcement learning techniques. The machine learning chatbot may employ the techniques utilized for ChatGPT. The machine learning chatbot may be configured to generate verbal, audible, visual, graphic, text, or textual output for either human or other bot/machine consumption or dialogue.

Broadly speaking, the chatbot 145 may be trained to provide text explaining why replacing or repairing the existing device improves the overall home score, text explaining a recommendation, etc. Examples of text generated by the chatbot 145 are illustrated in FIGS. 39 and 41.

In some embodiments, the chatbot 145 may be trained and/or operated by the request server 140 and/or the mobile device 112 and/or any other suitable component. In certain embodiments, the chatbot 145 is trained by the request server 140, and operated by the mobile device 112.

Programmable chatbots, such the chatbot 145, may provide tailored, conversational-like abilities relevant to repairing or replacing an existing device. The chatbot may be capable of understanding user requests/responses, providing relevant information, etc. Additionally, the chatbot may generate data from user interactions which the enterprise may use to personalize future support and/or improve the chatbot's functionality, e.g., when retraining and/or fine-tuning the chatbot.

In some embodiments, the chatbot 145 comprises an ML chatbot. The ML chatbot may provide advanced features as compared to a non-ML chatbot, which may include and/or derive functionality from a large language model (LLM). The ML chatbot may be trained on a server, such as server 140, using large training datasets of text which may provide sophisticated capability for natural-language tasks, such as answering questions and/or holding conversations. The ML chatbot may include a general-purpose pretrained LLM which, when provided with a starting set of words (prompt) as an input, may attempt to provide an output (response) of the most likely set of words that follow from the input. In one aspect, the prompt may be provided to, and/or the response received from, the ML chatbot and/or any other ML model, via a user interface of the server. This may include a user interface device operably connected to the server via an I/O module. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances and/or prompts, which may require the ML chatbot to keep track of an entire conversation history as well as the current state of the conversation. The ML chatbot may rely on various techniques to engage in conversations with users, which may include the use of short-term and long-term memory. Short-term memory may temporarily store information (e.g., in a memory of the server 140) that may be required for immediate use and may keep track of the current state of the conversation and/or to understand the user's latest input in order to generate an appropriate response. Long-term memory may include persistent storage of information (e.g., on a database of the server 140) which may be accessed over an extended period of time. The long-term memory may be used by the ML chatbot to store information about the user (e.g., preferences, chat history, etc.) and may be useful for improving an overall user experience by enabling the ML chatbot to personalize and/or provide more informed responses.

The system and methods to generate and/or train an ML chatbot model (e.g., the server 140) which may be used by the ML chatbot, may consist of three steps: (1) a supervised fine-tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning ML Model

FIG. 45 depicts a combined block and logic diagram 4500 for training an ML chatbot model, in which the techniques described herein may be implemented, according to some embodiments. Some of the blocks in FIG. 45 may represent hardware and/or software components, other blocks may represent data structures or memory storing these data structures, registers, or state variables (e.g., data structures for training data 4512), and other blocks may represent output data (e.g., 4525). Input and/or output signals may be represented by arrows labeled with corresponding signal names and/or other identifiers. The methods and systems may include one or more servers 4502, 4504, 4506, such as the server 140 of FIG. 1.

In one aspect, the server 4502 may fine-tune a pretrained language model 4510. The pretrained language model 4510 may be obtained by the server 4502 and be stored in a memory (e.g., a memory of the server). The pretrained language model 4510 may be loaded into an ML training module, such as MLTM 4406, by the server 4502 for retraining/fine-tuning. A supervised training dataset 4512 may be used to fine-tune the pretrained language model 4510 wherein each data input prompt to the pretrained language model 4510 may have a known output response for the pretrained language model 4510 to learn from. The supervised training dataset 4512 may be stored in a memory of the server 4502. In one aspect, the data labelers may create the supervised training dataset 4512 prompts and appropriate responses. The pretrained language model 4510 may be fine-tuned using the supervised training dataset 4512 resulting in the SFT ML model 4515 which may provide appropriate responses to user prompts once trained. The trained SFT ML model 4515 may be stored in a memory of the server 4502.

In one aspect, the supervised training dataset 4512 may include prompts and responses which may be relevant to determining text explaining why replacing or repairing the existing device improves the overall home score, and/or text explaining a recommendation. For example, a user prompt may include an inquiry as to if replacing or repairing an existing device would improve a home score. Appropriate responses from the trained SFT ML model 4515 may include requesting from the user information structure information, imagery data, an inventory list, an identification of and/or other information of the existing device, etc. The responses from the trained SFT ML model 4515 may include text explaining why replacing or repairing the existing device improves the overall home score, text explaining a recommendation. The responses from the trained SFT ML model 4515 may include an indication of a home score improvement(s) for replacing or repairing the existing device, as well as text explaining why replacing or repairing the existing device improves the overall home score, text explaining a recommendation, etc. The responses may be via text, audio, multimedia, etc.

### Training the Reward Model

In one aspect, training the ML chatbot model 4550 may include the server 4504 training a reward model 4520 to provide as an output a scaler value/reward 4525. The reward model 4520 may be required to leverage reinforcement learning with human feedback (RLHF) in which a model (e.g., ML chatbot model 4550) learns to produce outputs which maximize its reward 4525, and in doing so may provide responses which are better aligned to user prompts.

Training the reward model 4520 may include the server 4504 providing a single prompt 4522 to the SFT ML model 4515 as an input. The input prompt 4522 may be provided via an input device (e.g., a keyboard) via the I/O module of the server 140. The prompt 4522 may be previously unknown to the SFT ML model 4515, e.g., the labelers may generate new prompt data, the prompt 4522 may include testing data stored on database, and/or any other suitable prompt data. The SFT ML model 4515 may generate multiple, different output responses 4524A, 4524B, 4524C, 4524D to the single prompt 4522. The server 4504 may output the responses 4524A, 4524B, 4524C, 4524D via an I/O module to a user interface device, such as a display (e.g., as text responses), a speaker (e.g., as audio/voice responses), and/or any other suitable manner of output of the responses 4524A, 4524B, 4524C, 4524D for review by the data labelers.

The data labelers may provide feedback via the server 4504 on the responses 4524A, 4524B, 4524C, 4524D when ranking 4526 them from best to worst based upon the prompt-response pairs. The data labelers may rank 4526 the responses 4524A, 4524B, 4524C, 4524D by labeling the associated data. The ranked prompt-response pairs 4528 may be used to train the reward model 4520. In one aspect, the server 4504 may load the reward model 4520 via the MTLM 4406 module and train the reward model 4520 using the ranked response pairs 4528 as input. The reward model 4520 may provide as an output the scalar reward 4525.

In one aspect, the scalar reward 4525 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 4520 may generate a winning reward. Inputting a “losing” prompt-response pair data to the same reward model 4520 may generate a losing reward. The reward model 4520 and/or scalar reward 4536 may be updated based upon labelers ranking 4526 additional prompt-response pairs generated in response to additional prompts 4522.

In one example, a data labeler may provide to the SFT ML model 4515 as an input prompt 4522, “Describe the sky.” The input may be provided by the labeler via the server 4504 running a chatbot application utilizing the SFT ML model 4515. The SFT ML model 4515 may provide as output responses to the labeler via the server 4504: (i) “the sky is above” 4524A; (ii) “the sky includes the atmosphere and may be considered a place between the ground and outer space” 4524B; and (iii) “the sky is heavenly” 4524C. The data labeler may rank 4526, via labeling the prompt-response pairs, prompt-response pair 4522/4524B as the most preferred answer; prompt-response pair 4522/4524A as a less preferred answer; and prompt-response 4522/4524C as the least preferred answer. The labeler may rank 4526 the prompt-response pair data in any suitable manner. The ranked prompt-response pairs 4528 may be provided to the reward model 4520 to generate the scalar reward 4525.

While the reward model 4520 may provide the scalar reward 4525 as an output, the reward model 4520 may not generate a response (e.g., text). Rather, the scalar reward 4525 may be used by a version of the SFT ML model 4515 to generate more accurate responses to prompts, i.e., the SFT model 4515 may generate the response such as text to the prompt, and the reward model 4520 may receive the response to generate a scalar reward 4525 of how well humans perceive it. Reinforcement learning may optimize the SFT model 4515 with respect to the reward model 4520 which may realize the configured ML chatbot model 4550.

### RLHF to Train the ML Chatbot Model

In one aspect, the server 4506 may train the ML chatbot model 4550 (e.g., via the MLTM 4406) to generate a response 4534 to a random, new and/or previously unknown user prompt 4532. To generate the response 4534, the ML chatbot model 4550 may use a policy 4535 (e.g., algorithm) which it learns during training of the reward model 4520, and in doing so may advance from the SFT model 4515 to the ML chatbot model 4550. The policy 4535 may represent a strategy that the ML chatbot model 4550 learns to maximize its reward 4525. As discussed herein, based upon prompt-response pairs, a human labeler may continuously provide feedback to assist in determining how well the ML chatbot's 4550 responses match expected responses to determine rewards 4525. The rewards 4525 may feed back into the ML chatbot model 4550 to evolve the policy 4535. Thus, the policy 4535 may adjust the parameters of the ML chatbot model 4550 based upon the rewards 4525 it receives for generating good responses. The policy 4535 may update as the ML chatbot model 4550 provides responses 4534 to additional prompts 4532.

In one aspect, the response 4534 of the ML chatbot model 4550 using the policy 4535 based upon the reward 4525 may be compared using a cost function 4538 to the SFT ML model 4515 (which may not use a policy) response 4536 of the same prompt 4532. The server 4506 may compute a cost 4540 based upon the cost function 4538 of the responses 4534, 4536. The cost 4540 may reduce the distance between the responses 4534, 4536, i.e., a statistical distance measuring how one probability distribution is different from a second, in one aspect the response 4534 of the ML chatbot model 4550 versus the response 4536 of the SFT model 4515. Using the cost 4540 to reduce the distance between the responses 4534, 4536 may avoid a server over-optimizing the reward model 4520 and deviating too drastically from the human-intended/preferred response. Without the cost 4540, the ML chatbot model 4550 optimizations may result in generating responses 4534 which are unreasonable but may still result in the reward model 4520 outputting a high reward 4525.

In one aspect, the responses 4534 of the ML chatbot model 4550 using the current policy 4535 may be passed by the server 4506 to the rewards model 4520, which may return the scalar reward or discount 4525. The ML chatbot model 4550 response 4534 may be compared via cost function 4538 to the SFT ML model 4515 response 4536 by the server 4506 to compute the cost 4540. The server 4506 may generate a final reward 4542 which may include the scalar reward 4525 offset and/or restricted by the cost 4540. The final reward or discount 4542 may be provided by the server 4506 to the ML chatbot model 4550 and may update the policy 4535, which in turn may improve the functionality of the ML chatbot model 4550.

To optimize the ML chatbot model 4550 over time, RLHF via the human labeler feedback may continue ranking 4526 responses of the ML chatbot model 4550 versus outputs of earlier/other versions of the SFT ML model 4515, i.e., providing positive or negative rewards or adjustments 4525. The RLHF may allow the servers (e.g., servers 4504, 4506) to continue iteratively updating the reward model 4520 and/or the policy 4535. As a result, the ML chatbot model 4550 may be retrained and/or fine-tuned based upon the human feedback via the RLHF process, and throughout continuing conversations may become increasingly efficient.

Although multiple servers 4502, 4504, 4506 are depicted in the exemplary block and logic diagram 4500, each providing one of the three steps of the overall ML chatbot model 4550 training, fewer and/or additional servers may be utilized and/or may provide the one or more steps of the ML chatbot model 4550 training. In one aspect, one server may provide the entire ML chatbot model 4550 training.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In certain embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary computer-based or computer-centric methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for an ecosystem that initiates an action following an occurrence of an event, the method comprising:
receiving, via one or more processors, data from a plurality of data sources, the plurality of data sources including: smart home devices, a weather database, an insurance company, a real estate & property data company, artificial intelligence (AI) company, an electrical data company, a security company, and/or a property risk data company;
determining, via the one or more processors, based upon the received data from the plurality of data sources, that an event has occurred that will damage or has damage an insured asset; and
initiating, via the one or more processors, an action based upon the determination that the event has occurred.

2. The computer-implemented method of claim 1, wherein the action comprises presenting, via a smart phone and/or smart home device, an instruction or suggestion to protect the insured asset.

3. The computer-implemented method of claim 1, wherein the action comprises:
presenting, via a smart phone and/or smart home device, a question asking if the insured asset has been damaged;
presenting, via a smart phone and/or smart home device, a question asking if an insurance customer would like to place an insurance claim for the insured asset; or
electronically placing, via the one or more processors, an insurance claim for the insured asset.

4. The computer-implemented method of claim 1, wherein the action comprises presenting, via a smart phone and/or smart home device, a list of suggested vendors to repair or replace the insured asset.

5. The computer-implemented method of claim 1, wherein the insured asset comprises a house, an automobile, a motorcycle, or a boat.

6. The computer-implemented method of claim 1, wherein the event comprises a burst pipe, and wherein the action comprises:
shutting off a water valve; and/or
presenting a warning advising that water should be shut off.

7. The computer-implemented method of claim 1, wherein:
the receiving the data comprises:
receiving, via the one or more processors, weather data from the weather database;
analyzing, via the one or more processors, the received weather data;
requesting, via the one or more processors, based upon the analysis of the weather data, smart home data from the smart home devices; and
receiving, via the one or more processors, the smart home data in response to the request; and
determining that the event has occurred comprises determining that the event has occurred based upon the received smart home data.

8. The computer-implemented method of claim 1, wherein:
the receiving the data comprises:
receiving, via the one or more processors, insurance claims data from the insurance company;
analyzing, via the one or more processors, the received insurance claims data;
requesting, via the one or more processors, based upon the analysis of the insurance claims data, smart home data from the smart home devices; and
receiving, via the one or more processors, the smart home data in response to the request; and
determining that the event has occurred comprises determining that the event has occurred based upon the received smart home data.

9. The computer-implemented method of claim 1, further comprising:
training, via the one or more processors, an event determination machine learning algorithm by inputting historical information into the event determination machine learning algorithm, the historical information comprising: (i) independent variables comprising (a) historical weather data, (b) historical insurance claims data, and/or (c) historical smart device data, and/or (ii) dependent variables comprising historical events; and
determining, via the one or more processors, the event by routing the received data from the plurality of data sources into the event determination machine learning algorithm.

10. The computer-implemented method of claim 1, further comprising:
training, via the one or more processors, a remedial action machine learning algorithm by inputting historical information into the remedial action machine learning algorithm, the historical information comprising: (i) independent variables comprising (a) historical determined events, (b) historical weather data, and/or (c) historical smart device data, and/or (ii) dependent variables comprising historical remedial actions; and
wherein initiating the action includes determining, via the one or more processors, the action by routing the received data from the plurality of data sources into the remedial action machine learning algorithm.

11. A computer system for an ecosystem that initiates an action following an occurrence of an event, the system comprising one or more processors configured to:
receive data from a plurality of data sources, the plurality of data sources including: smart home devices, a weather database, an insurance company, a real estate & property data company, artificial intelligence (AI) company, an electrical data company, a security company, and/or a property risk data company;
determine, based upon the received data from the plurality of data sources, that an event has occurred that will damage or has damaged an insured asset; and
initiate an action based upon the determination that the event has occurred.

12. The computer system of claim 11, wherein the action comprises presenting, via a smart phone and/or smart home device, an instruction or suggestion to protect the insured asset.

13. The computer system of claim 11, wherein the action comprises:
causing a smart phone and/or smart home device to present a question asking if the insured asset has been damaged;
causing via the smart phone and/or smart home device to present a question asking if an insurance customer would like to place an insurance claim for the insured asset; or
electronically placing an insurance claim for the insured asset.

14. The computer system of claim 11, wherein the action comprises causing a smart phone and/or smart home device to present a list of suggested vendors to repair or replace the insured asset.

15. The computer system of claim 11, wherein the insured asset comprises a house, an automobile, a motorcycle, or a boat.

16. A computer device for an ecosystem that initiates an action following an occurrence of an event, the computer device comprising:
one or more processors; and
one or more non-transitory memories;
the one or more non-transitory memories having stored thereon computer-executable instructions that, when executed by the one or more processors, cause the computer device to:
receive data from a plurality of data sources, the plurality of data sources including: smart home devices, a weather database, an insurance company, a real estate & property data company, artificial intelligence (AI) company, an electrical data company, a security company, and/or a property risk data company;
determine, based upon the received data from the plurality of data sources, that an event has occurred that will damage or has damaged an insured asset; and
initiate an action based upon the determination that the event has occurred.

17. The computer device of claim 16, wherein the action comprises presenting, via a smart phone and/or smart home device, an instruction or suggestion to protect the insured asset.

18. The computer device of claim 16, wherein the action comprises:
causing a smart phone and/or smart home device to present a question asking if the insured asset has been damaged;
causing via the smart phone and/or smart home device to present a question asking if an insurance customer would like to place an insurance claim for the insured asset; or
electronically placing an insurance claim for the insured asset.

19. The computer device of claim 16, wherein the action comprises causing a smart phone and/or smart home device to present a list of suggested vendors to repair or replace the insured asset.

20. The computer device of claim 16, wherein the insured asset comprises a house, an automobile, a motorcycle, or a boat.
